(19) United States
(12) Patent Application Publication
(10) Pub. No.: US 2020/0037343 A1
(43) Pub. Date: Jan. 30, 2020

(54) METHOD AND APPARATUS FOR NETWORK CONTROLLED RESOURCE ALLOCATION IN NR V2X

(71) Applicant: Samsung Electronics Co., Ltd., Suwon-si (KR)

(72) Inventors: Chao He, Allen, TX (US); Hongbo Si, Plano, TX (US); Aris Papasakellariou, Houston, TX (US)

(21) Appl. No.: 16/520,094

(22) Filed: Jul. 23, 2019

Related U.S. Application Data
(60) Provisional application No. 62/702,449, filed on Jul. 24, 2018.
(60) Provisional application No. 62/711,921, filed on Jul. 30, 2018.
(60) Provisional application No. 62/732,368, filed on Sep. 17, 2018.
(60) Provisional application No. 62/737,408, filed on Sep. 27, 2018.
(60) Provisional application No. 62/753,528, filed on Oct. 31, 2018.
(60) Provisional application No. 62/787,854, filed on Jan. 3, 2019.
(60) Provisional application No. 62/800,067, filed on Feb. 1, 2019.
(60) Provisional application No. 62/802,392, filed on Feb. 7, 2019.
(60) Provisional application No. 62/848,101, filed on May 15, 2019.
(60) Provisional application No. 62/848,120, filed on May 15, 2019.

(51) Int. Cl. H04W 72/12; H04W 72/04; H04W 4/40; H04W 28/02; H04L 1/18

(52) U.S. Cl. CPC H04W 72/1263; H04W 72/0406; H04W 72/1278; H04W 72/0446; H04W 28/0268; H04L 1/1861; H04W 4/40

(57) ABSTRACT

A method of a UE in a wireless communication system is provided. The method comprises: receiving, from a BS, downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH); determining a type of traffic to be transmitted to the other UE via at least one of the PSFCH, PSCCH, or PSSCH, wherein the type of traffic is aperiodic or periodic traffic; identifying, based on the type of traffic, a set of resources for at least one transport block (TB) to be included in the at least one of the PSFCH, the PSCCH, or the PSSCH; and transmitting, to the other UE via the sidelink, the at least one TB using the identified set of resources.

### CROSS-REFERENCE TO RELATED APPLICATIONS AND CLAIM OF PRIORITY

The present application claims priority to:
U.S. Provisional Patent Application Ser. No. 62/702,449, filed on Jul. 24, 2018;
U.S. Provisional Patent Application Ser. No. 62/711,921, filed on Jul. 30, 2018;
U.S. Provisional Patent Application Ser. No. 62/732,368, filed on Sep. 17, 2018;
U.S. Provisional Patent Application Ser. No. 62/737,408, filed on Sep. 27, 2018;
U.S. Provisional Patent Application Ser. No. 62/753,528, filed on Oct. 31, 2018;
U.S. Provisional Patent Application Ser. No. 62/787,854, filed on Jan. 3, 2019;
U.S. Provisional Patent Application Ser. No. 62/800,067, filed on Feb. 1, 2019;
U.S. Provisional Patent Application Ser. No. 62/802,392, filed on Feb. 7, 2019;
U.S. Provisional Patent Application Ser. No. 62/848,101, filed on May 15, 2019; and
U.S. Provisional Patent Application Ser. No. 62/848,120, filed on May 15, 2019. The content of the above-identified patent document is incorporated herein by reference.

### TECHNICAL FIELD

The present application relates generally to wireless communication systems, more specifically, the present disclosure relates to network controlled resource allocation in BR V2X.

### BACKGROUND

The present disclosure relates to a pre-5^{th}-generation (5G) or 5G communication system to be provided for supporting higher data rates beyond 4^{th}-generation (4G) communication system such as long term evolution (LTE). A communication system includes a downlink (DL) that conveys signals from transmission points such as base stations (BSs) or NodeBs to user equipments (UEs) and an uplink (UL) that conveys signals from UEs to reception points such as NodeBs. Additionally a sidelink (SL) may convey signals from UEs to other UEs or other non-infrastructure based nodes. A UE, also commonly referred to as a terminal or a mobile station, may be fixed or mobile and may be a cellular phone, a personal computer device, etc. A NodeB, which is generally a fixed station, may also be referred to as an access point or other equivalent terminology such as eNodeB. The access network including the NodeB as related to 3GPP LTE is called as E-UTRAN (Evolved Universal Terrestrial Access Network).

### SUMMARY

The present disclosure relates to a pre-5th-Generation or 5G communication system to be provided for supporting vehicle to vehicle communication. Embodiments of the present disclosure provide network controlled resource allocation in NR V2X.

In one embodiment, a user equipment (UE) in a wireless communication system is provided. The UE comprises a transceiver configured to receive, from a base station (BS), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH). The UE further comprises a processor operably connected to the transceiver, the processor configured to: determine a type of traffic to be transmitted to the other UE via at least one of the PSFCH, PSCCH, or PSSCH, wherein the type of traffic is aperiodic traffic or periodic traffic; and identify, based on the type of traffic, a set of resources for at least one transport block (TB) to be included in the at least one of the PSFCH, the PSCCH, or the PSSCH, wherein the transceiver is further configured to transmit, to the other UE via the sidelink, the at least one TB using the identified set of resources.

In another embodiment, a base station (BS) in a wireless communication system is provided. The BS comprises a transceiver configured to transmit, to a user equipment (UE), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH), wherein: a type of traffic to be transmitted to the other UE via at least one of the PSFCH, PSCCH, or PSSCH, is determined, the type of traffic being aperiodic traffic or periodic traffic; a set of resources for at least one transport block (TB) to be included in the at least one of the PSFCH, the PSCCH, or the PSSCH, based on the type of traffic, is identified; and the at least one TB using the identified set of resources is transmitted to the other UE via the sidelink.

In yet another embodiment, a method of a user equipment (UE) in a wireless communication system is provided. The method comprises receiving, from a base station (BS), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH); determining a type of traffic to be transmitted to the other UE via at least one of the PSFCH, PSCCH, or PSSCH, wherein the type of traffic is aperiodic traffic or periodic traffic; identifying, based on the type of traffic, a set of resources for at least one transport block (TB) to be included in the at least one of the PSFCH, the PSCCH, or the PSSCH; and transmitting, to the other UE via the sidelink, the at least one TB using the identified set of resources.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example use case of a vehicle-centric communication network according to embodiments of the present disclosure;

FIG. 5 illustrates an example SL interface according to embodiments of the present disclosure;

FIG. 6 illustrates an example resource pool for PSCCH according to embodiments of the present disclosure;

FIG. 7 illustrates an example RF chain according to embodiments of the present disclosure;

FIG. 8 illustrates an example scheduled six consecutive slot/mini-slot resources according to embodiments of the present disclosure;

FIG. 9 illustrates an example scheduled six consecutive slot/mini-slot resources according to embodiments of the present disclosure;

FIG. 10 illustrates an example T-F resource pattern according to embodiments of the present disclosure;

FIG. 11 illustrates an example scheduled T-F resources according to embodiments of the present disclosure;

FIG. 12 illustrates an example PI channel structure according to embodiments of the present disclosure;

FIG. 13 illustrates a flowchart of a method for preemption indication according to embodiments of the present disclosure;

FIG. 14 illustrates an example resource allocation according to embodiments of the present disclosure;

FIG. 15 illustrates another example resource allocation according to embodiments of the present disclosure;

FIG. 16 illustrates yet another example resource allocation according to embodiments of the present disclosure;

FIG. 17 illustrates yet another example resource allocation according to embodiments of the present disclosure;

FIG. 18 illustrates an example CSI/SRS resource according to embodiments of the present disclosure;

FIG. 19 illustrates an example CSI/SRS resource according to embodiments of the present disclosure;

FIG. 20 illustrates an example reservation signal according to embodiments of the present disclosure;

FIG. 21 illustrates an example reservation signal structure according to embodiments of the present disclosure;

FIG. 22 illustrates a flowchart of a method for reservation signal indication according to embodiments of the present disclosure;

FIG. 23 illustrates an example reservation indication according to embodiments of the present disclosure;

FIG. 24 illustrates an example consecutive slots of T-F resources according to embodiments of the present disclosure;

FIG. 25 illustrates an example consecutive slots of T-F resources according to embodiments of the present disclosure;

FIG. 26 illustrates an example reservation indication according to embodiments of the present disclosure;

FIG. 27 illustrates an example call flow of resource allocation according to embodiments of the present disclosure;

FIG. 28 illustrates another example call flow of resource allocation according to embodiments of the present disclosure;

FIG. 29 illustrates an example resource allocation according to embodiments of the present disclosure;

FIG. 30 illustrates another example resource allocation according to embodiments of the present disclosure;

FIG. 31 illustrates yet another example resource allocation according to embodiments of the present disclosure;

FIG. 32 illustrates an example feedback channel resource according to embodiments of the present disclosure;

FIG. 33 illustrates another example feedback channel resource according to embodiments of the present disclosure;

FIG. 34 illustrates yet another example feedback channel resource according to embodiments of the present disclosure;

FIG. 35 illustrates yet another example feedback channel resource according to embodiments of the present disclosure;

FIG. 36 illustrates yet another example feedback channel resource according to embodiments of the present disclosure;

FIG. 37 illustrates yet another example feedback channel resource according to embodiments of the present disclosure;

FIG. 38 illustrates an example feedback channel resource according to embodiments of the present disclosure;

FIG. 39 illustrates yet another example feedback channel resource according to embodiments of the present disclosure;

FIG. 40 illustrates yet another example feedback channel resource according to embodiments of the present disclosure;

FIG. 41 illustrates yet another example feedback channel resource according to embodiments of the present disclosure;

FIG. 42 illustrates yet another example feedback channel resource according to embodiments of the present disclosure;

FIG. 43 illustrates yet another example feedback channel resource according to embodiments of the present disclosure;

FIG. 44 illustrates yet another example feedback channel resource according to embodiments of the present disclosure;

FIG. 45 illustrates yet another example feedback channel resource according to embodiments of the present disclosure; and

FIG. 46 illustrates a flowchart of a method for network controlled resource allocation according to embodiments of the present disclosure.

### DETAILED DESCRIPTION

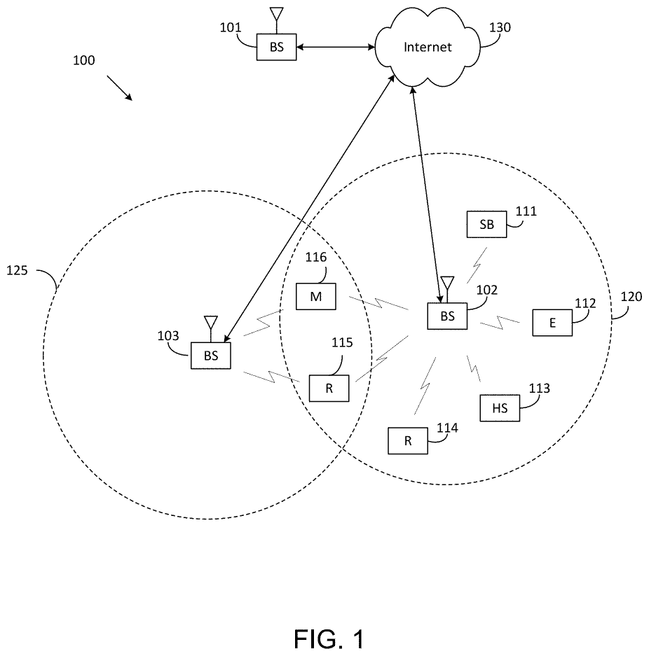

FIG. 1 through FIG. 46, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.913 v14.3.0, “Study on Scenarios and Requirements for Next Generation Access Technologies;” 3GPP TR 22.886 v15.1.0, “Study on enhancement of 3GPP Support for 5G V2X Services;” and 3GPP TS 36.213 v 15.1.0, “Evolved Universal Terrestrial Radio Access (E-UTRAN); Physical layer procedure.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for reception reliability for data and control information in an advanced wireless communication system. In certain embodiments, and one or more of the gNBs 101-103 includes circuitry, programing, or a combination thereof, for efficient network controlled resource allocation in NR V2X.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

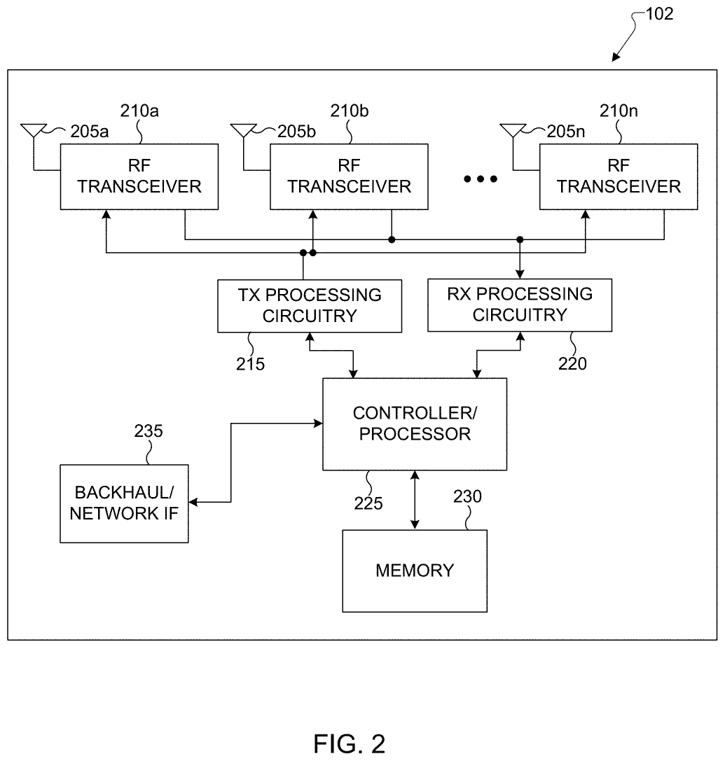

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

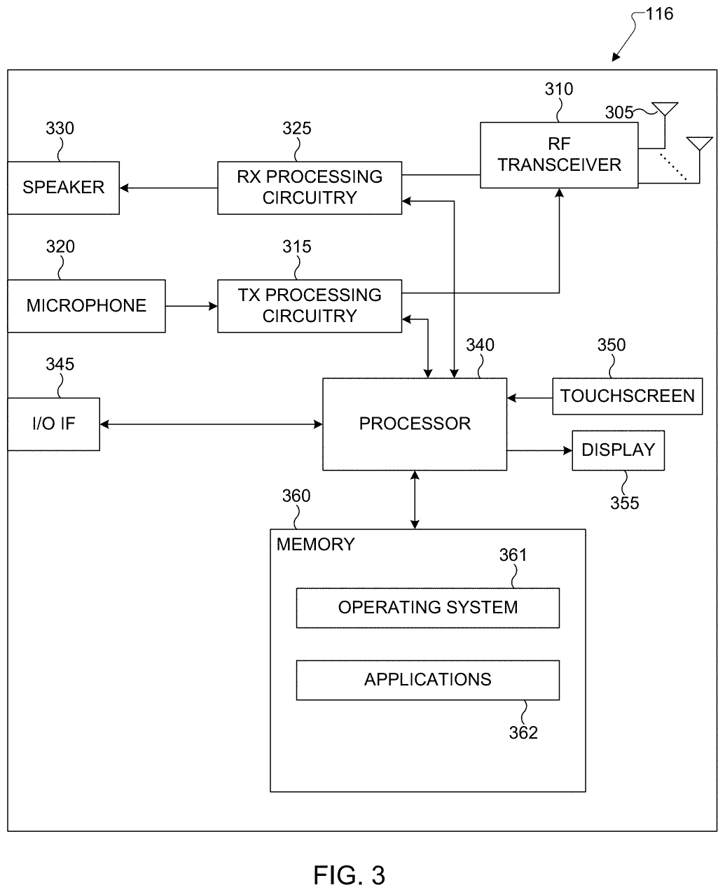

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

The present disclosure relates generally to wireless communication systems and, more specifically, to vehicular communication network protocols, including vehicle-to-device, vehicle-to-vehicle, and vehicle-to-network communication resource allocation and synchronization schemes. A communication system includes a downlink (DL) that conveys signals from transmission points such as base stations (BSs) or NodeBs to user equipments (UEs) and an uplink (UL) that conveys signals from UEs to reception points such as NodeBs.

Additionally a sidelink (SL) may convey signals from UEs to other UEs or other non-infrastructure based nodes. A UE, also commonly referred to as a terminal or a mobile station, may be fixed or mobile and may be a cellular phone, a personal computer device, etc. A NodeB, which is generally a fixed station, may also be referred to as an access point or other equivalent terminology such as eNodeB. The access network including the NodeB as related to 3 GPP LTE is called as an evolved universal terrestrial access network (E-UTRAN).

In a communication system, DL signals can include data signals conveying information content, control signals conveying DL control information (DCI), and reference signals (RS) that are also known as pilot signals. A NodeB transmits data information through a physical DL shared channel (PDSCH). A NodeB transmits DCI through a physical DL control channel (PDCCH) or an enhanced PDCCH (EPDCCH). Messages are transmitted on the PDCCH using a cell radio network temporary identifier (C-RNTI) to identify the intended UE. The C-RNTI is the RNTI to be used by a given UE while the UE is in a particular cell after the UE and a NodeB establish an RRC connection.

A NodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, a NodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a sub-frame (SF) and can have, for example, duration of 1 millisecond. A number of ten SFs is referred to as a frame and is identified by a system frame number (SFN).

Traditionally, cellular communication networks have been designed to establish wireless communication links between mobile devices (UEs) and fixed communication infrastructure components (such as base stations or access points) that serve UEs in a wide or local geographic range. However, a wireless network can also be implemented by utilizing only device-to-device (D2D) communication links without the need for fixed infrastructure components. This type of network is typically referred to as an “ad-hoc” network. A hybrid communication network can support devices that connect both to fixed infrastructure components and to other D2D-enabled devices.

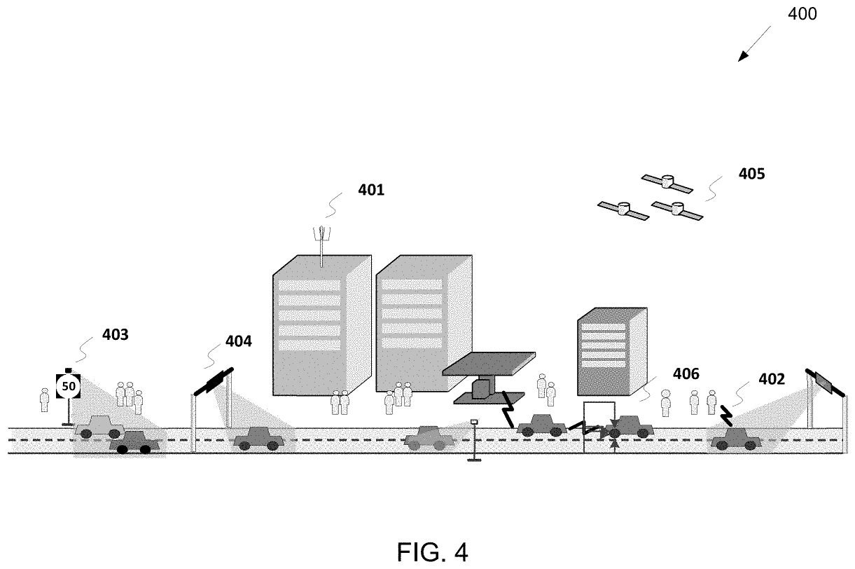

While UEs such as smartphones can be envisioned for D2D networks, vehicular communication can also be supported by a communication protocol where vehicles exchange control or data information with other vehicles or other infrastructure or UEs. Such a network is referred to as a V2X network. Multiple types of communication links can be supported by nodes supporting V2X in the network and can utilize same or different protocols and systems. FIG. 4 illustrates an example use case of a vehicle-centric communication network according to illustrative embodiments of the present disclosure.

FIG. 4 illustrates an example use case of a vehicle-centric communication network 400 according to embodiments of the present disclosure. The embodiment of the use case of a vehicle-centric communication network 400 illustrated in FIG. 4 is for illustration only. FIG. 4 does not limit the scope of the present disclosure to any particular implementation.

The vehicular communication, referred to as Vehicle-to-Everything (V2X), contains the following three different types: vehicle-to-vehicle (V2V) communications; vehicle-to-infrastructure (V2I) communications; and vehicle-to-pedestrian (V2P) communications.

These three types of V2X can use “co-operative awareness” to provide more intelligent services for end-users. This means that transport entities, such as vehicles, roadside infrastructure, and pedestrians, can collect knowledge of their local environment (e.g., information received from other vehicles or sensor equipment in proximity) to process and share that knowledge in order to provide more intelligent services, such as cooperative collision warning or autonomous driving.

V2X communication can be used to implement several types of services that are complementary to a primary communication network or to provide new services based on a flexibility of a network topology. V2X can support unicasting, broadcasting, or group/multicasting as potential means for V2V communication where vehicles are able to transmit messages to all in-range V2V-enabled devices or to a subset of devices that are members of particular group. The protocol can be based on LTE-D2D or on a specialized LTE-V2V protocol.

As illustrated in FIG. 4, V2X can support V2I communication 401 between one or more vehicles and an infrastructure node to provide cellular connectivity as well as specialized services related to control and safety of vehicular traffic. V2P communication 402 can also be supported, for example to provide safety services for pedestrians or traffic management services. V2X multicast communication 403 can be used to provide safety and control messages to large numbers of vehicles in a spectrally efficient manner.

The two primary standardized messages for V2V/V2I communication are the periodic beacons called cooperative awareness messages (CAM) and the event-triggered warning messages, called decentralized environment notification messages (DENM). The CAMs are periodically broadcasted beacons used to maintain awareness of the surrounding vehicles. These messages are sent with an adaptive frequency of 1-10 Hz. The CAMs include information such as position, type and direction. The DENMs are event-triggered warning messages which are generated to alert neighboring vehicles about potential hazards.

While vehicle devices can be able to support many different communication protocols and include support of mandatory or optional features, since the traffic types, QoS requirements, and deployment topologies are distinct from other types of communications, the hardware/software on a vehicle for supporting V2X can have a reduced or specialized functionality compared to other devices. For example, protocols related to low-complexity, low-data rate, and/or low-latency for machine-type communications 404 can be supported such as, for example, traffic tracking beacons. Satellite-based communication 405 can also be supported for V2X networks for communication or positioning services.

Direct communication between vehicles in V2V is based on a sidelink (SL) interface. Sidelink is the UE to UE interface for SL communication and SL discovery. The SL corresponds to the PC5 interface. SL communication is defined as a functionality enabling proximity services (ProSe) direct communication between two or more nearby UEs using E-UTRA technology but not traversing any network node.

E-UTRAN allows such UEs that are in proximity of each other to exchange V2V-related information using E-UTRA(N) when permission, authorization and proximity criteria are fulfilled. The proximity criteria can be configured by the MNO. However, UEs supporting V2V Service can exchange such information when served by or not served by E-UTRAN which supports V2X Service. The UE supporting V2V applications transmits application layer information (e.g., about the UE's location, dynamics, and attributes as part of the V2V Service).

The V2V payload may be flexible in order to accommodate different information contents, and the information can be transmitted periodically according to a configuration provided by the MNO. V2V is predominantly broadcast-based; V2V includes the exchange of V2V-related application information between distinct UEs directly and/or, due to the limited direct communication range of V2V, the exchange of V2V-related application information between distinct UEs via infrastructure supporting V2X Service, e.g., RSU, application server, etc.

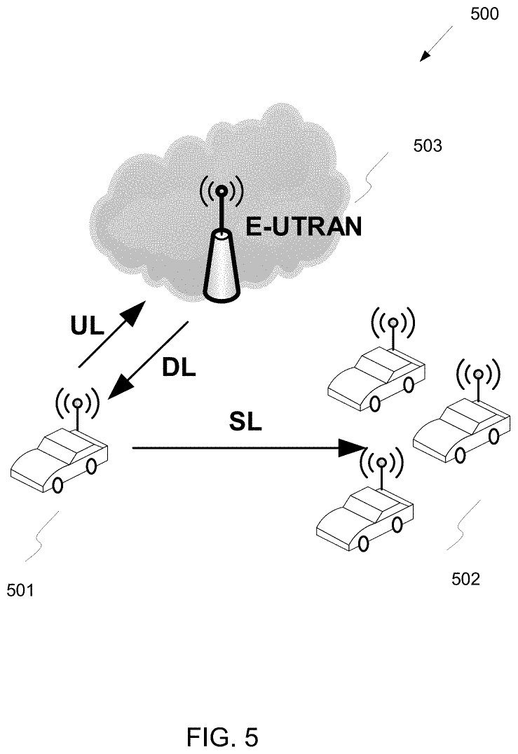

FIG. 5 illustrates an example SL interface 500 according to embodiments of the present disclosure. The embodiment of the SL interface 500 illustrated in FIG. 5 is for illustration only. FIG. 5 does not limit the scope of the present disclosure to any particular implementation.

FIG. 5 illustrates an example SL interface according to illustrative embodiments of the present disclosure. While UL designates the link from UE 501 to NodeB 503 and DL designates the reverse direction, SL designates the radio links over the PC5 interfaces between UE 501 and UEs 502. A UE 501 transmits a V2V message to multiple UEs 502 in the SL. SL communication happens directly without using E-UTRAN technology and not traversing any network node NodeB 503.

The PC5 interface re-uses existing frequency allocation, regardless of the duplex mode (frequency division duplex (FDD) or time division duplex (TDD). To minimize hardware impact on a UE and especially on the power amplifier of the UE, transmission of V2V links occurs in the UL band in case of FDD. Similar, the PC5 interface uses SFs that are reserved for UL transmission in TDD. The signal transmission is based on single carrier frequency division multiple access (SC-FDMA) that is also used for UL transmission. The new channels can be largely based on the channel structure applicable for the transmission of the physical UL shared channel (PUSCH).

SL transmission and reception occurs with resources assigned to a group of devices. A resource pool (RP) is a set of resources assigned for sidelink operation. It consists of the subframes and the resource blocks within the subframe. For SL communication, two additional physical channels are introduced: physical sidelink control channel (PSCCH) carrying the control information, and physical sidelink shared channel (PSSCH) carrying the data.

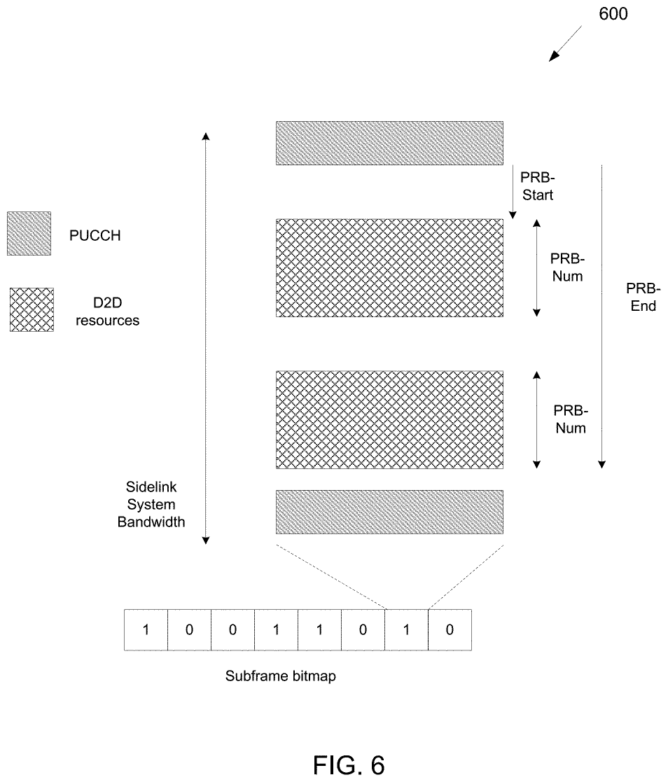

FIG. 6 illustrates an example resource pool for PSCCH 600 according to embodiments of the present disclosure. The embodiment of the resource pool for PSCCH 600 illustrated in FIG. 6 is for illustration only. FIG. 6 does not limit the scope of the present disclosure to any particular implementation.

FIG. 6 illustrates an example resource pool for PSCCH according to illustrative embodiments of the present disclosure. In one example, the pool is defined in the frequency, by parameters: PRBnum: that defines the frequency range in Physical Resource Block (PRB) bandwidth units; and PRBstart, PRBend: which defines the location in the frequency domain within the uplink band. In one example, the pool is defined in the time domain, by a bitmap that indicates the 1 msec sub-frames used for PSCCH transmission.

This block of resources is repeated with a period defined by a parameter SC-Period (expressed in sub-frame duration, i.e., 1 msec). The range of possible values for SC-Period is from 40 msec to 320 msec: low values are supported for voice transmission.

In LTE V2X, the data transmission on sidelink does not support HARQ. There is no ACK or NACK feedback for a PSSCH transmission. To improve the transmission reliability, re-transmission is one good approach.

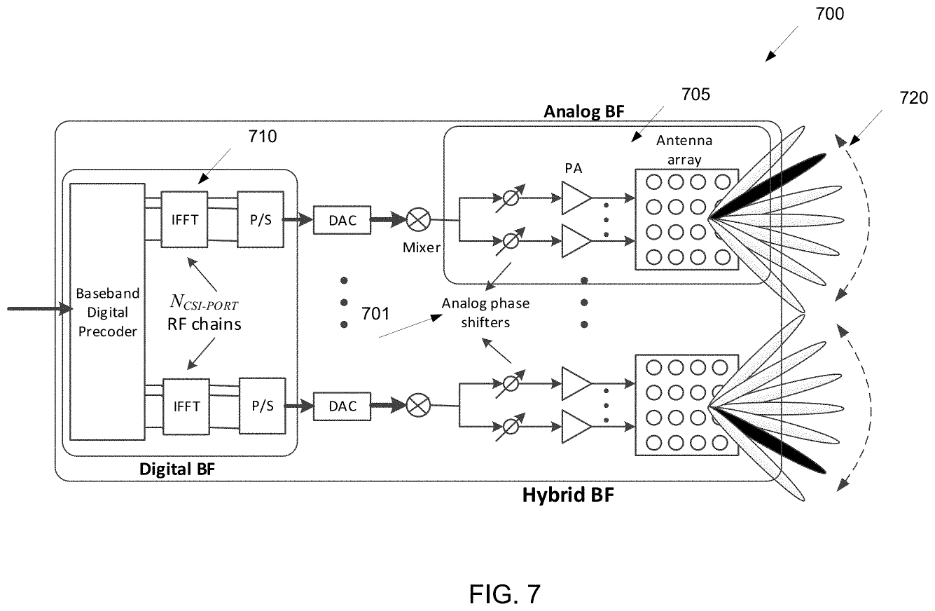

FIG. 7 illustrates an example RF chain 700 according to embodiments of the present disclosure. The embodiment of the RF chain 700 illustrated in FIG. 7 is for illustration only. FIG. 7 does not limit the scope of the present disclosure to any particular implementation.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles (720) by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks.

5G NR systems aim to support multiple services such as eMBB, mMTC and uRLLC with advanced features including higher data rate, higher operating frequency band, wider bandwidth, higher reliability, shorter latency, and increased a number of connectivity.

A vehicular communication, referred to as vehicle-to-everything (V2X), contains the following three different types: 1) vehicle-to-vehicle (V2V) Communications; 2) vehicle-to-infrastructure (V2I) communications; and 3) vehicle-to-pedestrian (V2P) Communications. These three types of V2X can use “co-operative awareness” to provide more intelligent services for end-users. This means that transport entities, such as vehicles, roadside infrastructure, and pedestrians, can collect knowledge of their local environment (e.g., information received from other vehicles or sensor equipment in proximity) to process and share that knowledge in order to provide more intelligent services, such as cooperative collision warning or autonomous driving.

The LTE-V standard includes two radio interfaces. The cellular interface (i.e., Uu) supports vehicle-to-infrastructure communications, while the PC5 interface supports V2V communications based on direct LTE sidelink. LTE sidelink (or device-to-device communication) was introduced for the first time for public safety, and includes two modes of operation: mode 1 and mode 2. Both modes were designed with the objective of prolonging the battery lifetime of mobile devices at the cost of increasing the latency. Connected vehicles require highly reliable and low-latent V2X communications; therefore, modes 1 and 2 are not suitable for vehicular applications.

Two new communication modes (modes 3 and 4) are introduced and specifically designed for V2V communications. In mode 3, the cellular network selects and manages the radio resources used by vehicles for their direct V2V communications. In mode 4, vehicles autonomously select the radio resources for their direct V2V communications. In contrast, mode 4 can operate without cellular coverage, and is therefore considered the baseline V2V mode since safety applications cannot depend on the availability of cellular coverage. Mode 4 includes a distributed scheduling scheme for vehicles to select their radio resources and includes the support for distributed congestion control.

LTE V2X defines sub channels as a group of RBs in the same subframe, and the number of RBs per subchannel can vary. Subchannels are used to transmit data and control information. The data is transmitted in transport blocks (TBs) over physical sidelink shared channels (PSSCH), and the sidelink control information (SCI) messages are transmitted over physical sidelink control channels (PSCCH).

A UE that wants to transmit a TB may also transmit the UE's associated SCI, which is also referred to as a scheduling assignment. The SCI includes information such as the modulation and coding scheme (MCS) used to transmit the TB, the frequency resource allocation, and the resource reservation interval for semi-persistent scheduling (SPS). A TB and the associated SCI may always be transmitted in the same subframe. LTE V2X defines two subchannelization schemes.

In one example adjacent PSCCH+PSSCH, the SCI and TB are transmitted in adjacent RBs. For each SCI+TB transmission, the SCI occupies the first two RBs of the first subchannel utilized for the transmission. The TB is transmitted in the RBs following the SCI, and can occupy several subchannels (depending on a size). In such case, the TB may also occupy the first two RBs of the following subchannels.

In one example of nonadjacent PSCCH+PSSCH, the RBs are divided into pools. One pool is dedicated to transmit only SCIs, and the SCIs occupy two RBs. The second pool is reserved to transmit only TBs and is divided into subchannels.

The use cases for advanced V2X services may be categorized into four use case groups: vehicles platooning, extended sensors, advanced driving and remote driving. Compared with LTE V2X, the NR V2X requirements need to support much lower end-to-end latency (as low as 3 ms), much higher reliability (as high as 99.999%), much higher data rates (as high as 1 Gbps) and much larger communication range.

Use of a listen-before-talk (LBT) procedure is vital for fair and friendly coexistence of LAA with other operators and technologies operating in unlicensed spectrum. LBT procedures on a node attempting to transmit on a carrier in unlicensed spectrum require the node to perform a clear channel assessment to determine if the channel is free for use. Thus, any LBT procedure involves at least energy detection to determine if the channel is being used.

A channel access procedure for transmission(s) including PDSCH/PDCCH/EPDCCH is shown as follows in LTE LAA. The eNB may transmit a transmission including PDSCH/PDCCH/EPDCCH on a carrier on which LAA Scell(s) transmission(s) are performed, after first sensing the channel to be idle during the slot durations of a defer duration T_{d}; and after the counter N is zero in step 4. The counter N is adjusted by sensing the channel for additional slot duration(s) according to the steps below.

In one example of step 1, set Nᵢₙᵢₜ, where Nᵢₙᵢₜ is a random number uniformly distributed between 0 and CWₚ, and go to step 4.

In another example of step 2, if N>0 and the eNB chooses to decrement the counter, set N=N−1.

In yet another example of step 3, sense the channel for an additional slot duration, and if the additional slot duration is idle, go to step 4; else, go to step 5.

In yet another example step of 4, if N=0, stop; else, go to step 2.

In yet another example of step 5, sense the channel until either a busy slot is detected within an additional defer duration T_{d} or all the slots of the additional defer duration T_{d} are detected to be idle.

In yet another example of step 6, if the channel is sensed to be idle during all the slot durations of the additional defer duration T_{d}, go to step 4; else, go to step 5;

If an eNB has not transmitted a transmission including PDSCH/PDCCH/EPDCCH on a carrier on which LAA Scell(s) transmission(s) are performed after step 4 in the procedure above, the eNB may transmit a transmission including PDSCH/PDCCH/EPDCCH on the carrier, if the channel is sensed to be idle at least in a slot duration Tₛₗ when the eNB is ready to transmit PDSCH/PDCCH/EPDCCH and if the channel has been sensed to be idle during all the slot durations of a defer duration T_{d} immediately before this transmission. If the channel has not been sensed to be idle in a slot duration Tₛₗ when the eNB first senses the channel after ready to transmit or if the channel has been sensed to be not idle during any of the slot durations of a defer duration T_{d} immediately before this intended transmission, the eNB proceeds to step 1 after sensing the channel to be idle during the slot durations of a defer duration T_{d}.

In 3 GPP LTE, multiplexing physical channels are considered at least the above aspects. In one example, multiplexing of PSCCH and the associated PSSCH (here, the “associated” means that the PSCCH at least carries information necessary to decode the PSSCH) are considered. In one instance, PSCCH and the associated PSSCH are transmitted using non-overlapping time resources. In another instance, the frequency resources used by the two channels are the same. In yet another instance, the frequency resources used by the two channels can be different. In yet another instance, PSCCH and the associated PSSCH are transmitted using non-overlapping frequency resources in the all the time resources used for transmission. The time resources used by the two channels are the same. In yet another instance, a part of PSCCH and the associated PSSCH are transmitted using overlapping time resources in non-overlapping frequency resources, but another part of the associated PSSCH and/or another part of the PSCCH are transmitted using non-overlapping time resources.

In one embodiment, at least two sidelink resource allocation modes are defined for NR-V2X sidelink communication. In such embodiment of mode 1, a base station schedules sidelink resource(s) to be used by UE for sidelink transmission(s). In such embodiment of mode 2, a UE determines (i.e., base station does not schedule) sidelink transmission resource(s) within sidelink resources configured by base station/network or pre-configured sidelink resources.

An eNB control of NR sidelink and gNB control of LTE sidelink resources may be separately considered in corresponding agenda items.

In mode-2 definition covers potential sidelink radio-layer functionality or resource allocation sub-modes (subject to further refinement including merging of some or all of them) where: a UE autonomously selects sidelink resource for transmission; a UE assists sidelink resource selection for other UE(s); a UE is configured with NR configured grant (type-1 like) for sidelink transmission; and/or a UE schedules sidelink transmissions of other UEs.

When a bursty packet arrives and the V2X UE transmits the bursty packet at the sidelink, the UE requests the resources used for the transmission from the gNB by sending a SR and BSR report to the gNB. If the aperiodic packet is large enough, the aperiodic packet needs more than one slot/mini-slot resource to complete the transmission of the bursty packet. The resource allocation for the aperiodic packet may be performed one-shot for multiple slots/mini-slots by the gNB, rather than dynamically allocating a resource for a slot/mini-slot each time. A DCI format is introduced for the gNB to indicate to the UE a set of resources that may be used by the UE to transmit the aperiodic packet. The benefit is that the control signaling in the Uu interface can be reduced. The resource allocation for aperiodic traffic can be extended to periodic traffic with some modification, e.g., additionally signaling the reservation interval for the periodic traffic.

In one embodiment, a set of resources with the same frequency RBs in consecutive slots/mini-slots are allocated for the UE by the gNB. In such embodiment, consecutive slots/mini-slots may not include those slots/mini-slots that are used for other purposes (e.g., slots/mini-slots determined by TDD UL/DL configuration).

In one embodiment, the DCI indicates the resource duration in a unit of slot/mini-slot. The duration may be in time unit of the sidelink resource pool on which the DCI schedules the T-F resource (e.g., number of sidelink slots/mini-slots). For each resource in a slot/mini-slot, the DCI also indicates the frequency RB location. Since frequency RB location is the same for all slots/mini-slots, there is only one frequency RB location indicated in the DCI.

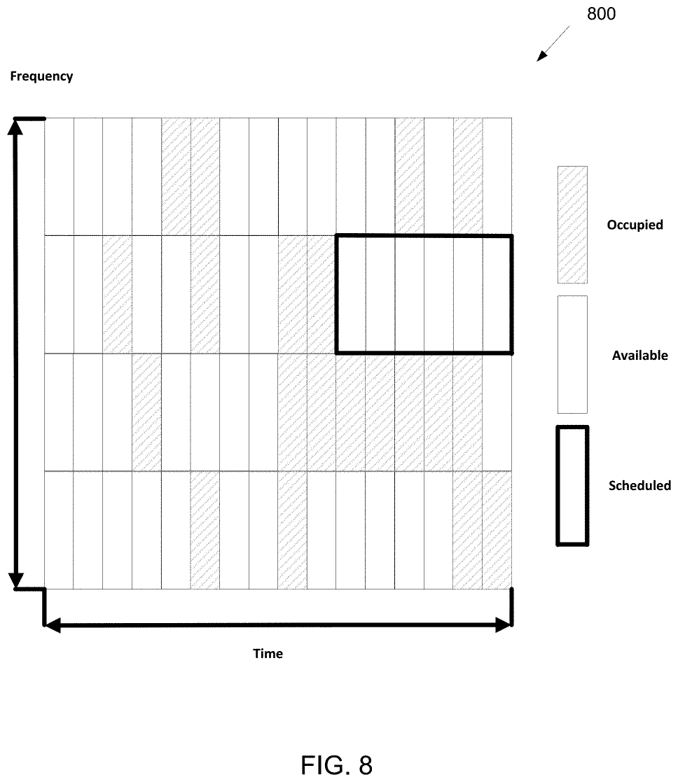

FIG. 8 illustrates an example scheduled six consecutive slot/mini-slot resource 800 according to embodiments of the present disclosure. The embodiment of the scheduled six consecutive slot/mini-slot resource 800 illustrated in FIG. 8 is for illustration only. FIG. 8 does not limit the scope of the present disclosure to any particular implementation.

FIG. 8 shows the scheduled six consecutive slot/mini-slot resources for a UE to transmit a bursty packet.

When there is a conflict in the indicated consecutive slot/mini-slot resources for the UE with resources reserved by other UEs, the gNB may signal to the UE whether the overlapped resources reserved by other UEs are preempted or skipped.

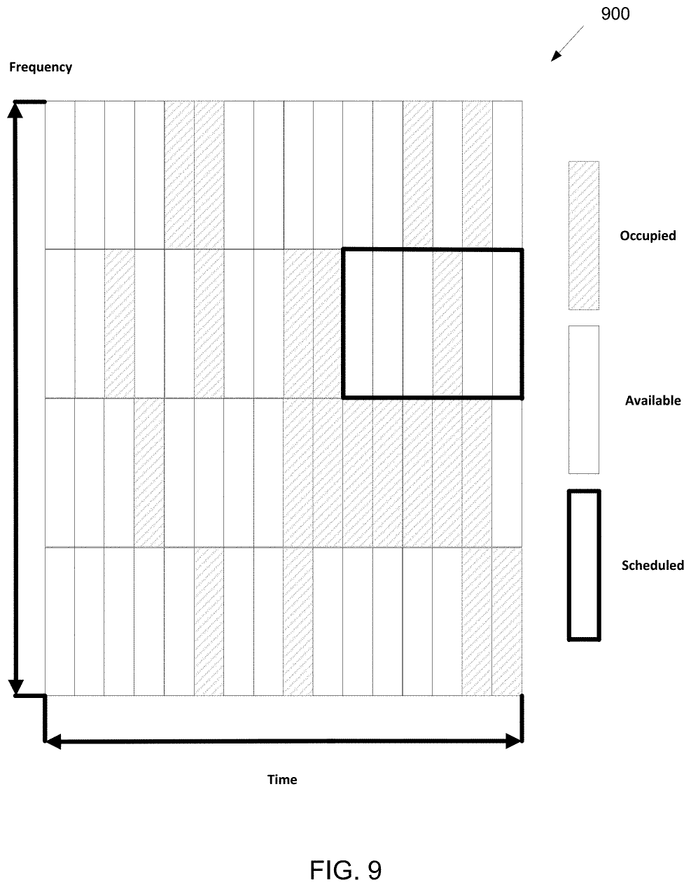

FIG. 9 illustrates another example scheduled six consecutive slot/mini-slot resource 900 according to embodiments of the present disclosure. The embodiment of the scheduled six consecutive slot/mini-slot resource 900 illustrated in FIG. 9 is for illustration only. FIG. 9 does not limit the scope of the present disclosure to any particular implementation.

FIG. 9 shows the scheduled six consecutive slot/mini-slot resources for a UE where one slot/mini-slot resource is reserved by another UE. If the gNB knows an overlapped resource reserved by another UE for transmission of a packet with lower priority than that of the scheduled UE (e.g., by reports from UEs to gNB) and the gNB cannot find other available resources for the UE, the gNB may still schedule the overlapped resources for the UE and carry a preemption indication in the DCI format to signal to the UE the resources the UE can preempt.

When the UE receives the DCI, the UE may use the overlapped resources for the transmission. If the resources that are scheduled and exclude the overlapped resources reserved by another UE are sufficient for the transmission, the gNB may indicate to the UE in the DCI format that the overlapped resources may not be used by the UE. When the UE receives the DCI, the UE may not use the overlapped resources for the transmission.

One embodiment is the preempted resources may be indicated in the DCI by a slot/mini-slot bitmap that shows the resources may be preempted and used by the scheduled UE.

When a different preemption indication channel from the SCI channel is required for the scheduled UE at the sidelink, the gNB may allocate the resource for the preemption indication channel and indicate the resource in the same or different DCI.

In one embodiment, the UE may decide whether the overlapped resources reserved by other UEs are preempted or skipped if the UE can detect the conflicted resources reserved by other UEs. The packet of the preempting UE may have a higher priority than that of the preempted UE.

Accordingly, the UE may set one or combination of the followings in the contents of the SCI format. The SCI format can be either a special SCI without an associated data channel or a SCI that is associated to a data channel.

The UE may set the channel occupancy time that shows the resource duration starting from the current slot/mini-slot the UE may use the resources for this bursty transmission. The channel occupancy time may be in number of sidelink slots/mini-slots.

The UE may set a preemption indication if necessary when there is some conflict with resources reserved by another UE to signal to that UE whether or not the conflicted resources are preempted for transmission of the UE.

If retransmission is configured for the UE, the gNB needs to determine the retransmission resources and carry the resource allocation field for retransmissions in the DCI format. The procedure that the gNB uses to determine the resources for retransmissions may be the same as above for initial transmissions. And the same resource allocation fields as initial transmission may be carried in the DCI format. There is a one-to-one association between the resources for each initial transmission and corresponding retransmission. When the UE receives the DCI, the UE can determine from the DCI the resources for each initial transmission and corresponding retransmission.

In one embodiment, a set of time-frequency (T-F) resource patterns are defined/configured by specs. A set of T-F resources is indicated by a DCI with a T-F resource pattern that indicates to the UE the resources that may be used by the UE for transmission of an aperiodic packet.

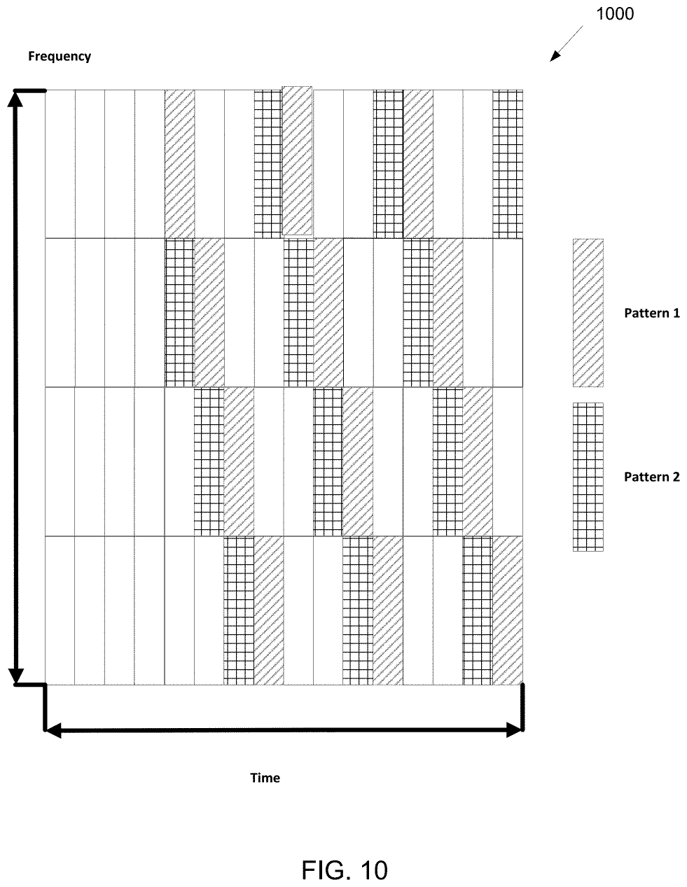

FIG. 10 illustrates an example T-F resource pattern 1000 according to embodiments of the present disclosure. The embodiment of the -F resource pattern 1000 illustrated in FIG. 10 is for illustration only. FIG. 10 does not limit the scope of the present disclosure to any particular implementation.

FIG. 10 shows an example where two T-F resource patterns (pattern 1 and pattern 2) are configured. In this embodiment, a T-F resource pattern may exclude those slots/mini-slots that are used for other purposes (e.g., slots/mini-slots determined by TDD UL/DL configuration). The duration of the pattern may be used by the aperiodic transmission or each transmission for periodic traffic may be indicated in the DCI. The duration may be in time unit of the sidelink resource pool on which the DCI schedules the T-F resource (e.g., number of sidelink slots/mini-slots or number of repeated patterns).

When there is a conflict in the indicated T-F resource pattern for the UE with resources reserved by other UEs, the gNB may indicate to the UE whether the overlapped resources reserved by other UEs are preempted or skipped.

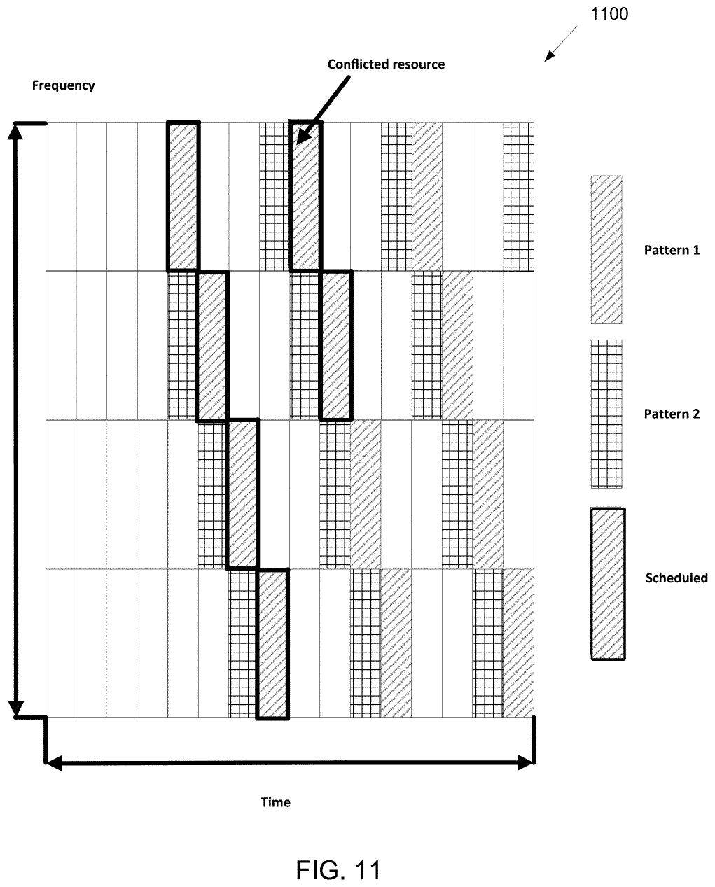

FIG. 11 illustrates an example scheduled T-F resources 1100 according to embodiments of the present disclosure. The embodiment of the scheduled T-F resources 1100 illustrated in FIG. 11 is for illustration only. FIG. 11 does not limit the scope of the present disclosure to any particular implementation.

FIG. 11 shows the scheduled T-F resources for a UE where one slot/mini-slot resource is reserved by another UE. If the gNB knows an overlapped resource reserved by another UE for transmission of a packet with lower priority than that of the scheduled UE (e.g., by reports from UEs to gNB) and the gNB cannot find other available resources for the UE, the gNB may still schedule the T-F resources for the UE including the conflicted resource and carry a preemption indication in the DCI format to signal to the UE the resources the UE can preempt.

When the UE receives the DCI, the UE may use the overlapped resources for the transmission. If the resources that are scheduled and exclude the overlapped resources reserved by another UE are sufficient for the transmission, the gNB may indicate to the UE in the DCI format that the overlapped resources may not be used by the UE. When the UE receives the DCI, the UE may not use the overlapped resources for the transmission.

The preempted resources may be indicated in the DCI by a slot/mini-slot bitmap that shows the resources may be preempted and used by the scheduled UE.

When a different preemption indication channel from the SCI channel is required for the scheduled UE at the sidelink, the gNB may allocate the resource for the preemption indication channel and indicate the resources in the same or different DCI.

In one embodiment, the UE may decide itself whether the overlapped resources reserved by other UEs are preempted or skipped if the UE can detect the conflicted resources reserved by other UEs. The packet of the preempting UE may have a higher priority than that of the preempted UE.

Accordingly, the UE may set one or combination of the followings in the contents of the SCI format. The SCI format can be either a special SCI without an associated data channel or a SCI that is associated to a data channel.

The UE may set the T-F resource pattern that shows the T-F resource time slots in which the UE may use the resources and shows the T-F resource frequency RB locations in each slot/mini-slot for this bursty transmission.

The UE may set a preemption indication if necessary when there is some conflict with resources reserved by another UE to signal to that UE whether or not the conflicted resources are preempted for transmission of the UE.

In each SCI, the UE may set the channel occupancy time starting from current slot of the SCI that shows the resource duration the UE may use the resources for this bursty transmission. The channel occupancy time may be in number of sidelink slots/mini-slots or number of repeated patterns). For example, each pattern occupies 4 slots, with 2 slots used for transmission and the other slots muted. The transmission for aperiodic traffic may occupy 8 slots. Then the channel occupancy time may be indicated by 8 slots/2=4 repeated patterns or 8 slots in the SCI for the first available slot of the scheduled T-F resources.

If retransmission is configured for the UE, the gNB needs to determine the retransmission resources and carry the resource allocation field for retransmissions in the DCI format. A different T-F resource pattern may be determined for the UE for retransmission. The procedure that the gNB determines the T-F resources for retransmissions may be the same as above for initial transmissions. And the same resource allocations fields as initial transmission may be carried in the DCI format. There is a one-to-one association between the resources for each initial transmission and corresponding retransmission. When the UE receives the DCI, the UE can determine from the DCI the resources for each initial transmission and corresponding retransmission.

In one embodiment, a set of resources with the same or not same frequency RBs in not necessarily consecutive slots/mini-slots are allocated for the UE by the gNB. In this Approach, the resources may not include those slots/mini-slots that are used for other purposes (e.g., slots/mini-slots determined by TDD UL/DL configuration).

In the aforementioned embodiment, if the PSFCH resource can be indicated in the DCI for HARQ-based retransmissions, the PSFCH presence can be indicated either explicitly or implicitly by the DCI or by higher layers. If HARQ/retransmission can be enabled or disabled by a SCI, the configuration (either by DCI or higher layers) from gNB/network may have a higher priority than SCI signaling. For example, a configuration from gNB/network indicates the HARQ/retransmissions need to be disabled, the UE cannot enable the HARQ/retransmissions in the SCI.

In the aforementioned embodiments, the resource indicated in the DCI can be either for a same TB or for different TBs. It can include retransmission resources (and corresponding PSFCH) or only initial transmission resources depending upon whether HARQ/retransmission is enabled.

A separate preemption indication channel may be introduced and used to indicate to other UE the resources reserved by other UEs that the UE needs to preempt. A preemption indication may be transmitted earlier than a SCI that is associated with a data channel.

When a different preemption indication channel from the SCI channel associated with a data channel is required for a scheduled UE, the gNB may allocate the resource for the preemption indication channel and indicate the resource in the same or different DCI that indicates the resources for the SCI channel and the associated data channel.

The time and frequency RB location of the preemption indication channel may be indicated by the DCI. The time indication may be a time slot/mini-slot offset to the time slot/mini-slot when the DCI is received by the UE. When a dedicated resource pool is configured for use by preemption indication channels, the frequency domain resource allocated for a preemption indication channel may also be indicated by a frequency resource index numbered in the resource pool.

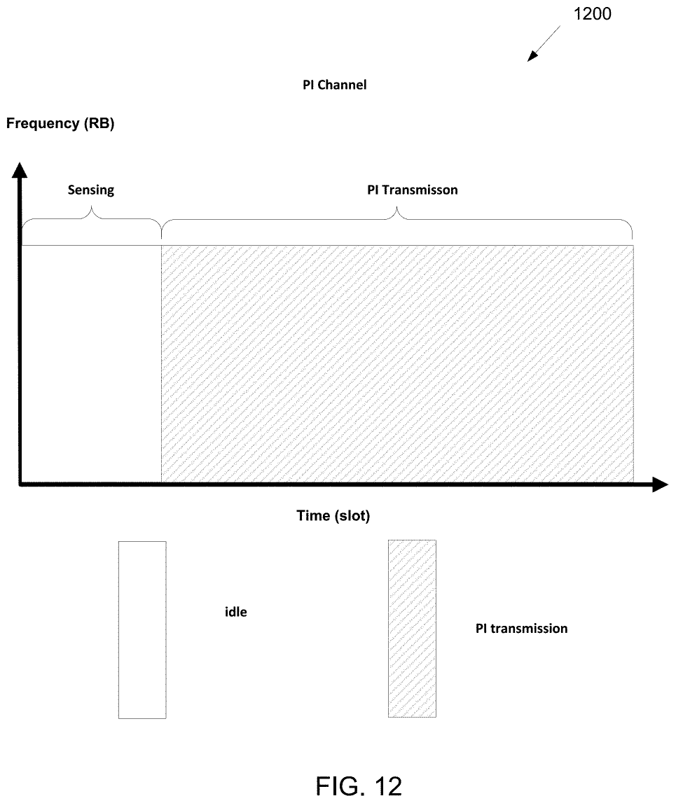

FIG. 12 illustrates an example PI channel structure 1200 according to embodiments of the present disclosure. The embodiment of the PI channel structure 1200 illustrated in FIG. 12 is for illustration only. FIG. 12 does not limit the scope of the present disclosure to any particular implementation.

A PI channel structure is shown in FIG. 12. It consists of two parts: sensing part and PI transmission part. When the sensing is successful in the first OFDM symbols, the PI transmission may start from next OFDM symbol until the end of the slot.

A preemption indication may be transmitted starting at any OFDM symbol in a slot. When a channel is sensed to be busy at any OFDM symbol, it may be shown that another UE is transmitting the preemption indication in the slot, and the UE needs to wait until next slot to begin the sensing procedure again. When the channel is sensed to be idle for a (pre)configured number of OFDM symbols in one slot, the UE can start the transmission of the preemption indication from next OFDM symbol until the end of the slot.

The number of OFDM symbols that need to be sensed to be idle in one slot may adapt accordingly if the UE fails in previous slots. An initial value (N) is set to the number of OFDM symbols that needs to be sensed to be idle for preemption indication in the first slot. When the UE fails to sense in current slot, the number of OFDM symbols that needs to be sensed to be idle for preemption indication in next slot can be decreased by a value (e.g., n) to N-n.

This procedure may be repeated within the selection window until either the sensing succeeds or the number of OFDM symbols that needs to be sensed to be idle is decreased to zero. When the number of OFDM symbols that needs to be sensed to be idle is decreased to zero, the UE can use the channel in a next slot without sensing. A selection window can be defined as a set of transmission slots that can meet the latency requirement for transmission.

There is a case where one UE transmits a preemption indication in the same slot as another UE, but in different frequency RB location. In this case, the UE and the other UE cannot receive the preemption indication transmitted from each other due to half duplex problems. To avoid the issue, there can be some constraint that only one preemption indication channel may be configured in each slot. Another constraint for the resource allocation of preemption indication is that a preemption indication can only be transmitted by the UE in the slot when the targeted UE doesn't transmit.

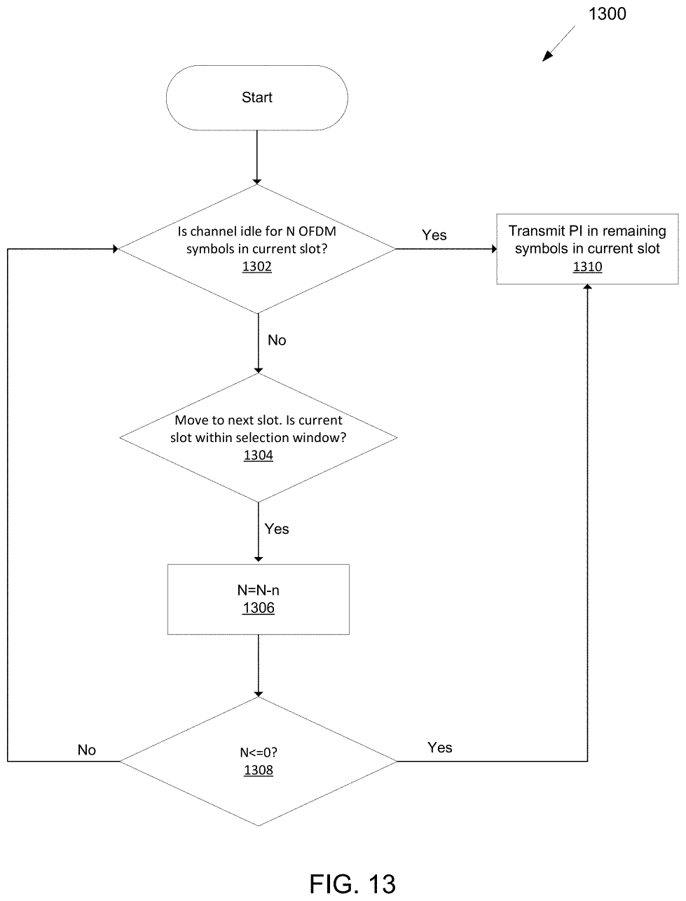

FIG. 13 illustrates a flowchart of a method 1300 for preemption indication according to embodiments of the present disclosure. The embodiment of the method 1300 illustrated in FIG. 13 is for illustration only. FIG. 13 does not limit the scope of the present disclosure to any particular implementation.

The whole procedure is shown in FIG. 13 where there is only one preemption indication channel configured in one slot.

As illustrated in FIG. 13, the method 1300 in step 1302 determines whether the channel is idle for N OFDM symbol in current slot. In step 1302, if the channel is idle, the method 1300 in step 1304 moves to a next slot and determines whether a current slot is within a selection window. In step 1304, if the current slot is within the selection window, the method 1300 determines N=N−n. In step 1308, the method 1300 determines N<=0. If N<=0 in step 1308, the method performs 1310. If no in step 1308, the method 1300 performs step 1302. In step 1310, the method 1300 transmits PI in remaining symbols in current slot.

In one embodiment, there can be multiple preemption indication channels in a same slot but in different frequency RB locations. In this case, the UE can perform multiple LBT sensing separately for preemption indication channel in the same slot but in different frequency RB locations. The UE may choose the preemption indication channel with the earliest starting OFDM symbol. When there are multiple preemption indication channels with same earliest starting OFDM symbol, the UE may randomly choose one channel to transmit the preemption indication.

When the minimum scheduling unit is mini-slot, the above can also be applicable with slot replaced by mini-slot.

When the minimum scheduling unit is mini-slot, the following can also be applicable with slot replaced by mini-slot.

In one embodiment, consecutive time slots with same frequency RB location are provided.

When a LBT block contains consecutive slots with same frequency RBs used for LBT sensing contains a resource reserved by another UE. The UE may still select and use this LBT block for LBT sensing. The resources reserved by another UE may be either preempted and used or not used by the UE for the aperiodic packet transmission. In such embodiment, consecutive slots/mini-slots may exclude those slots/mini-slots that are used for other purposes (e.g., slots/mini-slots determined by TDD UL/DL configuration).

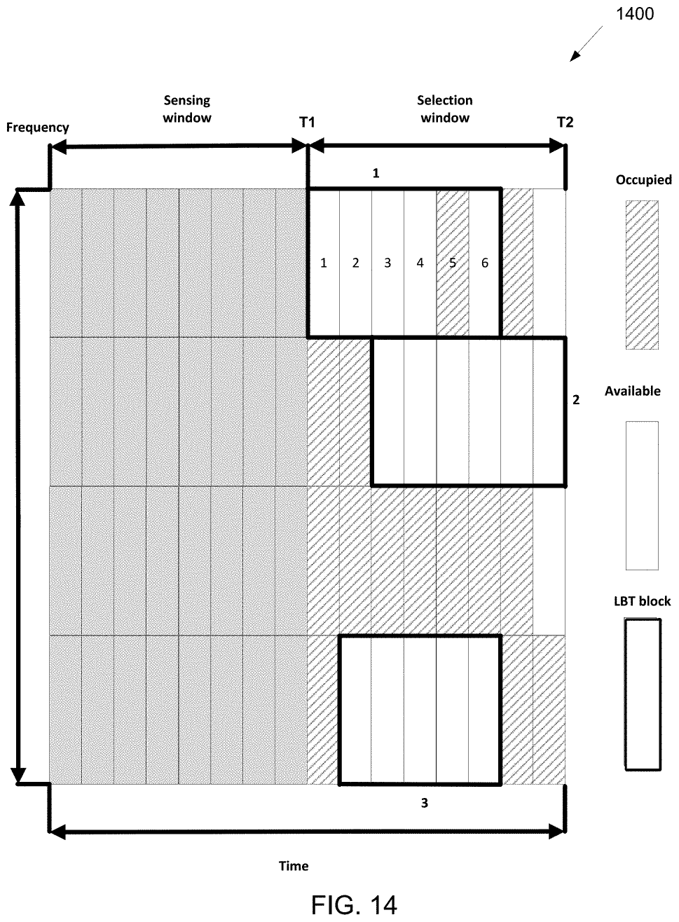

FIG. 14 illustrates an example resource allocation 1400 according to embodiments of the present disclosure. The embodiment of the resource allocation 1400 illustrated in FIG. 14 is for illustration only. FIG. 14 does not limit the scope of the present disclosure to any particular implementation.

As illustrated in FIG. 14, the UE needs one frequency resource in three consecutive slots to transmit an aperiodic packet. A LBT block 1 may be selected by the UE for LBT sensing even if there is a reserved resource in the middle of the LBT block.

In such example, when the UE performs LBT for LBT block 1 and succeeds in the second slot in LBT block 1, the UE can transmit the aperiodic packet from the third slot in LBT block 1 for three slots (i.e., slot number 3, 4 and 6).

When the resources reserved by another UE are not used for transmission by the UE, the channel occupancy time in the SCI of the UE may include the slots that are reserved by another UE so that other UEs performing sensing may know the time duration the UE needs to use the channel. The channel occupancy time in the SCI may exclude slots that are used for other purposes (e.g., slots/mini-slots determined by TDD UL/DL configuration).

In such example, when the UE performs LBT for LBT block 1 and succeeds in the third slot in LBT block 1, the UE doesn't have sufficient resource for transmission (needs 3 slots in this example). The UE may preempt and use the resources reserved by another UE for the transmission if the transmission has a higher priority than that of another UE. In this case, slot number 4, 5 and 6 are used by the UE for the aperiodic packet transmission.

When the resources reserved by another UE are used for transmissions by the UE, the channel occupancy time in the SCI of the UE may include the slots that are reserved by another UE so that other UEs performing sensing may know the time duration the UE needs to use the channel. In one example, information that the UE needs to signal is the preemption indication that indicates the resources that are preempted by the UE. The preemption indication can be in a separate preemption indication channel or in the same SCI channel with associated data channel.

In one embodiment, the UE performs LBT one more time for the resources after the reserved resources. The LBT procedure is the same as the LBT procedure done in the beginning of the LBT block. In this example, slot 6 is after the reserved resource of slot 5. The UE needs to perform LBT for slot 6 one more time.

In one embodiment, the UE performs LBT one more time for the resources after the reserved resources. The LBT procedure may be different from the LBT procedure done in the beginning of the LBT block. The UE may transmit the transmission immediately after sensing the channel to be idle for at least a sensing interval with contention window set to zero. In this example, slot 6 is after the reserved resource of slot 5. The UE needs to perform a different LBT procedure for slot 6 one more time.

In one embodiment, consecutive time slots with different frequency RB location are provided.

If there are no sufficient consecutive time slots with same frequency RB location for LBT sensing, other resources that are located in consecutive time slots but with different frequency RB location may also be considered for LBT sensing. Channel occupancy time is carried in each SCI to indicate consecutive time duration with same frequency RB locations that the UE uses for transmission. A LBT subblock is a subblock of consecutive time resources with same frequency RB locations. The UE needs to perform a LBT sensing separately for each subblock. In this embodiment, consecutive slots may exclude those slots/mini-slots that are used for other purposes (e.g., slots/mini-slots determined by TDD UL/DL configuration).

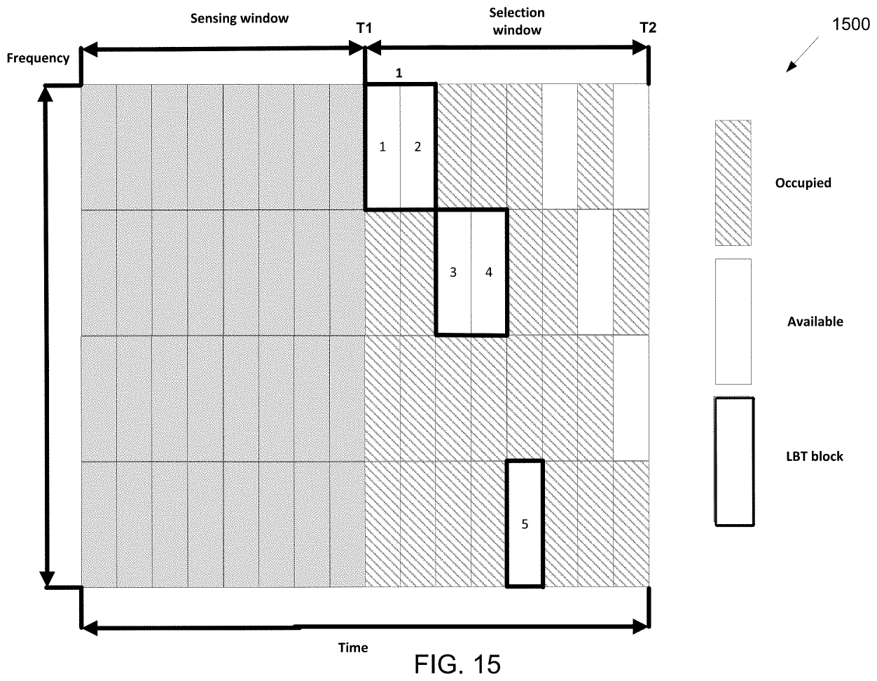

FIG. 15 illustrates another example resource allocation 1500 according to embodiments of the present disclosure. The embodiment of the resource allocation 1500 illustrated in FIG. 15 is for illustration only. FIG. 15 does not limit the scope of the present disclosure to any particular implementation.

As illustrated in FIG. 15, there are three subblocks for LBT block 1. The UE needs to perform LBT sensing separately for each subblock with slots 1-2, 3-4 and 5.

In one embodiment, the UE performs LBT one more time for each subblock. The LBT procedure is the same as the LBT procedure done in the first LBT subblock.

In one example, the UE performs LBT one more time for each subblock. The LBT procedure may be different from the LBT procedure done in the first LBT subblock. The UE may transmit the transmission immediately after sensing the channel to be idle for at least a sensing interval with a contention window set to zero.

In one embodiment, non-consecutive time slots with different frequency RB location are provided.

If there are no sufficient consecutive time slots with same frequency RB location for LBT sensing, other resources that are located in non-consecutive time slots but with same or different frequency RB location may also be considered for LBT sensing. Channel occupancy time is carried in each SCI to indicate consecutive time duration with same frequency RB locations that the UE uses for transmission. A LBT subblock is a subblock of consecutive time resources with same frequency RB locations. The UE needs to perform a LBT sensing separately for each subblock. In this embodiment, consecutive slots may exclude those slots/mini-slots that are used for other purposes (e.g., slots/mini-slots determined by TDD UL/DL configuration).

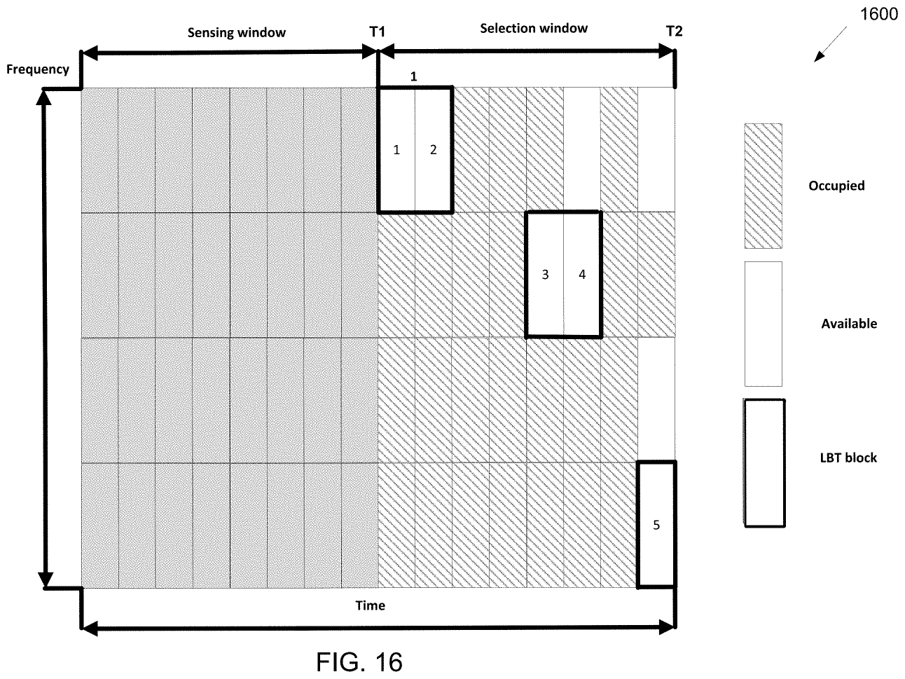

FIG. 16 illustrates yet another example resource allocation 1600 according to embodiments of the present disclosure. The embodiment of the resource allocation 1600 illustrated in FIG. 16 is for illustration only. FIG. 16 does not limit the scope of the present disclosure to any particular implementation.

As illustrated in FIG. 16, there are three subblocks for LBT block 1. The UE needs to perform LBT sensing separately for each subblock with slots 1-2, 3-4 and 5.

In one embodiment, the UE performs LBT one more time for each subblock. The LBT procedure is the same as the LBT procedure done in the first LBT subblock.

In one example, the UE performs LBT one more time for each subblock. The LBT procedure may be different from the LBT procedure done in the first LBT subblock. The UE may transmit the transmission immediately after sensing the channel to be idle for at least a sensing interval with contention window set to zero.

The following applies at least to the broadcast transmission for V2X. For an aperiodic packet transmission, the retransmission resources need to be sensed separately. Because the SCI of the initial transmission needs to carry the information (T-F resources) of retransmission resources, the retransmission resources need to be known by the UE at the time of initial transmissions. So the retransmission resources need to be determined at the same time as or before corresponding initial transmission. There are two approaches for determining retransmission resources.

In one embodiment, the same procedure as the LBT procedure for the initial transmission is applied to the UE for determining corresponding retransmission resources. The LBT procedure for the retransmission needs to start at least the same time as corresponding initial transmission. The resource selection constraint here is that retransmission resource cannot be in the same slot as corresponding initial transmission.

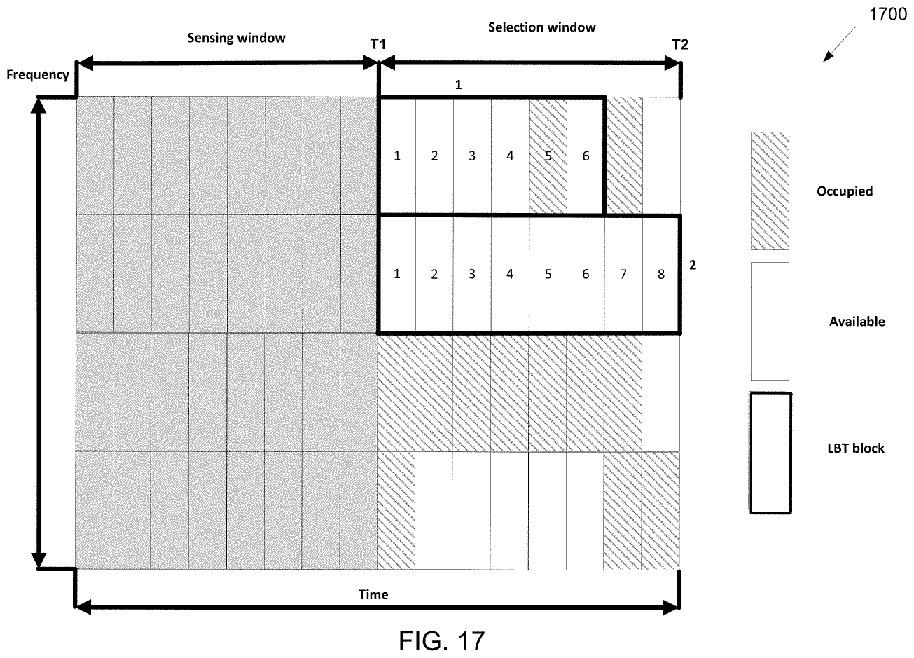

FIG. 17 illustrates yet another example resource allocation 1700 according to embodiments of the present disclosure. The embodiment of the resource allocation 1700 illustrated in FIG. 17 is for illustration only. FIG. 17 does not limit the scope of the present disclosure to any particular implementation.

As illustrated in FIG. 17, where LBT is performed on LBT block 1 for initial transmissions and LBT is performed for retransmissions on LBT block 2. If both LBT block 1 and LBT block 2 are sensed to be idle in the first slot, the initial transmissions are transmitted in slot number 2, 3, and 4. The earliest retransmissions can start from slot number 5 and can last until slot number 7. The resources for retransmissions in slot number 1-4 may be wasted and cannot be used for transmissions of the packet.

In one embodiment, a different procedure from the LBT procedure for the initial transmission is applied to the UE for determining corresponding retransmission resources. The UE uses LBT for resource selection for the initial transmission, whereas the UE uses a similar procedure as LTE mode-4 like resource selection for retransmission resources. The resource selection procedure may repeat for each retransmission. During sensing for each retransmission, the UE may exclude resources within selection window where there is resource allocated for any initial transmissions and retransmissions for this UE itself.

In one embodiment. LBT resource allocation after resource exclusion on a selected time-frequency resource is: 1) set N=Nᵢₙᵢₜ, where Nᵢₙᵢₜ is a number between 0 and Nₘₐₓ, and go to step 2; 2) if N>0 and the eNB/gNB chooses to decrement the counter, set N=N−1, go to step 2; else, go to step 3; sense the channel (a selected time-frequency resource) for a slot duration. If the slot duration is idle, stop; else, go to step 4; and the LBT procedure is suspended, and wait until next resource allocation slot or a backoff number of resource allocation slots to resume LBT procedure. And go to step 1.

The slot duration defined here can be configured to be symbol duration or more or less than symbol duration (e.g., a resource allocation slot). Specifically, when the slot duration is defined as a symbol duration, step 2 and step 3 means the UE only senses or listens to the channel (a selected time-frequency resource) in the Nth symbol.

For selection of Nᵢₙᵢₜ, there are a few approaches. These approaches may be applied to any other LBT resource allocation schemes where Nᵢₙᵢₜ is involved.

In one example, Nᵢₙᵢₜ is selected randomly from between 0 and Nₘₐₓ for each time-frequency resource where LBT is performed when a LBT resource allocation is started or resumed.

In another example, Nᵢₙᵢₜ is selected randomly from between 0 and Nₘₐₓ for each time-frequency resource where LBT is performed when a LBT resource allocation is started. When LBT resource allocation is resumed, the LBT resource allocation uses the same Nᵢₙᵢₜ when LBT resource allocation is suspended.

In yet another example, Nᵢₙᵢₜ is selected from between 0 and Nₘₐₓ for each time-frequency resource where LBT is performed when a LBT resource allocation is started or resumed. A mapping table may be introduced that maps a priority level to a value of Nᵢₙᵢₜ. One example is as below. Nᵢₙᵢₜ is set to 1 for Priority level of 1; Nᵢₙᵢₜ is set to 2 for Priority level of 2; Nᵢₙᵢₜ is set to 3 for Priority level of 3 as shown in TABLE 1.

TABLE 1
Value of Nᵢₙᵢₜ

| Priority level | Nᵢₙᵢₜ |
|---|---|
| 1 | 1 |
| 2 | 2 |
| 3 | 3 |

In another example, Nᵢₙᵢₜ is selected from between 0 and Nₘₐₓ for each time-frequency resource where LBT is performed every time when a LBT resource allocation is started or resumed considering both/either channel congestion level and/or priority level of the packet for transmission. Channel congestion level may be measured in each or all time-frequency resource(s) where LBT is performed. The measurement granularity for channel congestion level in frequency domain may be in the unit of the scheduling granularity (e.g., frequency subchannel). One example is per-subchannel congestion level is measured.

The higher the congestion level, the higher value Nᵢₙᵢₜ may take.

The lower the priority level, the higher value Nᵢₙᵢₜ may take.

Mapping tables that map both/either a congestion level and/or a priority level to a value of Nᵢₙᵢₜ are used.

One example is shown below. When a channel congestion level is lower than a (pre-)configured threshold, the mapping table is used to map from a priority level to a Nᵢₙᵢₜ. When a channel congestion level is not lower than a threshold, another mapping table is used to map from a priority level to a Nᵢₙᵢₜ.

For channel congestion level <(pre-)configured threshold as shown in TABLE 2, else shown in TABLE 3.

TABLE 2
Value of Nᵢₙᵢₜ

| Priority level | Nᵢₙᵢₜ |
|---|---|
| 1 | 1 |
| 2 | 2 |
| 3 | 3 |

TABLE 3
Value of Nᵢₙᵢₜ

| Priority level | Nᵢₙᵢₜ |
|---|---|
| 1 | 3 |
| 2 | 3 |
| 3 | 3 |

When a selected time-frequency resource is sensed to be busy, then LBT procedure is suspended, and the UE waits a backoff number of resource allocation slots to resume LBT procedure. These backoff mechanisms may be used for any LBT-like resource allocation procedures. There a few approaches for determination of the backoff counter.

In one embodiment, the backoff counter is selected randomly from between 0 and N_{slot_max} for each time-frequency resource where LBT is performed when a LBT resource allocation is suspended.

In one embodiment, the backoff counter is selected between 0 and for each time-frequency resource where LBT is performed when a LBT resource allocation is suspended considering both/either channel congestion level and/or priority level of the packet for transmission. A channel congestion level may be measured in each or all time-frequency resource(s) where LBT is performed. The measurement granularity for channel congestion level in frequency domain may be in the unit of the scheduling granularity (e.g., frequency subchannel).

The higher the congestion level, the higher value the backoff counter may take.

The lower the priority level, the higher value the backoff counter may take.

Mapping tables that map both/either a congestion level and/or a priority level to a value of Nᵢₙᵢₜ are used.

One example is shown below. When a channel congestion level is lower than a (pre-)configured threshold, the mapping table is used to map from a priority level to a backoff counter. When a channel congestion level is not lower than a threshold, another mapping table is used to map from a priority level to a backoff counter.

For channel congestion level <(pre-)configured threshold, the backoff counter is provided in TABLE 4, else provided in TABLE 5

TABLE 4
Backoff counter

| Priority level | Backoff counter |
|---|---|
| 1 | 1 |
| 2 | 2 |
| 3 | 3 |

TABLE 5
Backoff counter

| Priority level | Backoff counter |
|---|---|
| 1 | 3 |
| 2 | 3 |
| 3 | 3 |

In LTE cellular V2X, the UE broadcasts a SCI+TB to all UEs without supporting unicast or multicast in the physical layer. A UE doesn't need to decode the data TB if the data is not intended for the UE and there is a support for unicast or multicast in the physical layer. Otherwise, the UE needs to decode the data anyway and forward the decoded data to upper layers that may decide if the data is intended for the UE. It may bring more power consumption to the UE. Therefore, there is a need to specify operations for a support for unicast and multicast in the physical layer.

In LTE cellular V2X, the UE sends a TB with MCS determined by high layers without any channel state information available. Better resource utilization can be achieved if channel state information is acquired by the sender UE. Therefore, there is a need to specify operations for supporting SRS/CSI channels.

If different SCSs and TTI durations are configured for different resource pools, there is a benefit that when one SCI in one resource pool schedules a PSSCH in another resource pool the UE only needs to monitor the resource pool where the SCI resides. Another benefit is SCI resources can be configured with a resource pool in a frequency resource band with higher reliability. There is no SCI format to support this requirement. Therefor there is a need to specify the SCI format in order to support different SCSs and TTI durations between PSSCH and PSCCH resource pools.

There is a NR V2X requirement for support of Uu-based sidelink resource allocation/configuration with LTE Uu and NR Uu to control NR sidelink and NR Uu to control LTE sidelink. Therefore, there is a need to specify an LTE DCI format to support over NR sidelink from the LTE network.

In LTE V2X, there is no standards support for sidelink unicast and multicast in the physical layer. The physical layer sends a message to all UEs that can receive the message. In the MAC layer, the receiver UE filters the received message by DST field in the SL-SCH subheader. The DST field in the SL-SCH subheader can be 16 bits or 24 bits. If the DST field is 16 bits, the DST field carries the 16 most significant bits of the destination layer-2 ID. If the DST field is 24 bits, the DST field is set to the destination layer-2 ID. The destination layer-2 ID is set to the identifier provided by upper layers. If the V field is set to “0001,” this identifier is a groupcast identifier. If the V field is set to “0010,” this identifier is a unicast identifier;

A benefit to support sidelink unicast and multicast is: a UE doesn't need to decode the data TB if the data is not intended for the UE. Otherwise, the UE needs to decode the data anyway and forward the decoded data to upper layer for further processing.

In order to support sidelink unicast and multicast in the physical layer, a UE ID may be carried in the SCI, either explicitly or implicitly.

In one embodiment, in the SCI, 16 CRC parity bits are produced for the SCI message payload. A CRC is attached to each SCI message payload. The identity of the UE is included in the CRC calculation implicitly, i.e., the CRC is scrambled with the corresponding UE identity. Upon reception of a SCI, the UE may check the CRC using a set of assigned IDs. If the CRC checks, the message is declared to be correctly received and intended for the UE.

For unicast and multicast, the identity of the UE can be the destination layer-2 ID assigned by upper layers. Since the number of CRC bits is 16 and the number of destination layer-2 ID is 24, only part of the destination layer-2 ID can be implicity carried by the CRC. If the UE passes the CRC check in the physical layer, there is a possibility that the message is not intended for the UE. The MAC layer needs to further check whether or not the message is intended for the UE.

In one example, the most significant 16 bits of destination layer-2 ID is implicitly carried by the CRC. i.e., the CRC is scrambled with the most significant 16 bits of destination layer-2 ID.

In another example, the least significant 16 bits of destination layer-2 ID is implicitly carried by the CRC. i.e., the CRC is scrambled with the least significant 16 bits of destination dayer-2 ID.

In yet another example, other 16 bits-long part of destination layer-2 ID is implicitly carried by the CRC. i.e., the CRC is scrambled with other 16 bits-long part of destination layer-2 ID. For example, the middle 16 bits of destination layter-2 ID is implicitly carried by the CRC.

In yet another example, a new 16 bits-long number produced from destination layer-2 ID is implicitly carried by the CRC. i.e., the CRC is scrambled with a new 16 bits-long number produced from destination layer-2 ID. There is an algorithm that is known to both the transmitter and the receiver and produces the new 16 bits-long number.

In order to maintain a backward compatibility with a legacy SCI that is broadcast, a CRC is not scrambled with any UE identifier for broadcast SCI. At the receiver side, the UE checks the CRC first without using any UE ID to scramble the CRC. If the CRC check passes, the message is declared to be correctly received and be a broadcast message. If the CRC check fails, the UE checks the CRC using the assigned UE IDs (either unicast ID or multicast ID) to scramble the CRC and check the CRC again. If the CRC check passes this time, the message is declared to be correctly received and be intended for the UE.

If there is no backward compatibility in consideration with a legacy SCI that is broadcast, a CRC is scrambled with a broadcast identifier for broadcast SCI. At the receiver side, the UE checks the CRC first using this broadcast ID to scramble the CRC. If the CRC check passes, the message is declared to be correctly received and be a broadcast message. If the CRC check fails, the UE checks the CRC using the assigned UE IDs (either unicast ID or multicast ID) to scramble the CRC and check the CRC again. If the CRC check passes this time, the message is declared to be correctly received and be intended for the UE.

In one embodiment, a UE ID may be carried in the SCI explicitly. There is a SCI field that exists in the SCI format. Similarly, for unicast and multicast, the UE ID can be the destination layer-2 ID assigned by upper layers or part of the destination layer-2 ID. For broadcast, the UE ID can be a broadcast ID that is configured or predefined and are known by both the sender and receiver UE. If part of destination layer-2 ID is carried in the SCI, and the UE passes the CRC check in the physical layer, There is a possibility that the message is not intended for the UE. The MAC layer needs to further check whether or not the message is intended for the UE.

An SRS/CSI report is feedback by the receiver for acquiring the channel state information for better resource utilization. There is no support for SRS/CSI in LTE V2X.

An SRS/CSI request may be carried in the transmitter SCI format. The destination UE ID in the SCI format defines the UE that may transmit SRS/CSI in the SRS/CSI channel that is defined as follows if an SRS/CSI request is indicated in the SCI format.

In the SRS/CSI request, if there is an association between the PSCCH and the SRS/CSI channel, a single bit can be carried by the SRS/CSI request to trigger the SRS/CSI transmission by the PSCCH receiver. If there is no fixed association between the PSCCH and the SRS/CSI channel, a resource indication for SRS/CSI channel may be carried by the SRS/CSI request field.

A separate or shared resource pool is defined for the SRS/CSI resource. For a separate SRS/CSI resource, only SRS/CSI is transmitted in the slot. For a shared SRS/CSI resource, SRS/CSI is transmitted in the same slot as PSSCH. PSSCH transmission is rate-matched or punctured for the transmitted SRS/CSI resource elements.

A slot time and frequency pattern can be configured by higher layers that indicate the time slots and frequency resource location in each slot that can be used to transmit for the SRS/CSI channel. In the time slot pattern, a bitmap b₀, b₁, b₂ . . . b_{N″-1} is determined using bⱼ=a_{j mod N}_{_{B}}, for 0≤j<N′, where a₀, a₁, a₂, . . . , a_{N}_{_{B}}₋₁ and N_{B} are the bitmap and the length of the SRS/CSI bitmap indicated by higher layers respectively. A slot j (0≤j<N′) belongs to the SRS/CSI resource pool if bⱼ=1. Frequency pattern in the SRS/CSI slot is also configured by higher layers that define the resource elements in each OFDM symbol to be used by SRS/CSI transmissions.

Multiple SRS/CSI channels can be multiplexed in the same T-F RB SRS/CSI resource. If there is an association between the SCI that trigger the SRS/CSI transmission and corresponding SRS/CSI channel, the association is defined as follows.

In one embodiment of adjacent PSCCH+PSSCH, for adjacent PSCCH+PSSCH, a PSCCH+PSSCH resource pool is (pre)configured such that a UE always transmits PSCCH and the corresponding PSSCH in adjacent resource blocks in a slot, PSCCH resource m is the set of contiguous resource blocks with the physical resource block number n_{PRB}=n_{subCHRBstart}+m*n_{subCHsize}+j for j=0 . . . n_{PSCCCHsize} where n_{subCHRBstart} and n_{subCHsize} are the starting RB index and subchannel size of the PSCCH+PSSCH resource pool that are given by higher layer parameters startRBSubchannel and sizeSubchannel, respectively. The parameter n_{PSCCCHsize} is the number of RBs for a PSCCH resource.

The time slots for PSCCH/PSSCH channels that are associated with a same slot SRS/CSI resource is configured by higher layers or pre-defined.

The frequency RBs of the associated SRS/CSI resource is in the same frequency subchannels as PSCCH+PSSCH subchannels indicated by the PSCCH.

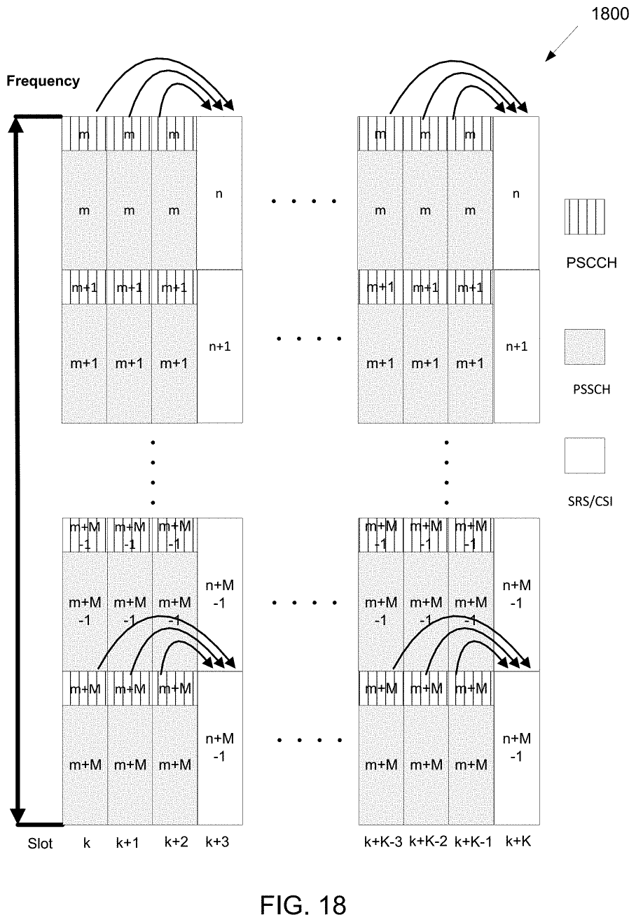

In a same time slot, multiple SRS/CSI channels by multiple UE can be multiplexed in a TDM manner, FDM manner, or CDM manner and so on. How SRS/CSI channels are multiplexed in the same T-F SRS/CSI resource is configured by higher layers or pre-defined. One example is shown in FIG. 18.

FIG. 18 illustrates an example CSI/SRS resource 1800 according to embodiments of the present disclosure. The embodiment of the CSI/SRS resource 1800 illustrated in FIG. 18 is for illustration only. FIG. 18 does not limit the scope of the present disclosure to any particular implementation.

As shown in FIG. 18, PSCCH resources m in slots k, k+1, and k+2 are associated with the SRS/CSI channel resource n in slot k+3. PSCCH resources m+M in slots k, k+1, and k+2 are associated with the SRS/CSI channel resource n+M in slot k+3. How these 3 SRS/CSI channels are multiplexed in the same T-F SRS/CSI resource is configured by higher layers or pre-defined.

If the number of PSCCH+PSSCH subchannels by different UEs in different time slots indicated by their corresponding SCIs associated with a same slot SRS/CSI channel frequency resource is different, the multiplexing granularity for these SRS/CSI channels can be per SRS/CSI subchannel. That means SRS/CSI channels are multiplexed separately in each SRS/CSI subchannel frequency resource associated with PSCCH+PSSCH subchannels.

For example, as illustrated in FIG. 18, it may be assumed that PSCCH/PSSCH subchannels m and m+1 in slot k are used by UE1, PSCCH/PSSCH subchannels m and m+1 in slot k+1 are used by a UE2 and a UE3, and PSCCH/PSSCH subchannels m and m+1 in slot k+2 are used by a UE4 and a UE5, In slot k+3, SRS/CSI resource n is multiplexed by the UE1, the UE2 and the UE4, whereas SRS/CSI resource n+1 is multiplexed by the UE1, the UE3 and the UE5.

In one embodiment of non-adjacent PSCCH+PSSCH, for non-adjacent PSCCH+PSSCH, different resource pools for PSCCH and PSSCH are (pre)configured such that a UE may transmit PSCCH and the corresponding PSSCH in non-adjacent resource blocks in a slot, the PSCCH/PSSCH resource m is the set of contiguous resource blocks with the physical resource block number n_{PRB}=nₛₜₐᵣₜ+2*m+j for j=0 . . . n_{FbChsize} where nₛₜₐᵣₜ is the starting RB index of the resource pool for PSCCH or PSSCH given by higher layer parameter startRBPSCCHPool and startRBPSSCHPool. The parameter n_{FbChsize} is the number of RBs for a PSCCH/PSSCH subchannel.

The time slots for PSCCH/PSSCH channels that are associated with a same slot SRS/CSI resource is configured by higher layers or pre-defined.

The frequency RBs of the SRS/CSI resource is in the same frequency subchannels as PSSCH subchannels indicated by the PSCCH. In one example, the frequency RBs of the SRS/CSI resource is in the same frequency subchannels as PSCCH and PSSCH subchannels indicated by the PSCCH.

In a same time slot, multiple SRS/CSI channels by multiple UEs can be multiplexed in a TDM manner, an FDM manner, or a CDM manner and so on. How SRS/CSI channels are multiplexed in the same T-F SRS/CSI resource is configured by higher layers or pre-defined.

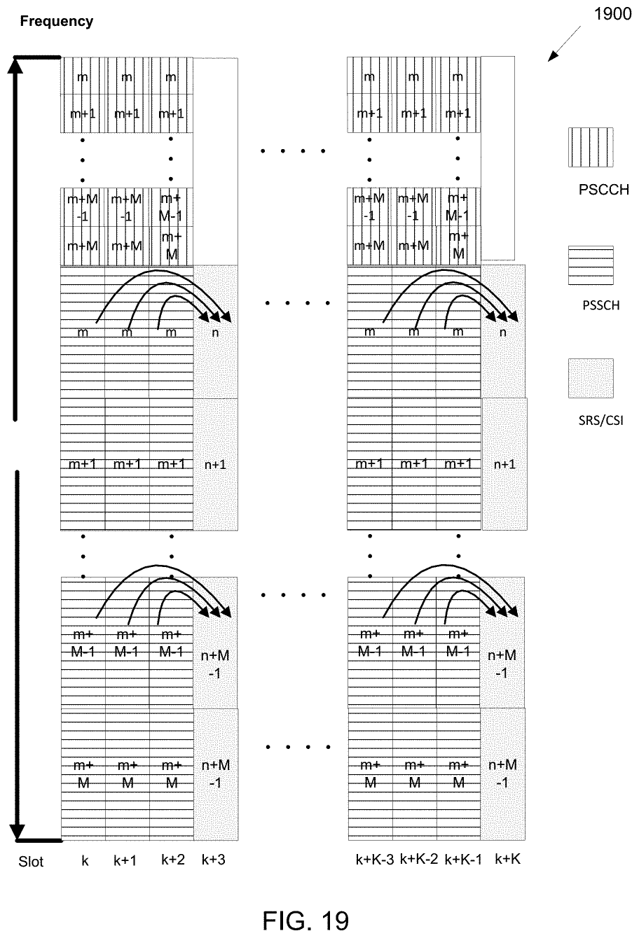

FIG. 19 illustrates an example CSI/SRS resource 1900 according to embodiments of the present disclosure. The embodiment of the CSI/SRS resource 1900 illustrated in FIG. 19 is for illustration only. FIG. 19 does not limit the scope of the present disclosure to any particular implementation.

As shown in FIG. 19, PSSCH subchannels m in slots k, k+1, and k+2 is associated with the SRS/CSI channel resource n with a same RB length of a PSSCH subchannel in slot k+3. PSSCH subchannels m+M−1 in slots k, k+1, and k+2 is associated with the SRS/CSI channel resource n+M−1 with a same RB length of a PSSCH subchannel in slot+3. How these 3 SRS/CSI channels are multiplexed in the same T-F SRS/CSI resource is configured by higher layers or pre-defined.

If the number of PSSCH subchannels by different UEs in different time slots indicated by their corresponding SCIs associated with a same slot SRS/CSI channel frequency resource is different, the multiplexing granularity for these SRS/CSI channels can be per SRS/CSI subchannel. That means SRS/CSI channels are multiplexed separately in each SRS/CSI subchannel frequency resource associated with PSSCH subchannels. For example, in FIG. 19, it may be assumed that PSSCH subchannels m and m+1 in slot k are used by UE1, PSSCH subchannels m and m+1 in slot k+1 are used by a UE2 and a UE3, and PSSCH subchannels m and m+1 in slot k+2 are used by a UE4 and a UE5, In slot k+3, SRS/CSI resource n is multiplexed by a UE1, a UE2, and a UE4, whereas SRS/CSI resource n+1 is multiplexed by a UE1, a UE3, and a UE5.

If different SCSs are configured for different resource pools, there is a benefit that when one SCI in one resource pool schedules a PSSCH in another resource pool the UE only needs to monitor the resource pool where the SCI resides. Another benefit is SCI resources can be configured with a resource pool in a frequency resource band with higher reliability. That can occur when resource pools for PSCCH and PSSCH are separate, and there is no one-to-one association between a PSSCH subchannel from one resource pool and a PSSCH subchannel from another resource pool. In this case, SCIs in one resource pool can schedule PSCCHs in different resource pools other than the SCI resource pool. The SCSs used in each resource pool can be different.

In order to support this case, some more SCI fields may be introduced and included in the SCI format: resource pool ID: the resource pool ID also indicates the carrier frequency, the SCS and/or TTI type to be used by the UE for the sidelink resource if a resource pool is configured related to a carrier frequency a SCS and/or TTI type; otherwise, fields of carrier indicator, resource pool ID, TTI and/or SCS type are used to indicate which type of TTI and/or SCS in a resource pool in a carrier frequency is used by the UE for the sidelink; and because there is no one-to-one association between a PSCCH subchannel and a PSSCH subchannel, the frequency location of initial transmission for PSSCH may be included. ┌ log₂ (N_{subchannel}^{SL})┐ bits. N_{subchannel}^{SL} is the number of subchannels in the PSSCH resource pool.

The time gap and frequency resource location in the SCI format are interpreted by the receiver UE according to the configured or indicated SCS and/or TTI type for the sidelink PSSCH resource allocation.

A number of subchannels and RB size of a subchannel for each resource pool can vary depending upon the configuration of each resource pool. It may lead to varying number of SCI bits for the frequency resource location. There are a few embodiments to solve this problem:

In one embodiment, a number of bits for indicating the frequency resource location in the SCI is set to correspond to the maximum number of N_{subchannel}^{SL} among the resource pools that are configured. The least or most significant number of bits corresponding to the resource pool that is indicated by the SCI by resource pool ID are used to indicate the frequency resource location. Other bits rather than these bits are ignored.

In one embodiment, for each configured resource pool, the number of subchannels is set to a fixed value so that the number of bits for indicating the frequency resource location in the SCI is fixed. The larger the RB size of the subchannel of the resource pool, the larger the size of the resource pool.

In order to support more than one retransmission, the number of remaining retransmissions may be included in the SCI format for each transmission. Each transmission SCI indicates the time gap between this transmission and next retransmission. It also indicates the frequency resource location of this transmission and next retransmission.

LTE Uu may have control capabilities over NR sidelink from the cellular network. In order to support NR sidelink probably with different SCSs and/or TTIs from LTE sidelink, the current LTE DCI format 5A may be adapted or reinterpreted correspondingly.

In LTE V2X, the carrier indicator field value in LTE DCI format 5A corresponds to v2x-InterFreqInfo. v2x-InterFreqInfoList Indicates synchronization and resource allocation configurations of other carrier frequencies than the serving carrier frequency for V2X sidelink communication. For inter-carrier scheduled resource allocation, CIF=1 in DCI-5A corresponds to the first entry in this frequency list, CIF=2 corresponds to the second entry, and so on. CIF=0 in DCI-5A corresponds to the frequency where the DCI is received.

In one embodiment of resource pool configuration, if the resource pool configuration also indicates the carrier frequency, the SCS and/or TTI type to be used by the UE for the sidelink resource, the DCI field carrier indicator in the DCI format 5A can be used to indicate the resource pool ID where the resource pool information such as the carrier frequency, the SCS and/or TTI type can be indicated. The number of carrier indicator bits are 3. So this embodiment can only indicate at most 8 resource pools for all NR V2X carriers. The upper layer can limit the carrier frequency and resource pools in NR for a NR V2X UE that can be scheduled by an LTE DCI format. For example, only one NR carrier frequency can be scheduled by LTE DCI format. So there are 8 resource pools that can be scheduled by LTE DCI format for the one NR carrier frequency.

In one embodiment, in LTE V2X, if the number of information bits in format 5A mapped onto a given search space is less than the payload size of format 0 mapped onto the same search space, zeros may be appended to format 5A until the payload size equals that of format 0 including any padding bits appended to format 0. The padded bits can be used to carry extra payload bits for scheduling NR V2X by LTE DCI format 5A. Assuming the number of subchannels in a resource pool N_{subchannel}^{SL} is 20.

The number of LTE DCI format 5A payload bits is: 3+log 2(20)+log 2(20*21/2)+4+2+3+1=3+5+8+4+2+3+1=26. The number of LTE DCI format 0 payload bits for 10 MHz in Release 8 is: 1+1+2+11+5+1+2+3+2+2+1=31. The padded bits (5 bits in this example) can be used to carry resource pool configuration information.

In one example, a resource pool ID is carried by the padded bits. So there are at most 32 resource pool IDs can be indicated by the LTE DCI format 5A in this example.

In another example, if the resource pool configuration doesn't configure the SCS and/or TTI type. The SCS and/or TTI type can be indicated by the LTE DCI format separately by the padded bits. For example, 3 bits indicates the resource pool ID, 2 bits indicates the SCS and/or TTI type.

In another example, if the resource pool configuration doesn't configure the SCS and/or TTI type. The SCS and/or TTI type can be indicated by the LTE DCI format separately by the padded bits. The upper layer can limit the carrier frequency and resource pools in NR for a NR V2X UE that can be scheduled by an LTE DCI format. For example, 5 bits indicates the SCS and/or TTI type, whereas carrier frequency is limited by the upper layer to a carrier frequency.

It can be configured to the UE by the eNodeB higher layers how the LTE DCI format 5A is interpreted by the UE.

Use of a listen-before-talk (LBT) procedure is vital for fair and friendly coexistence of LAA with other operators and technologies operating in unlicensed spectrum. LBT procedures on a node attempting to transmit on a carrier in unlicensed spectrum require the node to perform a clear channel assessment to determine if the channel is free for use. Thus, any LBT procedure involves at least energy detection to determine if the channel is being used.

Physical sidelink feedback channel (PSFCH) is defined and supported to convey SFCI for unicast and groupcast via PSFCH.

Sidelink control information (SCI) is defined: SCI is transmitted in PSCCH; and SCI includes at least one SCI format which includes the information necessary to decode the corresponding PSSCH. In one instance, NDI, if defined, is a part of SCI.

Sidelink feedback control information (SFCI) is defined: SFCI includes at least one SFCI format which includes HARQ-ACK for the corresponding PSSCH; how to include other feedback information (if supported) in SFCI is provided; and how to convey SFCI on sidelink in PSCCH, and/or PSSCH, and/or a new physical sidelink channel are provided. It may be noted that the context of mode 1: whether/how to convey information for SCI on downlink is provided; and whether/how to convey information of SFCI on uplink is provided.

At least two sidelink resource allocation modes are defined for NR-V2X sidelink communication.

In one example of mode 1, a base station schedules sidelink resource(s) to be used by UE for sidelink transmission(s).

In one example of mode 2, a UE determines (i.e., base station does not schedule) sidelink transmission resource(s) within sidelink resources configured by base station/network or pre-configured sidelink resources.

It is noted that eNB control of NR sidelink and gNB control of LTE sidelink resources may be separately considered in corresponding agenda items. It is noted that mode-2 definition covers potential sidelink radio-layer functionality or resource allocation sub-modes (subject to further refinement including merging of some or all of them) where: a UE autonomously selects sidelink resource for transmission; a UE assists sidelink resource selection for other UE(s); a UE is configured with NR configured grant (type-1 like) for sidelink transmission; and a UE schedules sidelink transmissions of other UEs.

The following is applied to the case where time/frequency relationship between PSCCH/PSSCH and the associated PSFCH is flexible. If a reservation signal is sent a few slots prior to transmissions to indicate a reserved PSCCH/PSSCH resource for the transmission, the associated PSFCH resource is indicated by the reservation signal. When another UE decodes the reservation signal, and find resources for PSFCH indicated by the reservation signal conflicts with resources this another UE selects, this another UE may reselect the resources. The resources indicated for the PSFCH may be both/either time and/or frequency domain. In time domain, the indication may be an offset to the time slot of the reservation signal or the transmission resource. FIG. 1 below shows an example where a reservation signal indicates both the resources for PSFCH and PSCCH/PSSCH.

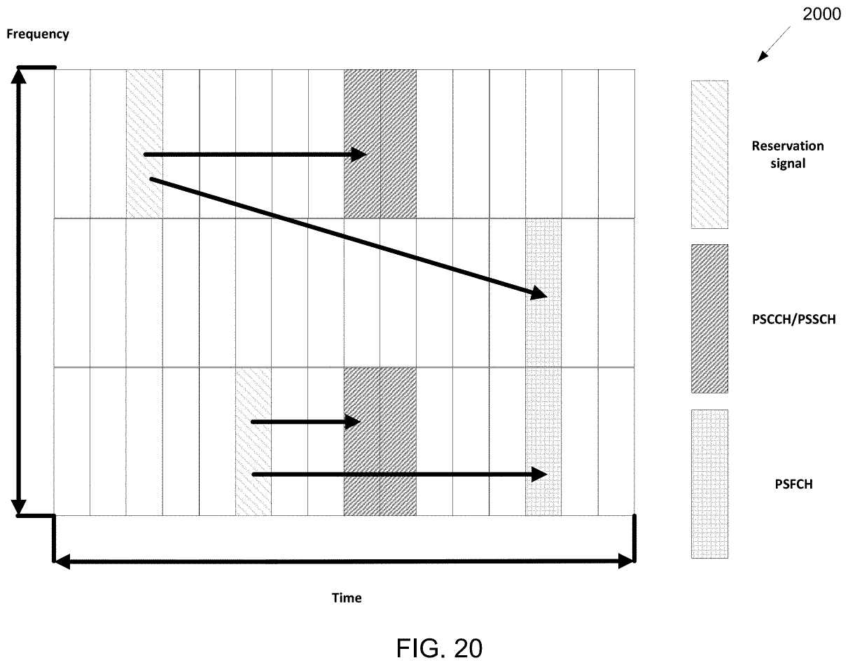

FIG. 20 illustrates an example reservation signal 2000 according to embodiments of the present disclosure. The embodiment of the reservation signal 2000 illustrated in FIG. 20 is for illustration only. FIG. 20 does not limit the scope of the present disclosure to any particular implementation.

For a case where multiple PSFCHs are multiplexed in a same time-frequency resource, e.g., CDMed by multiple PSFCHs, an extra field needs to be available in the SCI or reservation signal to indicate the extra domain.

In one example, CDMed by multiple PSFCHs, a cyclic shift index for the sequence used in the code domain needs to be available in the SCI or reservation signal.

In one example, FDMed by multiple PSFCHs, a frequency location offset (e.g., offset in terms of number of subcarriers/RBs in a RB/subchannel) needs to be available in the SCI or reservation signal.

In one example, TDMed by multiple PSFCHs, a time location offset (e.g., offset in terms of number of OFDM symbols in a slot) needs to be available in the SCI or reservation signal.

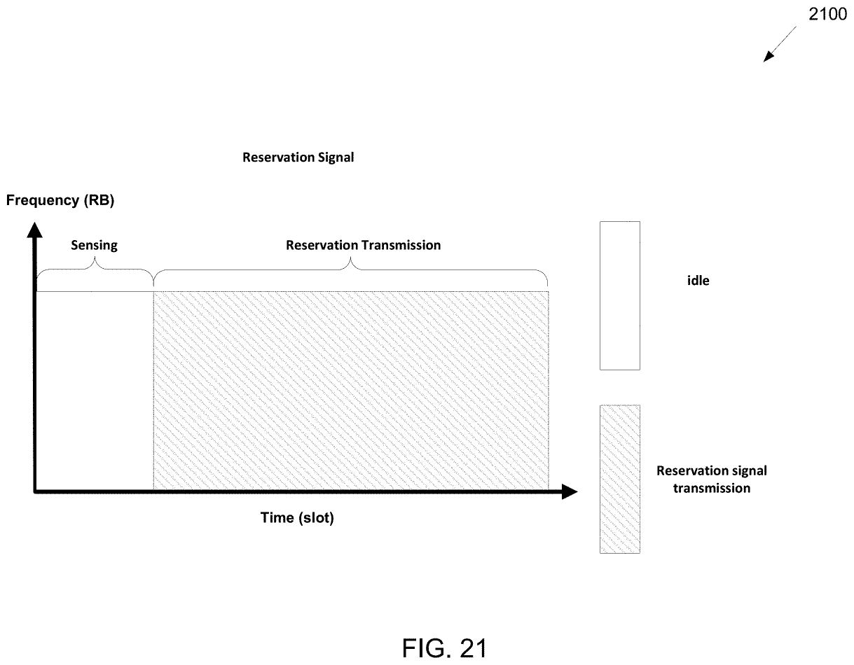

FIG. 21 illustrates an example reservation signal structure 2100 according to embodiments of the present disclosure. The embodiment of the reservation signal structure 2100 illustrated in FIG. 21 is for illustration only. FIG. 21 does not limit the scope of the present disclosure to any particular implementation.

A reservation signal is used for reserving resources prior to transmissions, as shown in FIG. 21.

In one embodiment, sensing part and reservation signal transmission part are provided. When the sensing is successful in the first OFDM symbols, the reservation signal transmission may start from next OFDM symbol until the end of the slot.

A reservation signal may be transmitted starting at any OFDM symbol in a slot. When a channel is sensed to be busy at any OFDM symbol, it may be shown that another UE transmits the reservation signal in the slot, and the UE needs to wait until next slot to begin the sensing procedure again. When the channel is sensed to be idle for a (pre)configured number of OFDM symbols in one slot, the UE can start the transmission of the reservation signal from next OFDM symbol until the end of the slot.

The number of OFDM symbols that need to be sensed to be idle in one slot may adapt accordingly if the UE fails in previous slots. An initial value (N) is set to the number of OFDM symbols that needs to be sensed to be idle for reservation signal in the first slot. When the UE fails to sense in current slot, the number of OFDM symbols needs to be sensed to be an idle for reservation signal in next slot can be decreased by a value (e.g., n) to N−n. This procedure may be repeated within the selection window until either the sensing succeeds or the number of OFDM symbols that needs to be sensed to be an idle is decreased to zero. When the number of OFDM symbols that needs to be sensed to be an idle is decreased to zero, the UE can use the channel in next slot without sensing. A selection window can be defined as a set of transmission slots that can meet the latency requirement for transmission.

There is a case where one UE transmits a reservation signal in the same slot as another UE, but in different frequency RB location. In this case, the UE and the other UE cannot receive the reservation signal transmitted from each other due to half duplex problems. To avoid the issue, there can be some constraint that only one reservation signal channel may be configured in each slot.

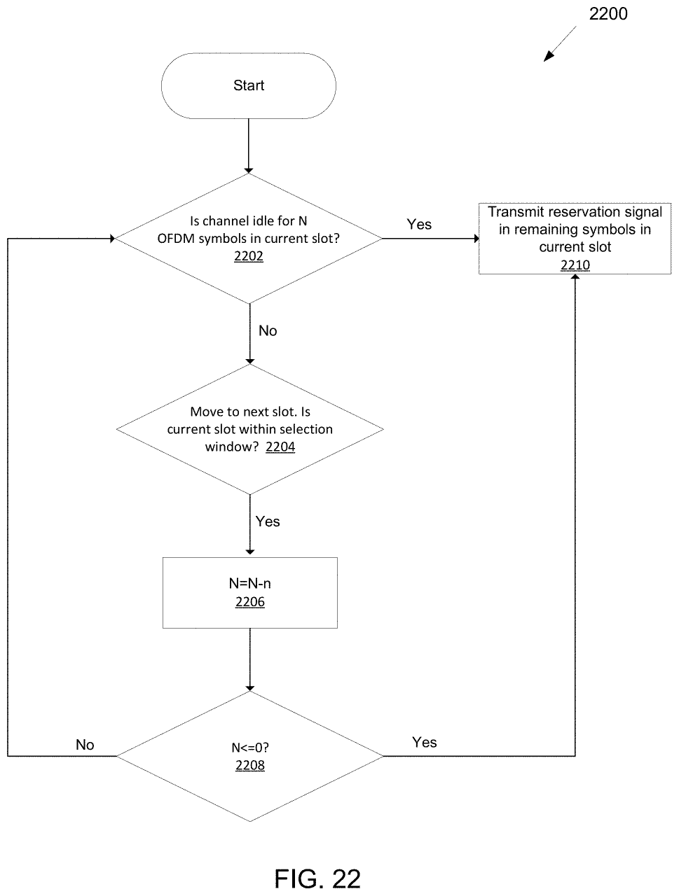

FIG. 22 illustrates a flowchart of a method 2200 for reservation signal indication according to embodiments of the present disclosure. The embodiment of the method 2200 illustrated in FIG. 22 is for illustration only. FIG. 22 does not limit the scope of the present disclosure to any particular implementation.

The whole procedure is shown in FIG. 22 where there is only one reservation signal configured in one slot.

As illustrated in FIG. 22, the method 2200 in step 2202 determines whether the channel is idle for N OFDM symbol in current slot. In step 2202, if the channel is idle, the method 2200 in step 2204 moves to a next slot and determines whether a current slot is within a selection window. In step 2204, if the current slot is within the selection window, the method 2200 determines N=N−n. In step 2208, the method 2200 determines N<=0. If N<=0 in step 2208, the method 2200 performs 2210. If no in step 2208, the method 2200 performs step 2202. In step 2210, the method 2200 transmits reservation signal in remaining symbols in current slot.

In one example, there can be multiple reservation signals in a same slot but in different frequency RB locations. In this case, the UE can perform multiple LBT sensing separately for reservation signal in the same slot but in different frequency RB locations. The UE may choose the reservation signal with the earliest starting OFDM symbol. When there are multiple reservation signals with same earliest starting OFDM symbol, the UE may randomly choose one channel to transmit the preemption indication.

When the minimum scheduling unit is mini-slot, the above can also be applicable with slot replaced by mini-slot.

In one embodiment, a reservation signal may be a separate PSCCH channel that is specially used as a signal to reserve resources for following transmissions.

In one embodiment, a reservation signal may be a separate PSCCH/PSSCH channel that is specially used as a signal to reserve resources for following transmissions.

In one embodiment, a reservation signal may be embedded in a separate PSCCH/PSSCH channel that is used to transmit another TB or another transmission for the same TB.

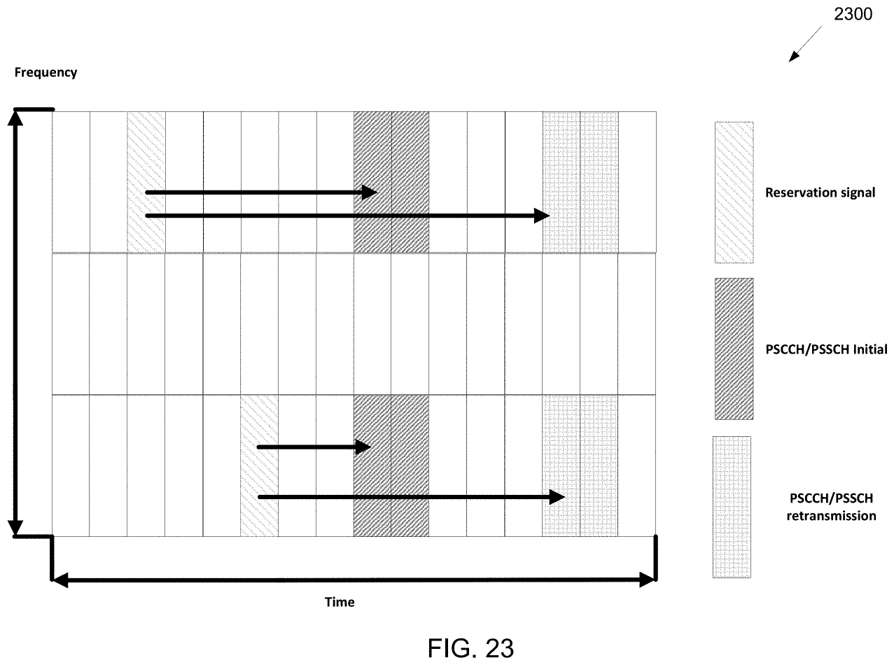

FIG. 23 illustrates an example reservation indication 2300 according to embodiments of the present disclosure. The embodiment of the reservation indication 2300 illustrated in FIG. 23 is for illustration only. FIG. 23 does not limit the scope of the present disclosure to any particular implementation.

In one embodiment, if a reservation signal is sent a few slots prior to the initial transmission to indicate a reserved PSCCH/PSSCH resource for the transmission, the associated following transmission resources for a same TB are indicated by the reservation signal. FIG. 23 shows an example where a reservation signal indicates the resources for the following transmissions e.g., both initial transmission and following retransmissions.

In one embodiment, if a reservation signal is sent a few slots prior to the transmission to indicate a reserved PSCCH/PSSCH resource for the transmission, the associated transmission resources for a same TB for this transmission and next transmission are indicated by the reservation signal.

In one embodiment, if a reservation signal is sent a few slots prior to the transmission to indicate a reserved PSCCH/PSSCH resource for the transmission, the associated transmission resources for this transmission and next transmission are indicated by the reservation signal. The two transmissions are not necessarily for a same TB, but can be for different TBs.

In one embodiment, if a reservation signal is sent a few slots prior to the transmission to indicate a reserved PSCCH/PSSCH resource for the transmission, the associated transmission resources for this transmission and remaining transmissions for a same TB are indicated by the reservation signal.

The resources indicated for the (re)transmissions may be in both/either time and/or frequency domain. In a time domain, the indication may be a time offset to the time slot of the initial transmission or the previous transmission. In a frequency domain, when transmissions occupy the same number of frequency resources, the indication may be a frequency RB/subchannel offset to the frequency RB/subchannel of the initial transmission or the previous transmission.

In one embodiment, the retransmission resource is allocated dynamically each time when a UE is going to schedule a retransmission, e.g., after the UE receives a NACK from the receiver UE. The SCI in each transmission only carries associated PSSCH scheduling information for this transmission. One example is both initial and retransmission resource is independently selected by a LBT-like sensing and resource selection scheme at the time prior to the corresponding transmission. Resources for Initial and retransmissions are selected and indicated independently.

In one embodiment, the retransmission resources are allocated by the time of the initial transmission. The SCI in each transmission carries PSSCH scheduling information for all the remaining transmissions or only this and next transmission for a same TB. Resources for retransmissions and initial transmission are selected together.

In one example, an initial and retransmission resources are selected by a LBT-like sensing and resource selection scheme where consecutive slots of T-F resources are selected for initial and retransmissions. For this example, sensing and resource selection needs to be performed only once for all scheduled transmissions of each TB. Another benefit is less signaling may be required in a SCI to indicate reserved retransmission resources since only time domain indication for retransmissions is needed to be available in the SCI.

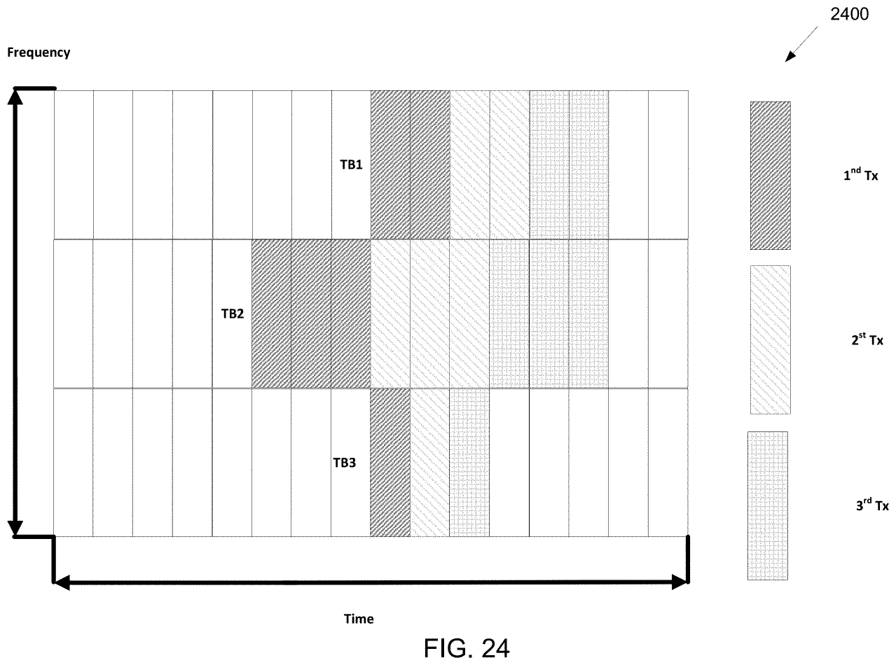

FIG. 24 illustrates example consecutive slots of T-F resources 2400 according to embodiments of the present disclosure. The embodiment of the consecutive slots of T-F resources 2400 illustrated in FIG. 24 is for illustration only. FIG. 24 does not limit the scope of the present disclosure to any particular implementation.

In an example shown in FIG. 24, for each TB, consecutive slots of T-F resources are selected for all scheduled transmissions (in this example, 3 transmissions are scheduled for each TB).

In one embodiment, the retransmission resources are allocated by the time of the initial transmission. The SCI in each transmission carries PSSCH scheduling information for all the remaining transmissions or only this and next transmission for a same TB. Resources for retransmissions and initial transmission are selected independently, but sensing starts from the same time slot.

In example, initial and retransmission resources are selected by a LBT-like sensing and resource selection scheme independently where consecutive slots of T-F resources are separately selected for initial and retransmissions.

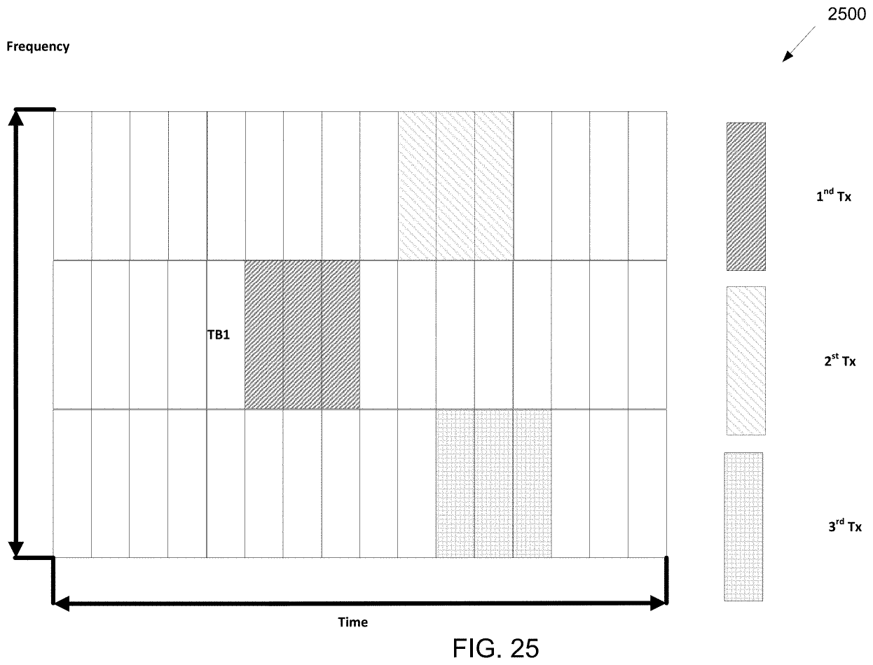

FIG. 25 illustrates example consecutive slots of T-F resources 2500 according to embodiments of the present disclosure. The embodiment of the consecutive slots of T-F resources 2500 illustrated in FIG. 25 is for illustration only. FIG. 25 does not limit the scope of the present disclosure to any particular implementation.

In an example shown in FIG. 25, for each TB, consecutive slots of T-F resources are separately selected for all scheduled transmissions (in this example, 3 transmissions are scheduled for each TB).

In one example, only the initial resource is selected by a LBT-like sensing and resource selection scheme, whereas retransmission resources are sensed and selected randomly after sensing.

In one example, only the initial resource is selected by schemes other than a LBT-like sensing and resource selection scheme, whereas retransmission resources are sensed and/or selected randomly after sensing.

The following is applied when the retransmission is HARQ-based. When a HARQ-ACK is received by the transmitter UE, the transmitter UE may release the reserved retransmission resource for use by other UEs, or the transmitter UE may use the reserved retransmission resource for transmissions of other TBs that already arrive in the physical layer.

For a system e.g., in a not lightly loaded system or a system with congestion, the HARQ-based retransmission resource reservation can be disabled by some signaling. In other cases, the HARQ-based retransmission resource reservation can be enabled by some signaling.

In one embodiment, a HARQ-based retransmission resource reservation is explicitly or implicitly signaled by a SCI e.g., in the initial transmission. The UE can sense the channel based upon congestion and/or QoS requirements, or other criteria and reserve or not reserve the resources for retransmissions.

In one embodiment, the gNB/network can signal explicitly or implicitly to the UE the resource reservation for retransmissions needs to be disabled/enabled based upon congestion and/or QoS requirements, or other criteria.

The following is applied to the case where time/frequency relationship between PSCCH/PSSCH and the associated PSFCH is flexible. PSFCH resource needs to be allocated dynamically and indicated in the SCI. For a case where multiple PSFCHs are multiplexed in a same time-frequency resource, e.g., CDMed/FDMed/TDMed by multiple PSFCHs, resource selection in additional domain needs to be performed. For resource allocation for this additional domain, the following is also applied to the case where time/frequency relationship between PSCCH/PSSCH and the associated PSFCH is fixed.

In one example, resource for a cyclic shift index for the sequence in CDM case needs to be considered in the resource selection.

In another example, resource for a frequency location offset (e.g., offset in terms of number of subcarriers/RBs in a RB/subchannel) in FDM case needs to be considered in the resource selection.

In yet another example, resource for a time location offset (e.g., offset in terms of number of OFDM symbols in a slot) in TDM case needs to be considered in the resource selection.

In one embodiment, PSFCH resource is selected randomly from available PSFCH resources within selection window in the PSFCH resource pool.

In another embodiment, PSFCH resource is selected randomly from available PSFCH resources within selection window in the PSFCH resource pool after resource exclusion. Resource exclusion is performed by excluding PSFCH resources from decoded SCI or reservation signal within sensing window that indicates the associated PSFCH resource.

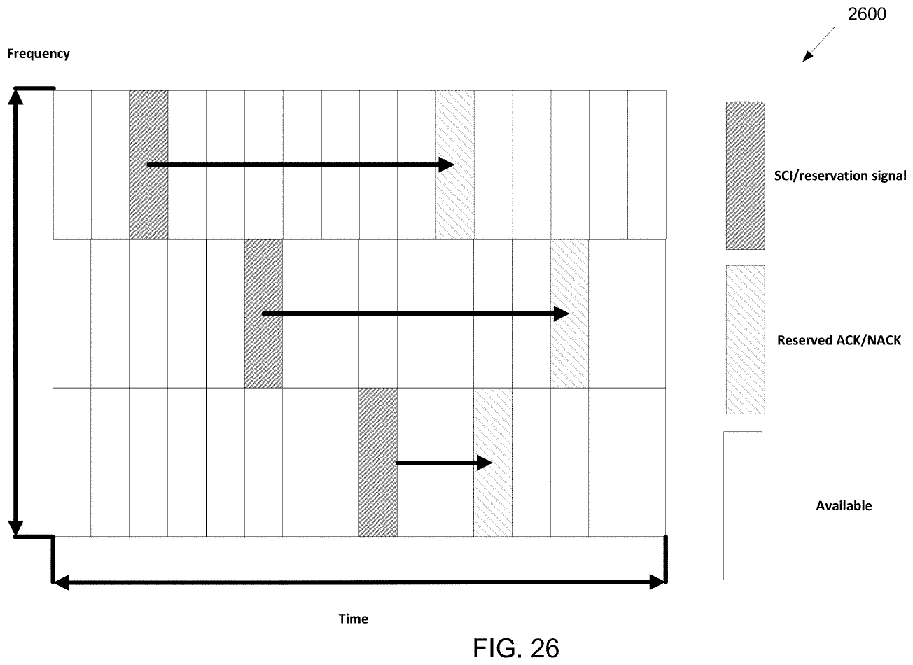

FIG. 26 shows how the PSFCH resource is selected from the available PSFCH resources after excluding reserved PSFCH resources indicated by corresponding SCIs or reservation signals.

FIG. 26 illustrates an example reservation indication 2600 according to embodiments of the present disclosure. The embodiment of the reservation indication 2600 illustrated in FIG. 26 is for illustration only. FIG. 26 does not limit the scope of the present disclosure to any particular implementation.

A multiple of SFCIs for a same or multiple TB(s) may be multiplexed in a same PSFCH resource.

For a same TB, the PSFCH resource indicated by the SCIs of all scheduled transmissions of the same TB may point to the same PSFCH resource in the PSFCH resource pool. In this case, only one SFCI considering combinations of all scheduled transmissions for the same TB is carried in the PSFCH.

For multiple TBs, the PSFCH resource indicated by the SCIs of scheduled transmissions for multiple TBs may point to the same PSFCH resource in the PSFCH resource pool. For each TB, only one SFCI considering combinations of all scheduled transmissions for the same TB is carried in the PSFCH.

In one example, for multiple TBs, the multiplexing order for all the SFCIs may be according to the reception order in which a receiver UE receives the last PSCCH/PSSCH transmission for a TB.

In another example, for multiple TBs, the multiplexing order for all the SFCIs may be according to the reception order in which a receiver UE receives the initial PSCCH/PSSCH transmission for a TB.

In yet another example, for multiple TBs, the SFCI may be the result of a logical operation “or” on all the SFCIs for the corresponding TBs if ACK/NACK is configured to be 0/1.

In yet another example, for multiple TBs, the SFCI may be the result of a logical operation “and” on all the SFCIs for the corresponding TBs if ACK/NACK is configured to be 1/0.

In NR V2X, in order to alleviate the half-duplex constraint, T-F patterns can be designed in a way such that any two different T-F patterns may not collide in at least one transmission.

In the design, number 1 represents that there is a transmission in the time unit. For frequency domain, it may be configured to transmit on any one subchannel that doesn't collide with one another.

For three scheduled transmissions for a same TB, when two different T-F patterns may not collide in at least two transmissions, the design is shown as follows.

For 3 subchannels in frequency domain and 7 time units in time domain, one embodiment of the time domain patterns is shown in TABLE 6.

TABLE 6
Pattern

Pattern 1: 1 1 1 0 0 0 0;
Pattern 2: 1 0 0 1 1 0 0;
Pattern 3: 1 0 0 0 0 1 1;
Pattern 4: 0 1 0 1 0 1 0;
Pattern 5: 0 0 1 0 1 1 0;
Pattern 6: 0 1 0 0 1 0 1;
Pattern 7: 0 0 1 1 0 0 1;

Another embodiment of the time domain pattern is shown in TABLE 7.

TABLE 7
Pattern

Pattern 1: 1 1 1 0 0 0 0;
Pattern 2: 1 0 0 1 1 0 0;
Pattern 3: 1 0 0 0 0 1 1;
Pattern 4: 0 0 1 0 1 0 1;
Pattern 5: 0 1 0 1 0 0 1;
Pattern 6: 0 0 1 1 0 1 0;
Pattern 7: 0 1 0 0 1 1 0;

The difference between embodiments in TABLE 6 and TABLE 7 is where for patterns 4-7 the patterns are complement 2-s of each other starting from time unit 2.

For 9 subchannels in frequency domain and 19 time units in time domain, one embodiment of the time domain patterns is shown in TABLE 8. It is derived and based upon one embodiment for 3 subchannels in frequency domain and 7 time units in time domain.

TABLE 8

Pattern 1: 1 1 1 0 0 0 0 0 0 0 0 0 0 0 0 0 0 0 0;
Pattern 2: 1 0 0 1 1 0 0 0 0 0 0 0 0 0 0 0 0 0 0;
Pattern 3: 1 0 0 0 0 1 1 0 0 0 0 0 0 0 0 0 0 0 0;
Pattern 4: 0 1 0 1 0 1 0 0 0 0 0 0 0 0 0 0 0 0 0;
Pattern 5: 0 0 1 0 1 1 0 0 0 0 0 0 0 0 0 0 0 0 0;
Pattern 6: 0 1 0 0 1 0 1 0 0 0 0 0 0 0 0 0 0 0 0;
Pattern 7: 0 0 1 1 0 0 1 0 0 0 0 0 0 0 0 0 0 0 0;
Pattern 8: 1 0 0 0 0 0 0 1 1 0 0 0 0 0 0 0 0 0 0;
Pattern 9: 1 0 0 0 0 0 0 0 0 1 1 0 0 0 0 0 0 0 0;
Pattern 10: 1 0 0 0 0 0 0 0 0 0 0 1 1 0 0 0 0 0 0;
Pattern 11: 0 0 0 0 0 0 0 1 0 1 0 1 0 0 0 0 0 0 0;
Pattern 12: 0 0 0 0 0 0 0 0 1 0 1 1 0 0 0 0 0 0 0;
Pattern 13: 0 0 0 0 0 0 0 1 0 0 1 0 1 0 0 0 0 0 0;
Pattern 14: 0 0 0 0 0 0 0 0 1 1 0 0 1 0 0 0 0 0 0;
Pattern 15: 1 0 0 0 0 0 0 0 0 0 0 0 0 1 1 0 0 0 0;
Pattern 16: 1 0 0 0 0 0 0 0 0 0 0 0 0 0 0 1 1 0 0;
Pattern 17: 1 0 0 0 0 0 0 0 0 0 0 0 0 0 0 0 0 1 1;
Pattern 18: 0 0 0 0 0 0 0 0 0 0 0 0 0 1 0 1 0 1 0;
Pattern 19: 0 0 0 0 0 0 0 0 0 0 0 0 0 0 1 0 1 1 0;
Pattern 20: 0 0 0 0 0 0 0 0 0 0 0 0 0 1 0 0 1 0 1;
Pattern 21: 0 0 0 0 0 0 0 0 0 0 0 0 0 0 1 1 0 0 1;
Pattern 22: 0 1 0 0 0 0 0 1 0 0 0 0 0 1 0 0 0 0 0;
Pattern 23: 0 0 1 0 0 0 0 0 1 0 0 0 0 1 0 0 0 0 0;
Pattern 24: 0 1 0 0 0 0 0 0 1 0 0 0 0 0 1 0 0 0 0;
Pattern 25: 0 0 1 0 0 0 0 1 0 0 0 0 0 0 1 0 0 0 0;
Pattern 26: 0 1 0 0 0 0 0 0 0 1 0 0 0 0 0 1 0 0 0;
Pattern 27: 0 0 1 0 0 0 0 0 0 0 1 0 0 0 0 1 0 0 0;
Pattern 28: 0 1 0 0 0 0 0 0 0 0 1 0 0 0 0 0 1 0 0;
Pattern 29: 0 0 1 0 0 0 0 0 0 1 0 0 0 0 0 0 1 0 0;
Pattern 30: 0 1 0 0 0 0 0 0 0 0 0 1 0 0 0 0 0 1 0;
Pattern 31: 0 0 1 0 0 0 0 0 0 0 0 0 1 0 0 0 0 1 0;
Pattern 32: 0 1 0 0 0 0 0 0 0 0 0 0 1 0 0 0 0 0 1;
Pattern 33: 0 0 1 0 0 0 0 0 0 0 0 1 0 0 0 0 0 0 1;
Pattern 34: 0 0 0 1 0 0 0 1 0 0 0 0 0 0 0 1 0 0 0;
Pattern 35: 0 0 0 0 1 0 0 0 1 0 0 0 0 0 0 1 0 0 0;
Pattern 36: 0 0 0 1 0 0 0 0 1 0 0 0 0 0 0 0 1 0 0;
Pattern 37: 0 0 0 0 1 0 0 1 0 0 0 0 0 0 0 0 1 0 0;
Pattern 38: 0 0 0 1 0 0 0 0 0 1 0 0 0 0 0 0 0 1 0;
Pattern 39: 0 0 0 0 1 0 0 0 0 0 1 0 0 0 0 0 0 1 0;
Pattern 40: 0 0 0 1 0 0 0 0 0 0 1 0 0 0 0 0 0 0 1;
Pattern 41: 0 0 0 0 1 0 0 0 0 1 0 0 0 0 0 0 0 0 1;
Pattern 42: 0 0 0 1 0 0 0 0 0 0 0 1 0 1 0 0 0 0 0;
Pattern 43: 0 0 0 0 1 0 0 0 0 0 0 0 1 1 0 0 0 0 0;
Pattern 44: 0 0 0 1 0 0 0 0 0 0 0 0 1 0 1 0 0 0 0;
Pattern 45: 0 0 0 0 1 0 0 0 0 0 0 1 0 0 1 0 0 0 0;
Pattern 46: 0 0 0 0 0 1 0 1 0 0 0 0 0 0 0 0 0 1 0;
Pattern 47: 0 0 0 0 0 0 1 0 1 0 0 0 0 0 0 0 0 1 0;
Pattern 48: 0 0 0 0 0 1 0 0 1 0 0 0 0 0 0 0 0 0 1;
Pattern 49: 0 0 0 0 0 0 1 1 0 0 0 0 0 0 0 0 0 0 1;
Pattern 50: 0 0 0 0 0 1 0 0 0 1 0 0 0 1 0 0 0 0 0;
Pattern 51: 0 0 0 0 0 0 1 0 0 0 1 0 0 1 0 0 0 0 0;
Pattern 52: 0 0 0 0 0 1 0 0 0 0 1 0 0 0 1 0 0 0 0;
Pattern 53: 0 0 0 0 0 0 1 0 0 1 0 0 0 0 1 0 0 0 0;
Pattern 54: 0 0 0 0 0 1 0 0 0 0 0 1 0 0 0 1 0 0 0;
Pattern 55: 0 0 0 0 0 0 1 0 0 0 0 0 1 0 0 1 0 0 0;
Pattern 56: 0 0 0 0 0 1 0 0 0 0 0 0 1 0 0 0 1 0 0;
Pattern 57: 0 0 0 0 0 0 1 0 0 0 0 1 0 0 0 0 1 0 0;

Another embodiment of the time domain patterns is shown in TABLE 9. It is derived and based upon Another embodiment for 3 subchannels in frequency domain and 7 time units in time domain.

TABLE 9
Pattern

Pattern 1: 1 1 1 0 0 0 0 0 0 0 0 0 0 0 0 0 0 0 0;
Pattern 2: 1 0 0 1 1 0 0 0 0 0 0 0 0 0 0 0 0 0 0;
Pattern 3: 1 0 0 0 0 1 1 0 0 0 0 0 0 0 0 0 0 0 0;
Pattern 4: 0 1 0 1 0 1 0 0 0 0 0 0 0 0 0 0 0 0 0;
Pattern 5: 0 0 1 0 1 1 0 0 0 0 0 0 0 0 0 0 0 0 0;
Pattern 6: 0 1 0 0 1 0 1 0 0 0 0 0 0 0 0 0 0 0 0;
Pattern 7: 0 0 1 1 0 0 1 0 0 0 0 0 0 0 0 0 0 0 0;
Pattern 8: 1 0 0 0 0 0 0 1 1 0 0 0 0 0 0 0 0 0 0;
Pattern 9: 1 0 0 0 0 0 0 0 0 1 1 0 0 0 0 0 0 0 0;
Pattern 10: 1 0 0 0 0 0 0 0 0 0 0 1 1 0 0 0 0 0 0;
Pattern 11: 0 0 0 0 0 0 0 1 0 1 0 1 0 0 0 0 0 0 0;
Pattern 12: 0 0 0 0 0 0 0 0 1 0 1 1 0 0 0 0 0 0 0;
Pattern 13: 0 0 0 0 0 0 0 1 0 0 1 0 1 0 0 0 0 0 0;
Pattern 14: 0 0 0 0 0 0 0 0 1 1 0 0 1 0 0 0 0 0 0;
Pattern 15: 1 0 0 0 0 0 0 0 0 0 0 0 0 1 1 0 0 0 0;
Pattern 16: 1 0 0 0 0 0 0 0 0 0 0 0 0 0 0 1 1 0 0;
Pattern 17: 1 0 0 0 0 0 0 0 0 0 0 0 0 0 0 0 0 1 1;
Pattern 18: 0 0 0 0 0 0 0 0 0 0 0 0 0 1 0 1 0 1 0;
Pattern 19: 0 0 0 0 0 0 0 0 0 0 0 0 0 0 1 0 1 1 0;
Pattern 20: 0 0 0 0 0 0 0 0 0 0 0 0 0 1 0 0 1 0 1;
Pattern 21: 0 0 0 0 0 0 0 0 0 0 0 0 0 0 1 1 0 0 1;
Pattern 22: 0 0 1 0 0 0 0 0 1 0 0 0 0 0 1 0 0 0 0;
Pattern 23: 0 1 0 0 0 0 0 1 0 0 0 0 0 0 1 0 0 0 0;
Pattern 24: 0 0 1 0 0 0 0 1 0 0 0 0 0 1 0 0 0 0 0;
Pattern 25: 0 1 0 0 0 0 0 0 1 0 0 0 0 1 0 0 0 0 0;
Pattern 26: 0 0 1 0 0 0 0 0 0 0 1 0 0 0 0 0 1 0 0;
Pattern 27: 0 1 0 0 0 0 0 0 0 1 0 0 0 0 0 0 1 0 0;
Pattern 28: 0 0 1 0 0 0 0 0 0 1 0 0 0 0 0 1 0 0 0;
Pattern 29: 0 1 0 0 0 0 0 0 0 0 1 0 0 0 0 1 0 0 0;
Pattern 30: 0 0 1 0 0 0 0 0 0 0 0 0 1 0 0 0 0 0 1;
Pattern 31: 0 1 0 0 0 0 0 0 0 0 0 1 0 0 0 0 0 0 1;
Pattern 32: 0 0 1 0 0 0 0 0 0 0 0 1 0 0 0 0 0 1 0;
Pattern 33: 0 1 0 0 0 0 0 0 0 0 0 0 1 0 0 0 0 1 0;
Pattern 34: 0 0 0 0 1 0 0 0 1 0 0 0 0 0 0 0 1 0 0;
Pattern 35: 0 0 0 1 0 0 0 1 0 0 0 0 0 0 0 0 1 0 0;
Pattern 36: 0 0 0 0 1 0 0 1 0 0 0 0 0 0 0 1 0 0 0;
Pattern 37: 0 0 0 1 0 0 0 0 1 0 0 0 0 0 0 1 0 0 0;
Pattern 38: 0 0 0 0 1 0 0 0 0 0 1 0 0 0 0 0 0 0 1;
Pattern 39: 0 0 0 1 0 0 0 0 0 1 0 0 0 0 0 0 0 0 1;
Pattern 40: 0 0 0 0 1 0 0 0 0 1 0 0 0 0 0 0 0 1 0;
Pattern 41: 0 0 0 1 0 0 0 0 0 0 1 0 0 0 0 0 0 1 0;
Pattern 42: 0 0 0 0 1 0 0 0 0 0 0 0 1 0 1 0 0 0 0;
Pattern 43: 0 0 0 1 0 0 0 0 0 0 0 1 0 0 1 0 0 0 0;
Pattern 44: 0 0 0 0 1 0 0 0 0 0 0 1 0 1 0 0 0 0 0;
Pattern 45: 0 0 0 1 0 0 0 0 0 0 0 0 1 1 0 0 0 0 0;
Pattern 46: 0 0 0 0 0 0 1 0 1 0 0 0 0 0 0 0 0 0 1;
Pattern 47: 0 0 0 0 0 1 0 1 0 0 0 0 0 0 0 0 0 0 1;
Pattern 48: 0 0 0 0 0 0 1 1 0 0 0 0 0 0 0 0 0 1 0;
Pattern 49: 0 0 0 0 0 1 0 0 1 0 0 0 0 0 0 0 0 1 0;
Pattern 50: 0 0 0 0 0 0 1 0 0 0 1 0 0 0 1 0 0 0 0;
Pattern 51: 0 0 0 0 0 1 0 0 0 1 0 0 0 0 1 0 0 0 0;
Pattern 52: 0 0 0 0 0 1 0 0 0 0 1 0 0 0 1 0 0 0 0;
Pattern 53: 0 0 0 0 0 0 1 0 0 1 0 0 0 0 1 0 0 0 0;
Pattern 54: 0 0 0 0 0 1 0 0 0 0 0 1 0 0 0 1 0 0 0;
Pattern 55: 0 0 0 0 0 0 1 0 0 0 0 0 1 0 0 1 0 0 0;
Pattern 56: 0 0 0 0 0 1 0 0 0 0 0 0 1 0 0 0 1 0 0;
Pattern 57: 0 0 0 0 0 0 1 0 0 0 0 1 0 0 0 0 1 0 0;

For four scheduled transmissions for a same TB, when two different T-F patterns may not collide in at least two transmissions, the patterns can be extended from T-F patterns for 2 scheduled transmissions. Each time unit in a pattern may expand to two time units by replacing each 1 with (1 1) and each 0 with (0 0). For example, the patterns for two transmissions are shown in TABLE 10.

TABLE 10
Pattern

Pattern 1: 1 1 0 0
Pattern 2: 1 0 1 0
Pattern 3: 1 0 0 1
Pattern 4: 0 1 0 1
Pattern 5: 0 1 1 0
Pattern 6: 0 0 1 1

Patterns with 4 transmissions are generated by replacing each 1 with (1 1), and each 0 with (0 0) as shown in TABLE 11.

TABLE 11
Pattern

Pattern 1: (1 1) (1 1) (0 0) (0 0)
Pattern 2: (1 1) (0 0) (1 1) (0 0)
Pattern 3: (1 1) (0 0) (0 0) (1 1)
Pattern 4: (0 0) (1 1) (0 0) (1 1)
Pattern 5: (0 0) (1 1) (1 1) (0 0)
Pattern 6: (0 0) (0 0) (1 1) (1 1)

Sidelink sensing and resource selection procedures are provided for Mode-2(a). The following techniques are provided to identify occupied sidelink resources: decoding of sidelink control channel transmissions; sidelink measurements; detection of sidelink transmissions; and other options are not precluded, including combination of the above options

The following aspects are provided for sidelink resource selection: how a UE selects resource for PSCCH and PSSCH transmission (or other sidelink physical channel/signal, if other sidelink physical channel/signal is introduced); and which information is used by UE for resource selection procedure

The following aspects about assistance information are provided for Mode 2(b): which assistance information is used and how the assistance information is acquired; which UE sends assistance information; how to deliver assistance information, including physical channel and UE behavior; and how assistance information is taken into account in determination of sidelink resource for transmission.

Whether some or all of Mode-2(b) functionality is a part of Mode-2(a)(c)(d) is provided.

The following aspects are provided for Mode 2(c): how to assign resource(s) for UE sidelink transmission to mitigate collisions and half-duplex impacts; whether any sensing or resource selection procedure is used on top of configured grant(s); whether and how to use any granted but unused resources; how to adapt to traffic variation; how different from Mode-1 operation for in-coverage scenario; how different from Mode-2(a), when Mode-2(a) uses dedicated resource pool with dedicated sidelink resource pool configuration; and whether and how this mode operates out of network coverage.

Whether some or all of Mode-2(c) functionality is a part of Mode-2(a)(b)(d) is provided.

The following aspects are provided for Mode 2(d): in which use cases/scenarios this mode is applicable; what is the overall architecture for Mode-2(d) operation; how to decide which UE schedules which other UE(s) and how to maintain this relationship; what is the procedure of UE(s) when the scheduling UE disappears; what is the scheduling UE behavior and signaling mechanism to schedule sidelink resources for transmission/reception for other UEs; which resources can be used to schedule other UEs; and inter- and intra-UE collision handling and sidelink resource allocation mechanisms across groups.

Whether or not some or all of the above aspects are applicable to 2(b) is provided.

In the context of in-device coexistence between NR and LTE V2X sidelinks (not co-channel): TDM solutions are those that prevent overlapping or simultaneous NR and LTE V2X sidelink transmissions; and FDM solutions are those that involve simultaneous transmissions of NR and LTE V2X sidelink transmissions and defining mechanisms for sharing the total device power between the two.

For TDM solutions, LTE and NR V2X sidelinks are assumed to be synchronized: accuracy of time alignment/synchronization is provided; and alignment whether slot level and/or DFN based alignment is needed.

For TDM solutions, the following aspects are provided: for long term time-scale coordination, potential transmissions in time of LTE and NR V2X are statically/quasi-statically determined and a UE behavior when LTE and NR V2X sidelink transmissions overlap in time is provided.

For short time-scale coordination, transmissions in time of LTE and NR V2X are known to each RAT and a UE behavior when LTE and NR V2X sidelink transmissions overlap in time is provided (coordination details and UE assistance for coordination are provided).

The grouping of UEs and the determination of the scheduling/assisting UE may be determined by higher layers. The group forming can be similar to the group forming in groupcast. After the grouping and determination of the scheduling/assisting UE, the scheduling/assisting UE requests resource for the group from the base station. After receiving the resource request from the scheduling/assisting UE, the base station schedules a resource set to be used by the group. After that, the scheduling/assisting UE may signal to all member UEs the allocated resource set e.g., in the groupcast PSSCH/PSSCH channel. Each member UE may perform autonomous resource selection in the resource set signaled by the scheduling/assisting UE.

Before the scheduling/assisting UE performs resource request from the base station, each member UE may transmit their respective service requirements (e.g., in the groupcast PSCCH/PSSCH channel) to the scheduling/assisting UE, e.g., periodicity, packet size etc. Based upon the service requirement report from each member UE, the scheduling UE knows the resource requirements of the group and requests resource from the base station.

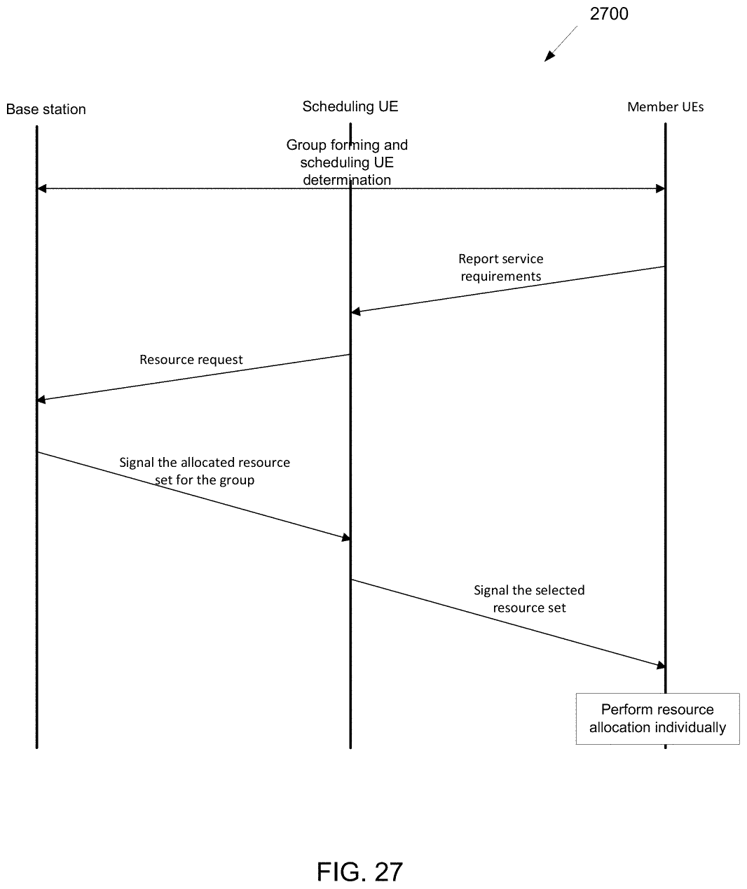

FIG. 27 illustrates an example call flow of resource allocation 2700 according to embodiments of the present disclosure. The embodiment of the call flow of resource allocation 2700 illustrated in FIG. 27 is for illustration only. FIG. 27 does not limit the scope of the present disclosure to any particular implementation.

The whole procedure is shown in FIG. 27. Some steps in the procedure may not necessarily exist, e.g., the resource set for the group may be semi-statically configured or preconfigured. The scheduling/assisting UE only signals the resource set to all member UEs when it is determined as the scheduling/assisting UE.

The grouping of UEs and the determination of the scheduling/assisting UE may be determined by higher layers. The group forming can be similar to the group forming in groupcast. After the grouping and determination of the scheduling/assisting UE, the scheduling/assisting UE performs autonomous resource selection and selects a resource set for the group from the (pre)configured resource pool. After that, the scheduling/assisting UE may signal to all member UEs the selected resource set e.g., in the groupcast PSCCH/PSSCH channel. Each member UE may perform autonomous resource selection in the resource set signaled by the scheduling/assisting UE.

Before the scheduling UE performs autonomous resource selection in the (pre)configured resource pool, each member UE may transmit their respective service requirements (e.g., in the groupcast PSCCH/PSSCH channel) to the scheduling UE, e.g., periodicity, packet size etc. Based upon the service requirement report from each member UE, the scheduling UE knows the resource requirements of the group and performs autonomous resource selection on the (pre)configured resource pool.

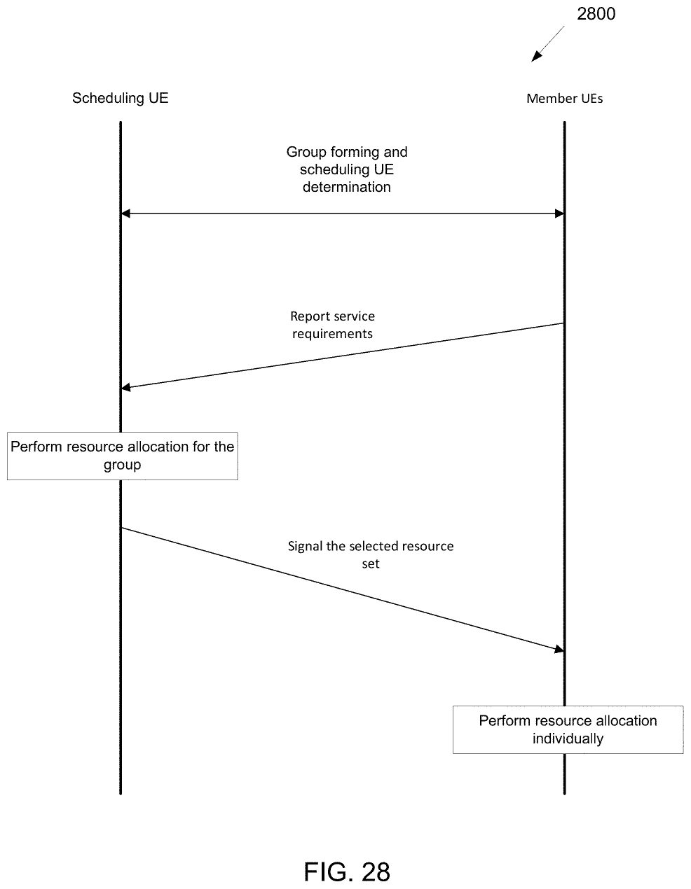

FIG. 28 illustrates another example call flow of resource allocation 2800 according to embodiments of the present disclosure. The embodiment of the call flow of resource allocation 2800 illustrated in FIG. 28 is for illustration only. FIG. 28 does not limit the scope of the present disclosure to any particular implementation.

The whole procedure is shown in FIG. 28. Some steps in the procedure may not necessarily exist, e.g., the resource set for the group may be semi-statically configured or preconfigured. The scheduling/assisting UE only signals the resource set to all member UEs when it is determined as the scheduling/assisting UE.

A group may be formed by higher layer signaling. After a group is formed, the scheduling UE may be determined by approaches below.

In one embodiment, the scheduling UE may be selected with the best receiving signal quality from the base station. A UE within the coverage of the base station may send scheduling request to the base station to request the resource for the group. Therefore, the receiving signal quality from the base station is an important metric for the selection of the scheduling UE.

In another embodiment, the scheduling UE may be selected with best receiving signal quality from other member UEs. The resource set needs to be signaled by the scheduling UE to all member UEs. Therefore, the receiving signal quality from other member UEs is an important metric for the selection of the scheduling UE, while the scheduling UE may perform autonomous resource selection when the scheduling UE is out of coverage of the base station.

In yet another embodiment, a combination of the above two embodiments are provided. The scheduling UE may be selected considering both the receiving signal quality from the base station and the receiving signal quality from other member UEs. The scheduling UE may have both good receiving signal quality from the base station and good receiving signal quality from other member UEs.

Some other related procedures are different depending upon whether UEs from the same upper layer group are served by the same scheduling UE.

An SCI without associated PSSCH is supported that signals to other scheduling UEs the resources reserved, at least when the resources are a group of resources for the whole group of UEs.

An SCI without associated PSSCH is supported that signals to other member UEs the resources reserved, at least when the resources are a group of resources for the whole group of UEs.

ACK/NACK for the resource allocation SCI from the member UEs to the scheduling UEs may be used to indicate whether the resource allocation by the scheduling UE is received correctly or not by the member UEs, at least when the signaled resources are a group of resources for the whole group of UEs.

As provided, the aforementioned determination of the scheduling UE can be used for UEs to (re)-select scheduling UE(s).

When a UE is selected as a scheduling UE, other UEs that joins now or later need to be get informed by the scheduling UE. Higher layer signaling can be used by the scheduling UE to inform other UEs that are is selected as a scheduling UE.

For cases where UEs from the same upper layer group are served by the same scheduling UE, the higher layer signaling may only be transmitted to UEs in the same upper layer group. Otherwise, all other UEs can receive the information.

For cases where UEs from the same upper layer group are served by the same scheduling UE, UEs in the same group associates to the scheduling UE selected in the same upper layer group.

Otherwise, if multiple scheduling UEs are detected by a same UE, the UE needs to determine how to associate to a scheduling UE from multiple detected scheduling UEs. Just like handoff, the UE needs to perform detection and association of scheduling UE periodically.

In one example, the UE associates to a scheduling UE with a maximum received energy among a few detected scheduling UEs, e.g., maximum RSRP or RSSI.

For cases where UEs from the same upper layer group are served by the same scheduling UE, when a scheduling UE stops scheduling, the UEs needs to first select a new scheduling UE among UEs in the same upper layer group. When no other scheduling UEs are selected from the same upper layer group, the UE needs to switch to other sub-modes.

Otherwise, when a scheduling UE stops scheduling, UEs need to first select a different scheduling UE from a group of candidate scheduling UEs detected. When no other scheduling UEs are detected, the UE needs to switch to other sub-modes.

For configurations with overlapped resources between groups, if the scheduling UE cannot know whether the allocated resources to member UEs collide with UEs in other groups, a sensing at the member UE side may be performed. The scheduling UE may signal to the member UEs whether sensing is required at the member UE side or not.

By own sensing at member UE side, member UEs may also report to the corresponding scheduling UE whether the resources the scheduling UE signals are good for transmission. The feedback can be either higher layer signaling or physical layer signaling.

Before a UE is associated with a scheduling UE, the UE works in another sub-mode. It uses the resources for communication that are configured for that sub-mode.

When a scheduling UE stops scheduling and UEs are detecting or selecting a new scheduling UE, the UEs uses resources for communications in mode 2d if the resources are still valid, otherwise the UEs uses resources configured for another sub-mode the UEs switch to.

When a UE switches to Mode 2d, the UE uses the resources that are determined or configured for Mode 2d.

Before a UE is associated with a scheduling UE, the UE works in another sub-mode. After a UE associates to a scheduling UE, the UE switches to Mode 2d. In Mode 2d, when no scheduling UEs are detected or selected any more, the UE switches to other sub-modes.

For a same UE, the transmission in NR V2X may cause interference on the reception in LTE V2X at the same slot and vice versa. During LTE resource allocation for the UE, LTE resource allocation module may consider the interference from NR V2X transmission in the same slot, and vice versa.

LTE resource allocation module may obtain the resource information in the sensing window from NR resource allocation module. While calculating RSSI for candidate resources, the UE may not include the resources at the time slot where that SCI is located, or a RSSI offset can be added in the RRSI calculation to offset the interference caused by the NR transmission. NR resource allocation module may perform similarly.

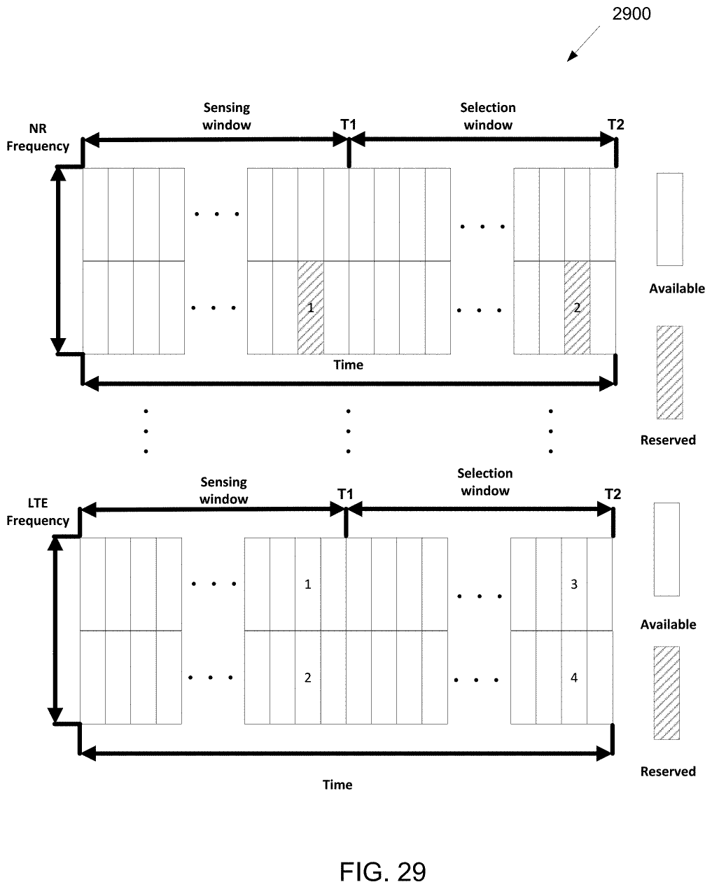

FIG. 29 illustrates an example resource allocation 2900 according to embodiments of the present disclosure. The embodiment of the resource allocation 2900 illustrated in FIG. 29 is for illustration only. FIG. 29 does not limit the scope of the present disclosure to any particular implementation.

As illustrated in FIG. 29, LTE V2X resource allocation module may include LTE resources 3 and 4 in the candidate set. During RSSI calculation for LTE resources 3 and 4, LTE resources 1 and 2 are not included or a RSSI offset is added in the RSSI calculation.

For a UE with limited Tx capabilities, the UE can only transmit on either LTE or NR at a time, but not on both at the same time. During LTE resource allocation for the UE, LTE resource allocation module may take this into account, and vice versa.

An LTE resource allocation module (e.g., circuit) may obtain the resource reserved in the selection window from NR resource allocation module. LTE resource allocation module (e.g., circuit) may exclude resources reserved by NR. Similarly, NR resource allocation module (e.g., circuit) may obtain the resource reserved in the selection window from LTE resource allocation module. NR resource allocation module may exclude resources reserved by LTE.

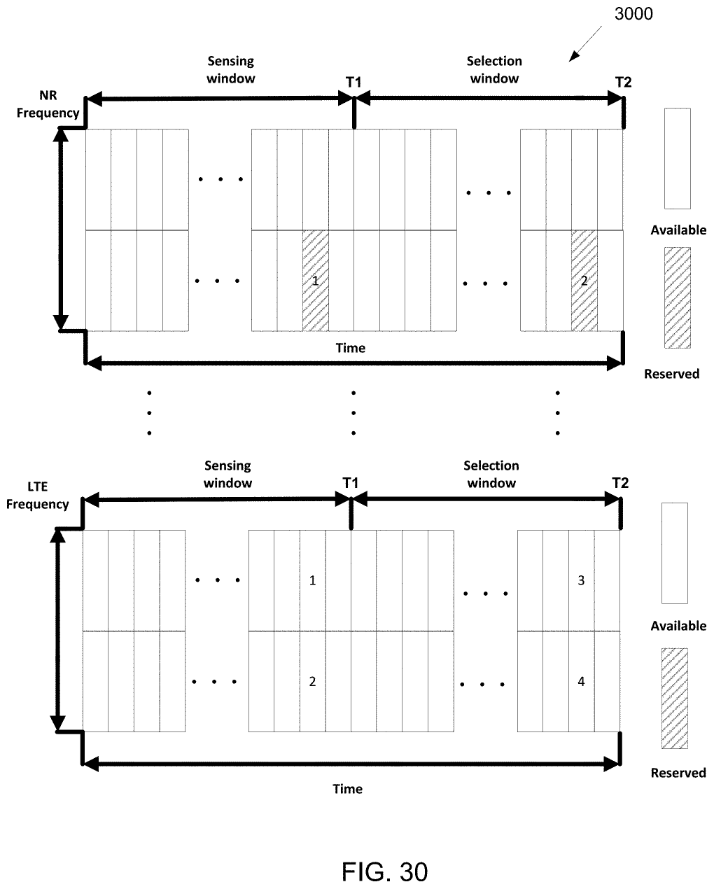

FIG. 30 illustrates another example resource allocation 3000 according to embodiments of the present disclosure. The embodiment of the resource allocation 3000 illustrated in FIG. 30 is for illustration only. FIG. 30 does not limit the scope of the present disclosure to any particular implementation.

As illustrated in FIG. 30, LTE V2X resource allocation module (e.g., circuit) may exclude LTE resources 3 and 4 in the candidate set because NR resource 1 indicates NR resource 2 in the same slot as LTE resource 3 and 4 is reserved by NR.

LTE resource allocation module (e.g., circuit) may obtain the resource information in the sensing window from NR resource allocation module. If a SCI for NR in the sensing window indicates a periodic resource is not used any more in the next period. LTE resource allocation module may include the resource in the candidate resource set. While calculating RSSI, the UE may not include the resources at the same time slot where that NR SCI is located, or a RSSI offset can be added in the RRSI calculation to offset the interference caused by the NR transmission. NR resource allocation module may perform similarly.

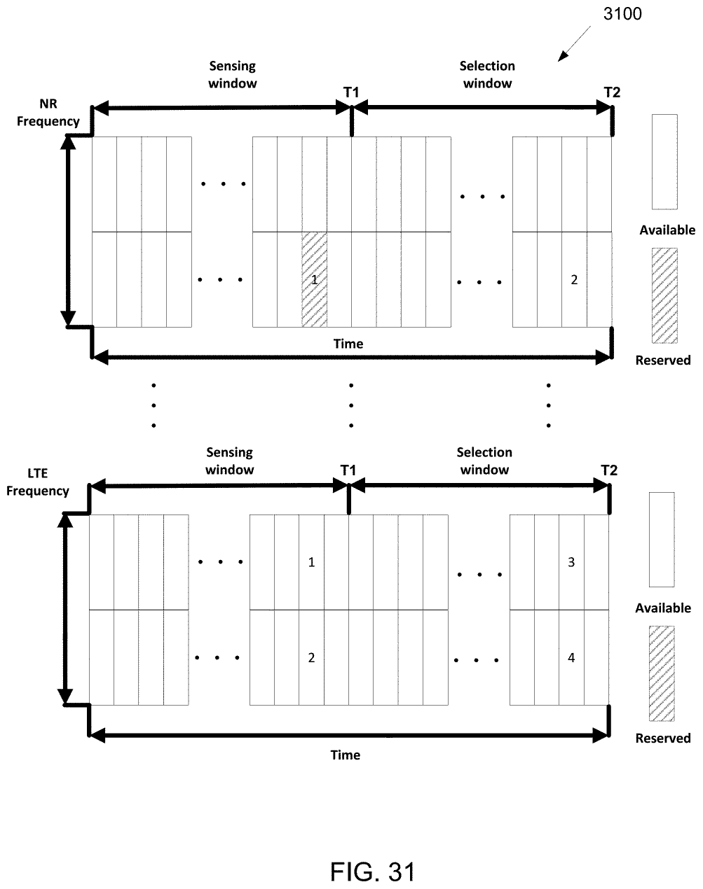

FIG. 31 illustrates yet another example resource allocation 3100 according to embodiments of the present disclosure. The embodiment of the resource allocation 3100 illustrated in FIG. 31 is for illustration only. FIG. 31 does not limit the scope of the present disclosure to any particular implementation.

As illustrated in FIG. 31, LTE V2X resource allocation module may include LTE resources 3 and 4 in the candidate set because NR resource 1 indicates NR resource 2 in the same slot as LTE resource 3 and 4 is not used any more by NR. During RSSI calculation for LTE resources 3 and 4, LTE resources 1 and 2 are not included or a RSSI offset is added.

In cellular V2X, the UE sends a TB at most two times, including one initial transmission and one retransmission. The SCI in both transmissions includes the frequency resource location of both transmissions and the gap between the initial transmission and the retransmission. Currently there is no support for feedback of ACK/NACK from the receiver UE in V2X. To avoid unnecessary retransmission and resource waste for retransmission and improve the throughput of V2X applications, there is a need to support ACK/NACK feedback and this is a need of a design on how to determine resources for ACK/NACK feedback channels in the next generation wireless communication.

There are a few embodiments for the resource determination of ACK/NACK feedback channels in V2X.

In one embodiment, for an ACK/NACK (T-F) feedback channel resource, a set of contiguous resource blocks in a time slot that supports the transmission of one or more multiplexed feedback channels for ACK/NACK transmissions.

In one embodiment, for an ACK/NACK Feedback channel, one or more channels multiplexed in a feedback channel resource for ACK/NACK transmission. So there are more than one feedback channels in a feedback channel resource. Each feedback channel can transmit one ACK/NACK for a TB.

In one embodiment, there is an association between PSCCH resource m and the associated ACK/NACK feedback channel resource. The ACK/NACK feedback channel is used to feedback the ACK/NACK information of the corresponding TB that the PSCCH indicates in the SCI. The association is based upon both frequency domain and time domain of PSCCH resource m.

There is a separate resource pool that is configured by e.g., higher layers and dedicated for the use of ACK/NACK feedback channels. In this embodiment, the receiver UE simply feedbacks the ACK/NACK in the associated feedback channel resource and the receiver UE can support unicast, multicast and broadcast without any bits in the SCI indicating the receiver UE ID or receiver group ID. The sender UE can decode and acquire the corresponding ACK/NACK information from the associated ACK/NACK feedback channel resource.

In one example of adjacent PSCCH+PSSCH, for adjacent PSCCH+PSSCH, a PSCCH+PSSCH resource pool is (pre)configured such that a UE always transmits PSCCH and the corresponding PSSCH in adjacent resource blocks in a subframe, PSCCH resource m is the set of contiguous resource blocks with the physical resource block number n_{PRB}=n_{subCHRBstart}+m*n_{subCHsize}+j for j=0 . . . n_{PSCCCHsize} where n_{subCHRBstart} and n_{subCHsize} are the starting RB index and subchannel size of the PSCCH+PSSCH resource pool that are given by higher layer parameters startRBSubchannel and sizeSubchannel, respectively. The parameter n_{PSCCCHsize} is the number of RBs for a PSCCH resource.

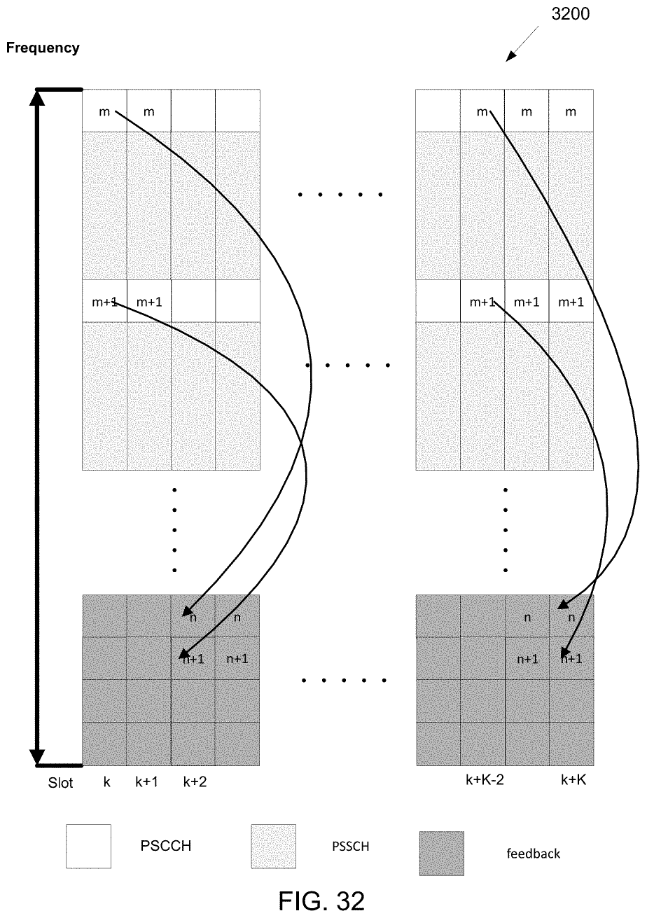

FIG. 32 illustrates an example feedback channel resource 3200 according to embodiments of the present disclosure. The embodiment of the feedback channel resource 3200 illustrated in FIG. 32 is for illustration only. FIG. 32 does not limit the scope of the present disclosure to any particular implementation.

In one example, the associated feedback channel resource is determined as below and an example is shown in FIG. 32. In this approach, different PSCCH channels are associated with feedback channel resources in different frequency resource blocks and time resources.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for j=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a T-F feedback channel resource.

In the time domain, the feedback channel resource associated with PSCCH resource m is in slot k+k_{offset} where k is the time slot for PSCCH resource m and k_{offset} is the time slot offset relative to time slot k. k_{offset} can be configured by higher layers.

As illustrated in FIG. 32, PSCCH resource m in slot k is associated with the feedback channel resource n in slot k+2 with a slot offset k_{offset} of 2 relative to PSCCH resource m in slot k. PSCCH resource m+1 in slot k+K−2 is associated with the feedback channel resource n+1 in slot k+K with a slot offset k_{offset} of 2 relative to PSCCH resource m+1 in slot k+K−2.

If there is more than one PSSCH subchannel transmission for one corresponding PSCCH, there are more than one PSCCH resource used in the PSCCH and PSSCH where PSCCH resources other than the first PSCCH resource m is used for PSSCH transmission. In this case, the receiver UE can send the ACK/NACK in the corresponding feedback resources associated with all the PSCCH resources used by the PSCCH/PSSCH. It can help increase the reliability of ACK/NACK because more than one repetition of ACK/NACK is transmitted in the ACK/NACK feedback channels.

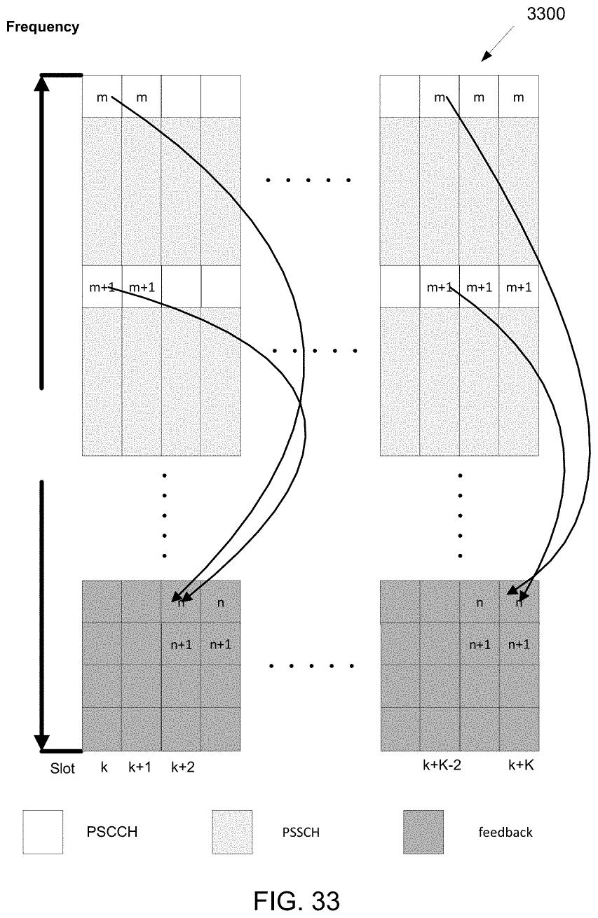

FIG. 33 illustrates another example feedback channel resource 3300 according to embodiments of the present disclosure. The embodiment of the feedback channel resource 3300 illustrated in FIG. 33 is for illustration only. FIG. 33 does not limit the scope of the present disclosure to any particular implementation.

In one embodiment, the associated feedback channel resource is determined as below and an example is shown in FIG. 33. In such embodiment, PSCCH resources in the same time slot may be associated with a same feedback channel resource, but PSCCH resources in a different time slot can only associated with feedback channel resources in a different time slot. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource is configured by higher layers or pre-defined.

In the frequency domain, the feedback channel resource associated with PSCCH resource m is the set of contiguous resource blocks with the physical resource block number n_{PRB}=n_{subCHRBstart}+n_{offset}+└m/nₘᵤₗₜᵢₚₗₑₓ┘*n_{FbChsize}+j for j=0 . . . n_{FbChsize} where PRB n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a T-F feedback channel resource. nₘᵤₗₜᵢₚₗₑₓ is the number of feedback channels multiplexed in the same T-F feedback resource.

In the time domain, the feedback channel resource associated with PSCCH resource m is in slot k+k_{offset} where k is the time slot for PSCCH resource m and k_{offset} is the slot offset relative to slot k. k_{offset} can be configured by higher layers.

As illustrated in FIG. 33, PSCCH resource m and m+1 in slot k is associated with the feedback channel resource n in slot k+2 with a slot offset k_{offset} of 2 relative to PSCCH resource m in slot k. PSCCH resource m and m+1 in slot k+K−2 is associated with the feedback channel resource n+1 in slot k+K with a slot offset k_{offset} of 2 relative to PSCCH resource m+1 in slot k+K. In this example, the number of feedback channels multiplexed in the same feedback channel resource nₘᵤₗₜᵢₚₗₑₓ is 2.

If there is more than one PSSCH subchannel transmission for one corresponding PSCCH, there are more than one PSCCH resource used in the PSCCH and PSSCH where PSCCH resources other than the first PSCCH resource m is used for PSSCH transmission. In this case, the receiver UE can send the ACK/NACK in the corresponding feedback resources associated with all the PSCCH resources used by the PSCCH/PSSCH. It can help increase the reliability of ACK/NACK because more than one repetition of ACK/NACK is transmitted in the ACK/NACK feedback channels.

In one embodiment of non-adjacent PSCCH+PSSCH, different resource pools for PSCCH and PSSCH are (pre)configured such that a UE may transmit PSCCH and the corresponding PSSCH in non-adjacent resource blocks in a slot, the PSCCH resource m is the set of contiguous resource blocks with the physical resource block number n_{PRB}=n_{PSCCHstart}+2*m+j for j=0 . . . n_{FbChsize} where n_{PSCCHstart} is the starting RB index of the resource pool for PSCCH given by higher layer parameter startRBPSCCHPool. The parameter n_{PSCCHsize} is the number of RBs for a PSCCH resource.

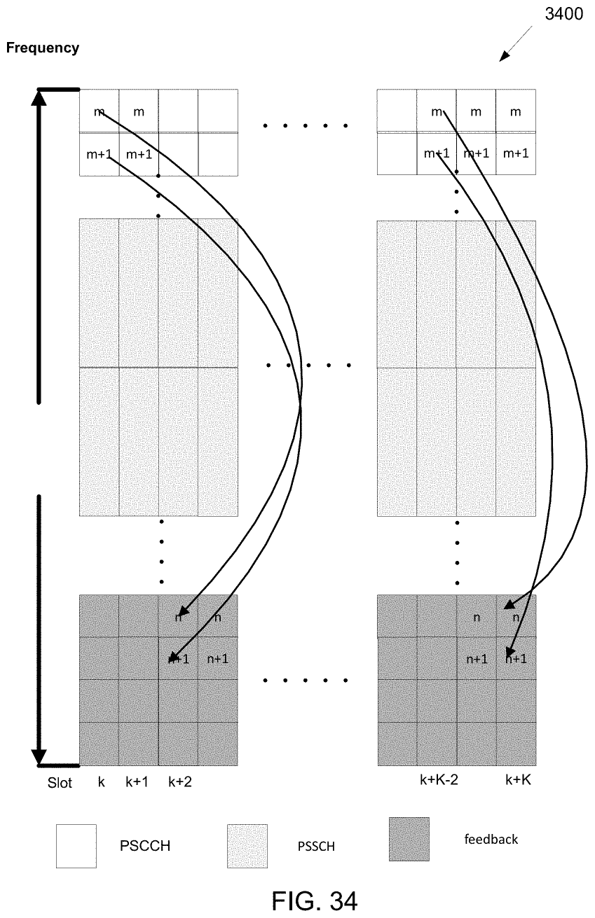

FIG. 34 illustrates yet another example feedback channel resource 3400 according to embodiments of the present disclosure. The embodiment of the feedback channel resource 3400 illustrated in FIG. 34 is for illustration only. FIG. 34 does not limit the scope of the present disclosure to any particular implementation.

In one example, the associated feedback channel resource is determined as below and an example is shown in FIG. 34. In such example, different PSCCH channels are associated with feedback channel resources in different frequency resource blocks and time resources.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for j=0 . . . n_{FbChsize} where n_{subCHRBstart} and offset are the starting RB index of the PSCCH resource pool and the offset in number of RBs relative to the starting RB index of the PSCCH resource pool that are given by higher layer parameters. The parameter n_{FbChsize} is the number of RBs for a feedback channel resource.

In the time domain, the feedback channel resource associated with PSCCH resource m is in slot k+k_{offset} where k is the slot for PSCCH resource in and k_{offset} is the slot offset relative to slot k. k_{offset} can be configured by higher layers.

As illustrated in FIG. 34, PSCCH resource m in slot k is associated with the feedback channel n in slot k+2 with a slot offset k_{offset} of 2 relative to PSCCH resource m in slot k. PSCCH resource m+1 in slot k+K−2 is associated with the feedback channel n+1 in slot k+K with a slot offset k_{offset} of 2 relative to PSCCH resource m+1 in slot k+K−2.

Because there is a one-to-one association between one PSCCH resource and one PSSCH subchannel, there may be more than one PSSCH subchannel transmission for one corresponding TB. In this case, the receiver UE can send the ACK/NACK in the corresponding feedback resources associated with all the PSCCH resources that correspond to all the PSSCH subchannels for the TB transmission. It can help increase the reliability of ACK/NACK because more than one repetition of ACK/NACK is transmitted in the ACK/NACK feedback channels.

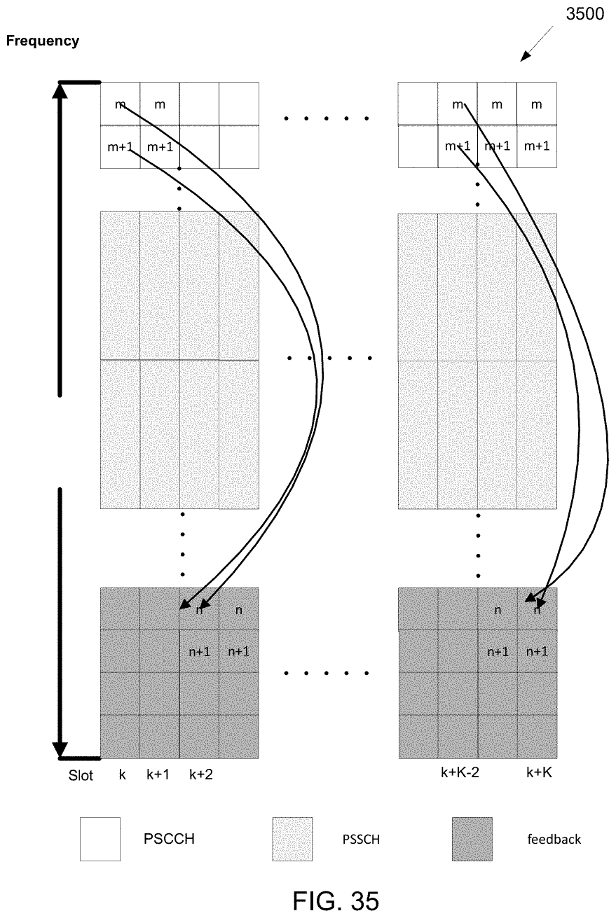

FIG. 35 illustrates yet another example feedback channel resource 3500 according to embodiments of the present disclosure. The embodiment of the feedback channel resource 3500 illustrated in FIG. 35 is for illustration only. FIG. 35 does not limit the scope of the present disclosure to any particular implementation.

In one example, the associated feedback channel resource is determined as below and an example is shown in FIG. 35. In such example, different PSCCH channels in the same time slot may be associated with a same feedback channel resource, but PSCCH channels in a different time slot can only associated with feedback channel resources in a different time slot. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource is configured by higher layers or pre-defined.

In the frequency domain, the feedback channel resource associated with PSCCH resource m is the set of contiguous resource blocks with the physical resource block number n_{PRB}=n_{subCHRBstart}+n_{offset}+└m/nₘᵤₗₜᵢₚₗₑₓ ┘*n_{FbChsize} for j=0 . . . n_{FbChsize} where n_{subCHRBstart} and n_{offset} are the starting RB index of the PSCCH resource pool and the offset in number of RBs relative to the starting RB index of the PSCCH resource pool that are given by higher layer parameters. The parameter n_{FbChsize} is the number of RBs for a T-F feedback channel resource. nₘᵤₗₜᵢₚₗₑₓ is the number of feedback channels multiplexed in the same feedback resource.

In the time domain, the feedback channel resource associated with PSCCH resource m is in slot k+k_{offset} where k is the slot for PSCCH resource m and k_{offset} is the slot offset relative to slot k. k_{offset} can be configured by higher layers.

As illustrated in FIG. 35, PSCCH resource m and m+1 in slot k is associated with the feedback channel resource n in slot k+2 with a slot offset k_{offset} of 2 relative to PSCCH resource m in slot k. PSCCH resource m and m+1 in slot k+K−2 is associated with the feedback channel resource n in slot k+K with a slot offset k_{offset} of 2 relative to PSCCH resource m+1 in slot k+K−2.

Because there is a one-to-one association between one PSCCH resource and one PSSCH subchannel, there may be more than one PSSCH subchannel transmission for one corresponding TB. In this case, the receiver UE can send the ACK/NACK in the corresponding feedback resources associated with all the PSCCH resources that correspond to all the PSSCH subchannels for the TB transmission. It can help increase the reliability of ACK/NACK because more than one repetition of ACK/NACK is transmitted in the ACK/NACK feedback channels.

For TDM (PSCCH+PSSCH), a PSCCH+PSSCH resource pool is (pre)configured such that a UE always transmits PSCCH and the corresponding PSSCH in TDM in a subframe or different subframes, PSCCH resource m is the set of contiguous resource blocks with the physical resource block number n_{PRB}=n_{subCHRBstart}+m*n_{subCHsize}+j for j=0 . . . n_{PSCCCHsize} where n_{subCHRBstart} and n_{subCHsize} are the starting RB index and subchannel size of the PSCCH+PSSCH resource pool that are given by higher layer parameters startRBSubchannel and sizeSubchannel, respectively. The parameter n_{PSCCCHsize} is the number of RBs for a PSCCH resource.

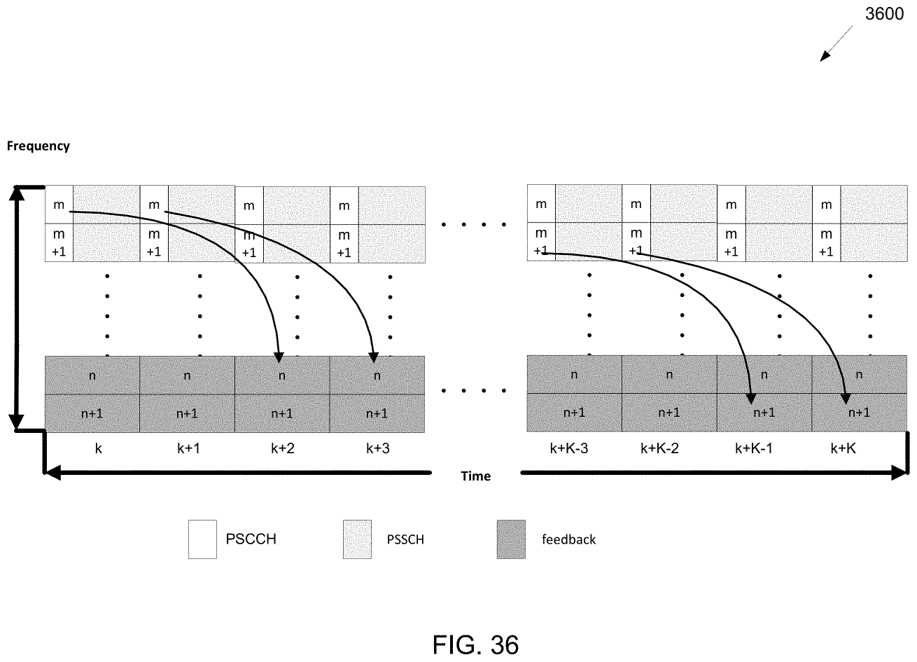

FIG. 36 illustrates yet another example feedback channel resource 3600 according to embodiments of the present disclosure. The embodiment of the feedback channel resource 3600 illustrated in FIG. 36 is for illustration only. FIG. 36 does not limit the scope of the present disclosure to any particular implementation.

In one example, the associated feedback channel resource is determined as below and an example is shown in FIG. 36. In this approach, different PSCCH channels are associated with feedback channel resources in different frequency resource blocks and time resources.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for J=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a T-F feedback channel resource.

In the time domain, the feedback channel resource associated with PSCCH resource m is in slot k+k_{offset} where k is the time slot for PSCCH resource m and k_{offset} is the time slot offset relative to time slot k. k_{offset} can be configured by higher layers.

As illustrated in FIG. 36, PSCCH resource m in slot k is associated with the feedback channel resource n in slot k+2 with a slot offset k_{offset} of 2 relative to PSCCH resource m in slot k. PSCCH resource m+1 in slot k+K−3 is associated with the feedback channel resource n+1 in slot k+K−1 with a slot offset k_{offset} of 2 relative to PSCCH resource m+1 in slot k+K−3.

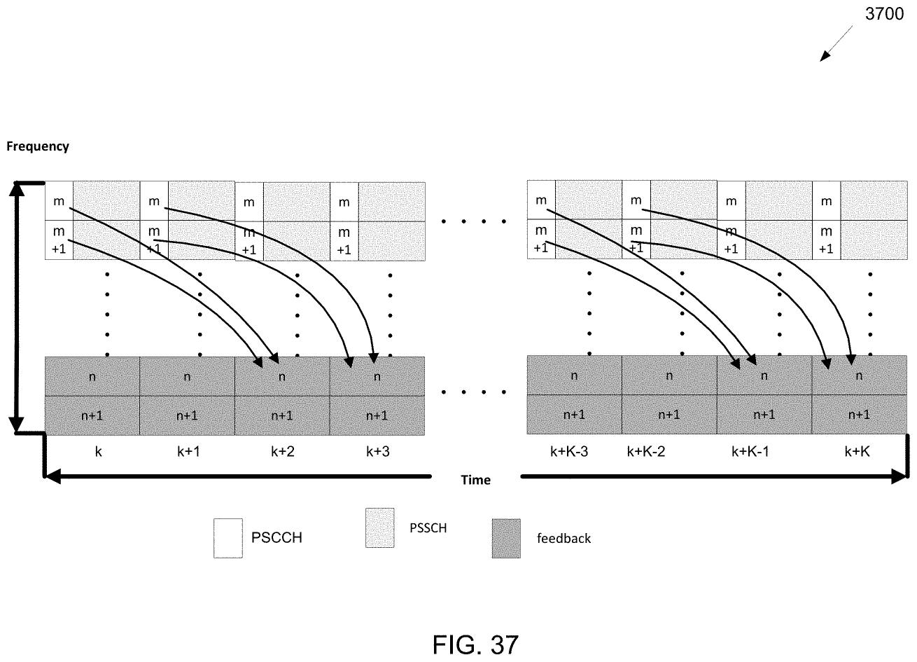

FIG. 37 illustrates yet another example feedback channel resource 3700 according to embodiments of the present disclosure. The embodiment of the example feedback channel resource 3700 illustrated in FIG. 37 is for illustration only. FIG. 37 does not limit the scope of the present disclosure to any particular implementation.

In one example, the associated feedback channel resource is determined as below and an example is shown in FIG. 37. In this approach, PSCCH resources in the same time slot may be associated with a same feedback channel resource, but PSCCH resources in a different time slot can only be associated with feedback channel resources in a different time slot. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource is configured by higher layers or pre-defined.

In the frequency domain, the feedback channel resource associated with PSCCH resource m is the set of contiguous resource blocks with the physical resource block number n_{PRB}=n_{subCHRBstart}+n_{offset}+└m/nₘᵤₗₜᵢₚₗₑₓ ┘*n_{FbChsize}+j for j=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a T-F feedback channel resource. nₘᵤₗₜᵢₚₗₑₓ is the number of feedback channels multiplexed in the same T-F feedback resource.

In the time domain, the feedback channel resource associated with PSCCH resource m is in slot k+k_{offset} where k is the time slot for PSCCH resource m and k_{offset} is the slot offset relative to slot k. k_{offset} can be configured by higher layers.

As illustrated in FIG. 37, PSCCH resource m and m+1 in slot k is associated with the feedback channel resource n in slot k+2 with a slot offset k_{offset} of 2 relative to PSCCH resource m in slot k. PSCCH resource m and m+1 in slot k+K−3 is associated with the feedback channel resource n+1 in slot k+K−1 with a slot offset k_{offset} of 2 relative to PSCCH resource m+1 in slot k+K−3. In this example, the number of feedback channels multiplexed in the same feedback channel resource nₘᵤₗₜᵢₚₗₑₓ is 2.

In this embodiment, there is an association between PSCCH resource m and the associated feedback channel resource. The association is based upon both frequency domain and time domain of PSCCH resource m.

There is a separate resource pool that is configured by higher layers and dedicated for the use of ACK/NACK feedback channels. In this embodiment, the receiver UE simply feedbacks the ACK/NACK in the associated feedback channel resource and the receiver UE can support unicast, multicast and broadcast without any bits in the SCI indicating the receiver UE ID or receiver group ID. The sender UE can decode and acquire the corresponding ACK/NACK information from the associated ACK/NACK feedback channel resource.

In such embodiment, for each PSCCH resource m, there is one associated T-F feedback channel resource in each time slot within a time slot offset range relative to PSCCH resource m. For each associated T-F feedback channel resource, there may be more than one feedback channel associated with different PSCCH resources respectively. In each T-F feedback channel resource, how feedback channels are multiplexed in the same T-F feedback channel resource is configured or pre-defined.

The benefits of the aforementioned embodiment: the sender UE can signal in the associated PSCCH the time slot (in the form of slot offset relative to the PSCCH) the sender UE needs the receiver UE to feedback the ACK/NACK; the sender UE can signal in the associated PSCCH the latest time slot (in the form of slot offset relative to the PSCCH) the sender UE needs the receiver UE to feedback the ACK/NACK; depending upon the receiver UE processing delay, the receiver UE can choose the time slot that the receiver UE can send the ACK/NACK; or the receiver UE can send the ACK/NACK in more than one associated feedback channel to increase the reliability of ACK/NACK transmission.

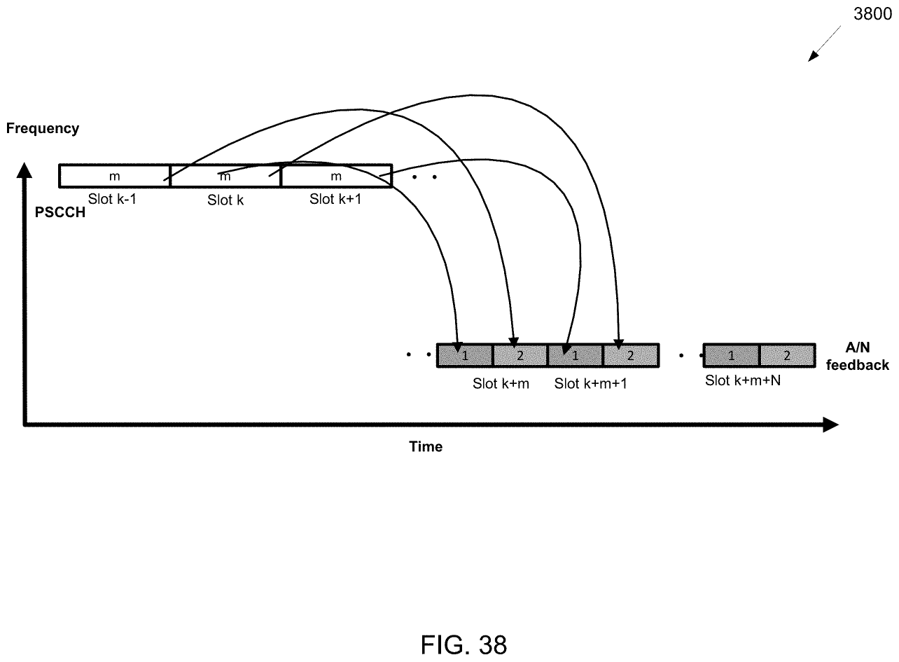

FIG. 38 illustrates an example PSCCH resource 3800 according to embodiments of the present disclosure. The embodiment of the PSCCH resource 3800 illustrated in FIG. 38 is for illustration only. FIG. 38 does not limit the scope of the present disclosure to any particular implementation.

As illustrated in FIG. 38, PSCCH resource m in time slot k is associated with feedback channel 1 in time slot k+m and feedback channel 2 in time slot k+m+1. In this example, there are two feedback channels in each T-F feedback resource n in a time slot. Similarly, PSCCH resource m in time slot k−1 is associated with feedback channel 1 in time slot k+m−1 and feedback channel 2 in time slot k+m.

In one embodiment, for adjacent PSCCH+PSSCH, a PSCCH+PSSCH resource pool is (pre)configured such that a UE always transmits PSCCH and the corresponding PSSCH in adjacent resource blocks in a subframe, the PSCCH resource m is the set of contiguous resource blocks with the physical resource block number n_{PRB}=n_{subCHRBstart}+m*n_{subCHsize}+j for j=0 . . . n_{PSCCCHsize} where n_{subCHRBstart} and n_{subCHsize} are the starting RB index and subchannel size of the PSCCH+PSSCH resource pool that are given by higher layer parameters startRBSubchannel and sizeSubchannel, respectively. The parameter n_{PSCCCHsize} is the number of RBs for a PSCCH resource.

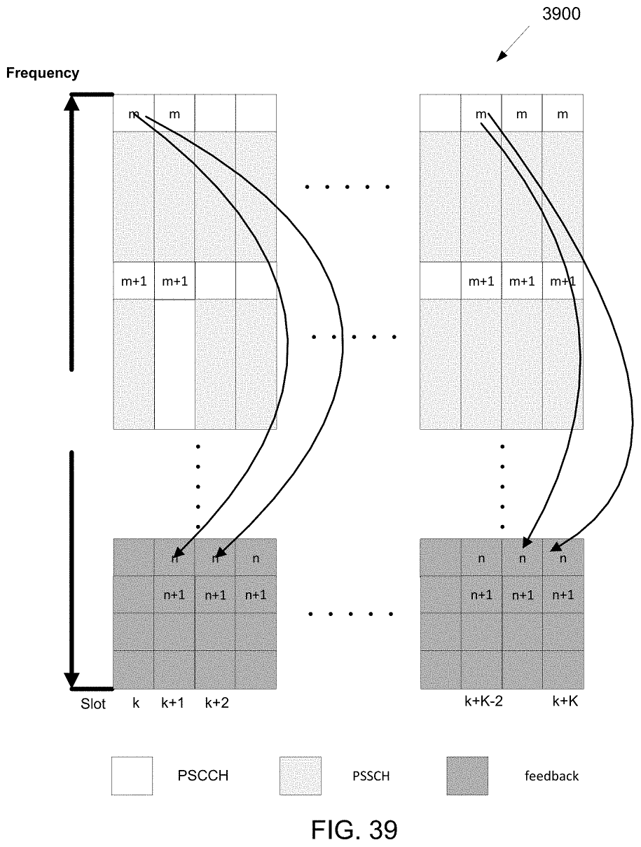

FIG. 39 illustrates yet another example feedback channel resource 3900 according to embodiments of the present disclosure. The embodiment of the feedback channel resource 3900 illustrated in FIG. 39 is for illustration only. FIG. 39 does not limit the scope of the present disclosure to any particular implementation.

In one example, the associated feedback channel resource is determined as below and an example is shown in FIG. 39. In this approach, each PSCCH resource are associated with more than one T-F feedback channel resource in different time slots and feedback channels associated with PSCCH resources in different time slots may multiplex in the same T-F feedback channel resource.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for j=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a feedback channel resource.

In the time domain, the feedback channel resource associated with PSCCH resource m is in slot k+k_{offset} . . . k+k_{offset}+M, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel. For each T-F feedback channel resource that is associated with PSCCH resource m, how the feedback channels are multiplexed is configured by higher layers or predefined.

As illustrated in FIG. 39, PSCCH resource m in slot k is associated with one feedback channel in the feedback channel resource n in slot k+1 with a slot offset k_{offset} of 1 relative to PSCCH resource m in slot k. PSCCH resource m in slot k is also associated with one feedback channel in the feedback channel resource n in slot k+2 with a slot offset k_{offset} of 2 relative to PSCCH resource m in slot k.

If there is more than one PSSCH subchannel transmission for one corresponding PSCCH, there are more than one PSCCH resource used in the PSCCH and PSSCH where PSCCH resources other than the first PSCCH resource m is used for PSSCH transmission. In this case, the receiver UE can send the ACK/NACK in the corresponding feedback resources associated with all the PSCCH resources used by the PSCCH/PSSCH. It can help increase the reliability of ACK/NACK because more than one repetition of ACK/NACK is transmitted in the ACK/NACK feedback channels.

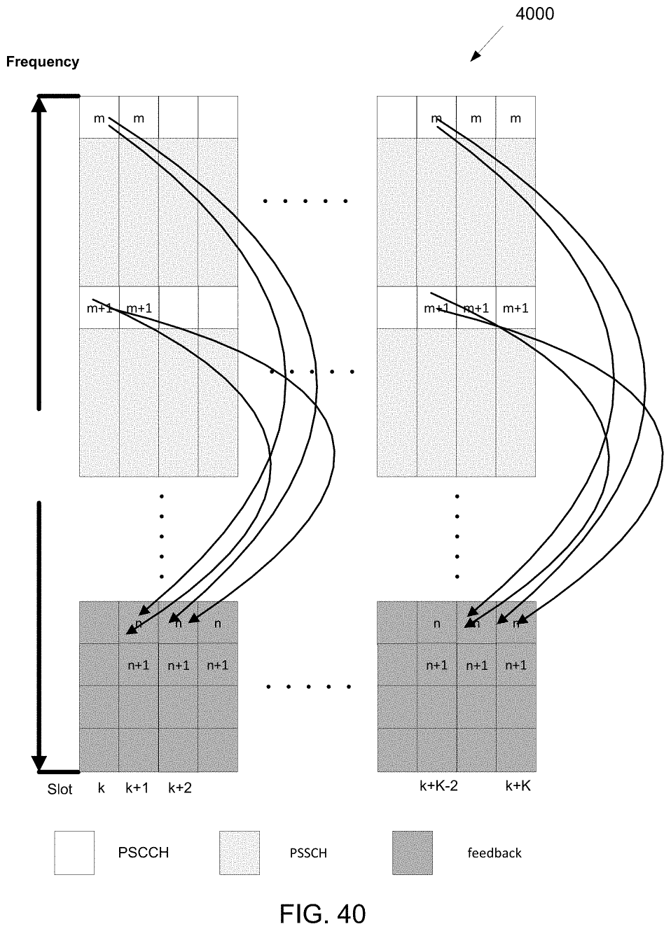

FIG. 40 illustrates yet another example feedback channel resource 4000 according to embodiments of the present disclosure. The embodiment of the feedback channel resource 4000 illustrated in FIG. 40 is for illustration only. FIG. 40 does not limit the scope of the present disclosure to any particular implementation.

In one example, the associated feedback channel resource is determined as below and an example is shown in FIG. 40. In this example, PSCCH resources in the same time slot but in different frequency resource blocks may be associated with a same feedback channel resource. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource are configured by higher layers or pre-defined.

In the frequency domain, the feedback channel resource associated with PSCCH resource m for PSCCH resource is the set of contiguous resource blocks with the physical resource block number n_{PRB}=n_{subCHRBstart}+n_{offset}+└m/nₘᵤₗₜᵢₚₗₑₓ ┘*n_{FbChsize}+j for j . . . n_{FbChsize}where n_{subCHRBstart} and offset are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a feedback channel resource. nₘᵤₗₜᵢₚₗₑₓ is the number of feedback channels associated with PSCCH resources in the same time slot that are multiplexed in the same feedback channel resource.

In the time domain, the feedback channel resource associated with PSCCH resource m is in slot k+k_{offset} . . . k+k_{offset}+M, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel associated with the PSCCH resources from the same time slot. For each T-F feedback channel resource that is associated with PSCCH resource m, how the feedback channels are multiplexed is configured by higher layers or predefined.

As illustrated in FIG. 40, PSCCH resource m and m+1 in slot k is associated with one feedback channel in the feedback channel resource n in slot k+1 with a slot offset of 1 relative to PSCCH resource m in slot k. PSCCH resource m and m+1 in slot k is also associated with one feedback channel in the feedback channel resource n in slot k+2 with a slot offset of 2 relative to PSCCH resource m in slot k. In this example, a number of feedback channels associated with PSCCH resources in the same time slot multiplexed in the same T-F feedback channel resource nₘᵤₗₜᵢₚₗₑₓ s 2.

If there is more than one PSSCH subchannel transmission for one corresponding PSCCH, there are more than one PSCCH resource used in the PSCCH and PSSCH where PSCCH resources other than the first PSCCH resource m is used for PSSCH transmission. In this case, the receiver UE can send the ACK/NACK in the corresponding feedback resources associated with all the PSCCH resources used by the PSCCH/PSSCH. It can help increase the reliability of ACK/NACK because more than one repetition of ACK/NACK is transmitted in the ACK/NACK feedback channels.

In one embodiment, for non-adjacent PSCCH+PSSCH, different resource pools for PSCCH and PSSCH are (pre)configured such that a UE may transmit PSCCH and the corresponding PSSCH in non-adjacent resource blocks in a slot, the PSCCH resource m is the set of contiguous resource blocks with the physical resource block number n_{PRB}=n_{PSCCHstart}+2*m+j for j= . . . n_{FbChsize} where n_{PSCCHstart} is the starting RB index of the resource pool for PSCCH given by higher layer parameter startRBPSCCHPool. The parameter n_{PSCCCHsize} is the number of RBs for a PSCCH resource.

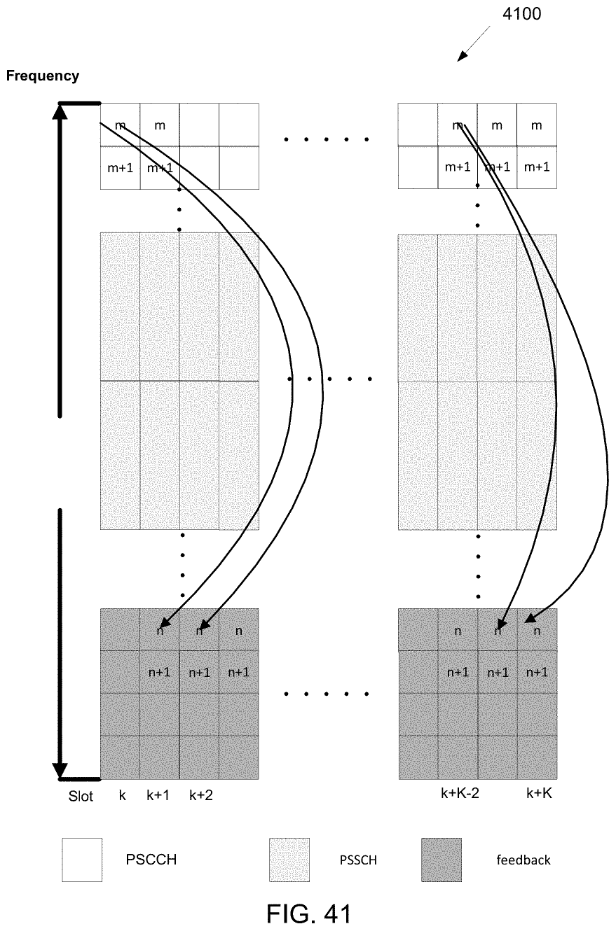

FIG. 41 illustrates yet another example feedback channel resource 4100 according to embodiments of the present disclosure. The embodiment of the feedback channel resource 4100 illustrated in FIG. 41 is for illustration only. FIG. 41 does not limit the scope of the present disclosure to any particular implementation.

In one example, the associated feedback channel resource is determined as below and an example is shown in FIG. 41. In this example, each PSCCH resource are associated with more than one T-F feedback channel resource in different time slots and feedback channels associated with PSCCH resources in different time slots may multiplex in the same T-F feedback channel resource.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for j=0 . . . n_{FbChsize} where n_{subCHRBstart} and n_{offset} are the starting RB index of the PSCCH resource pool and the offset in number of RBs relative to the starting RB index of the PSCCH resource pool that are given by higher layer parameters. The parameter n_{FbChsize} is the number of RBs for a feedback channel resource.

In the time domain, the feedback channel resource associated with PSCCH resource m is in slot k+k_{offset} . . . k+k_{offset}+m, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel. For each T-F feedback channel resource that is associated with PSCCH resource m, how the feedback channels are multiplexed is configured by higher layers or predefined.

As illustrated in FIG. 41, PSCCH resource m in slot k is associated with one feedback channel in the feedback channel resource n in slot k+1 with a slot offset of 1 relative to PSCCH resource m in slot k. PSCCH resource m in slot k is also associated with one feedback channel in the feedback channel resource n in slot k+2 with a slot offset of 2 relative to PSCCH resource m in slot k.

Because there is a one-to-one association between one PSCCH resource and one PSSCH subchannel, there may be more than one PSSCH subchannel transmission for one corresponding TB. In this case, the receiver UE can send the ACK/NACK in the corresponding feedback resources associated with all the PSCCH resources that correspond to all the PSSCH subchannels for the TB transmission. It can help increase the reliability of ACK/NACK because more than one repetition of ACK/NACK is transmitted in the ACK/NACK feedback channels.

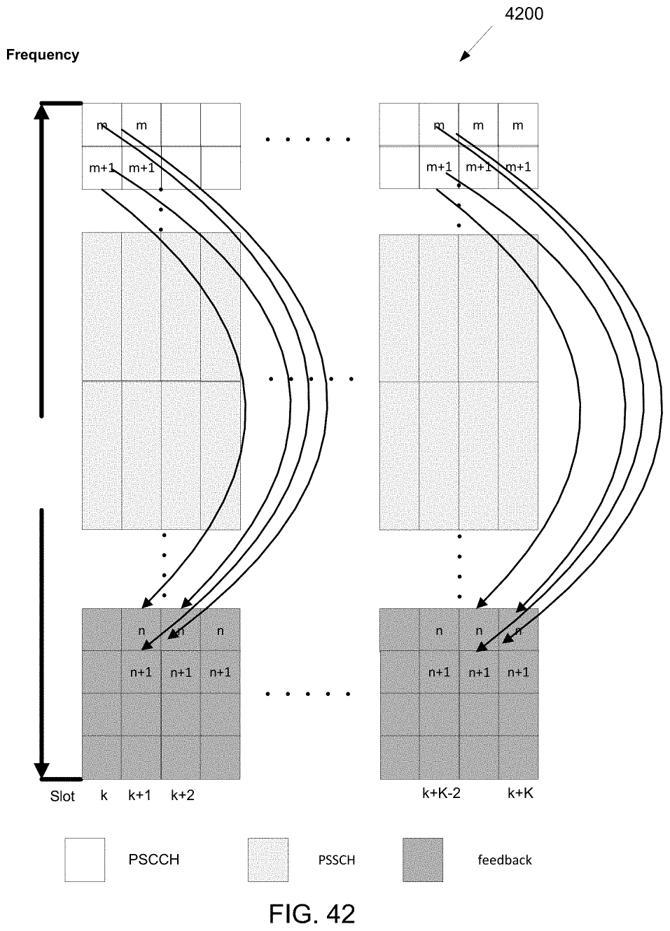

FIG. 42 illustrates yet another example feedback channel resource 4200 according to embodiments of the present disclosure. The embodiment of the feedback channel resource 4200 illustrated in FIG. 42 is for illustration only. FIG. 42 does not limit the scope of the present disclosure to any particular implementation.

In one example, the associated feedback channel resource is determined as below and an example is shown in FIG. 42. In this approach, different PSCCH channels in the same time slot may be associated with a same feedback channel resource. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource is configured by higher layers or pre-defined.

In the frequency domain, the feedback channel resource associated with PSCCH resource m is the set of contiguous resource blocks with the physical resource block number n_{PRB}=n_{subCHRBstart}+n_{offset}+└m/nₘᵤₗₜᵢₚₗₑₓ ┘*n_{FbChsize}+j for j=0 . . . n_{FbChsize} where n_{subCHRBstart} and n_{offset} are the starting RB index of the PSCCH resource pool and the offset in number of RBs relative to the starting RB index of the PSCCH resource pool that are given by higher layer parameters. The parameter n_{FbChsize} is the number of RBs for a feedback channel resource. nₘᵤₗₜᵢₚₗₑₓ is the number of feedback channels associated with PSSCH resources in the same time slot multiplexed in the same T-F feedback channel resource.

In the time domain, the feedback channel resource associated with PSCCH resource m is in slot k+k_{offset} . . . k+k_{offset}+m, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel associated with the PSCCH resources from the same time slot. For each T-F feedback channel resource that is associated with PSCCH resource m, how the feedback channels are multiplexed is configured by higher layers or predefined.

As illustrated in FIG. 42, PSCCH resource m and m+1 in slot k is associated with one feedback channel in the feedback channel resource n in slot k+1 with a slot offset of 1 relative to PSCCH resource m in slot k. PSCCH resource m and m+1 in slot k is also associated with one feedback channel in the feedback channel resource n in slot k+2 with a slot offset of 2 relative to PSCCH resource m in slot k. In this example, the number of feedback channels associated with PSCCH resources in the same time slot multiplexed in the same T-F feedback channel resource nₘᵤₗₜᵢₚₗₑₓ is 2.

Because there is a one-to-one association between one PSCCH resource and one PSSCH subchannel, there may be more than one PSSCH subchannel transmission for one corresponding TB. In this case, the receiver UE can send the ACK/NACK in the corresponding feedback resources associated with all the PSCCH resources that correspond to all the PSSCH subchannels for the TB transmission. It can help increase the reliability of ACK/NACK because more than one repetition of ACK/NACK is transmitted in the ACK/NACK feedback channels.

In one embodiment, for adjacent PSCCH+PSSCH, a PSCCH+PSSCH resource pool is (pre)configured such that a UE always transmits PSCCH and the corresponding PSSCH in TDM in a subframe or different subframes, the PSCCH resource m is the set of contiguous resource blocks with the physical resource block number n_{PRB}=n_{subCHRBstart}+m*n_{subCHsize}+j for j=0 . . . n_{PSCCHHsize} where n_{subCHRBstart} and n_{subCHsize} are the starting RB index and subchannel size of the PSCCH+PSSCH resource pool that are given by higher layer parameters startRBSubchannel and sizeSubchannel, respectively. The parameter n_{PSCCCHsize} is the number of RBs for a PSCCH resource.

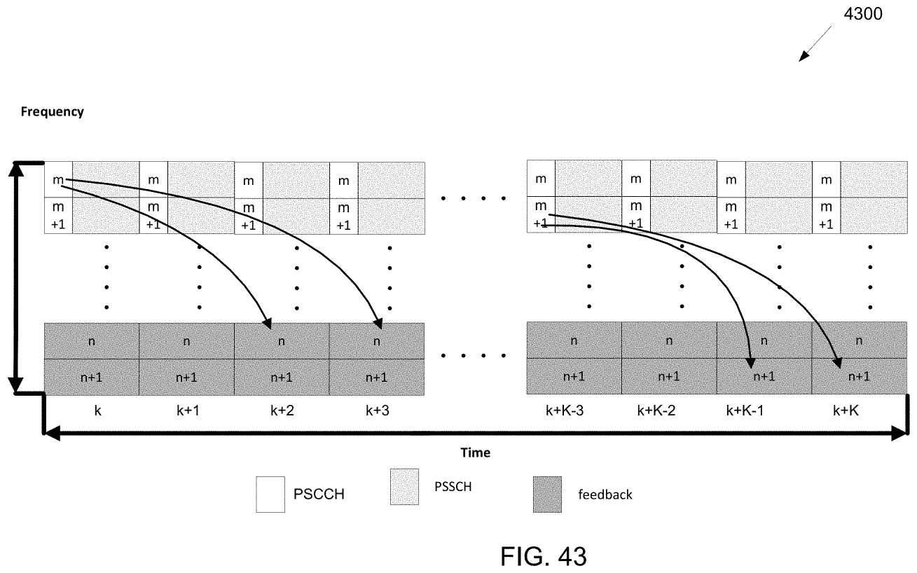

FIG. 43 illustrates yet another example feedback channel resource 4300 according to embodiments of the present disclosure. The embodiment of the feedback channel resource 4300 illustrated in FIG. 43 is for illustration only. FIG. 43 does not limit the scope of the present disclosure to any particular implementation.

In one example, the associated feedback channel resource is determined as below and an example is shown in FIG. 43. In this example, each PSCCH resource are associated with more than one T-F feedback channel resource in different time slots and feedback channels associated with PSCCH resources in different time slots may multiplex in the same T-F feedback channel resource.

In the frequency domain, the feedback channel resource associated with PSCCH resource m is the set of contiguous resource blocks with the physical resource block number n_{PRB}=n_{subCHRBstart}+n_{offset}+m*n_{FbChsize}+j for j=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a feedback channel resource.

In the time domain, the feedback channel resource associated with PSCCH resource m is in slot k+k_{offset} . . . k+k_{offset}+M, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel. For each T-F feedback channel resource that is associated with PSCCH resource m, how the feedback channels are multiplexed is configured by higher layers or predefined.

As illustrated in FIG. 43, PSCCH resource m in slot k is associated with one feedback channel in the feedback channel resource n in slot k+2 with a slot offset k_{offset} of 2 relative to PSCCH resource m in slot k. PSCCH resource m in slot k is also associated with one feedback channel in the feedback channel resource n in slot k+3 with a slot offset k_{offset} of 3 relative to PSCCH resource m in slot k.

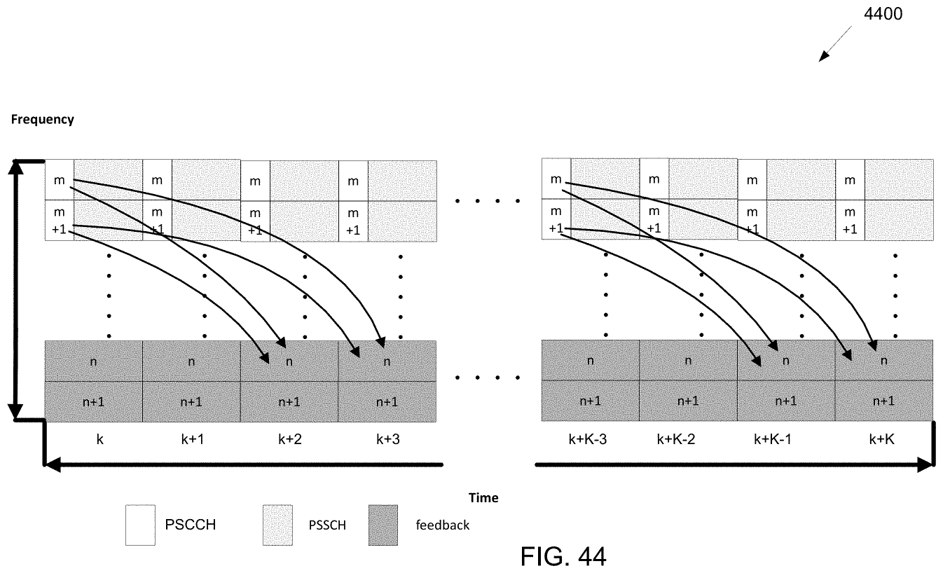

FIG. 44 illustrates yet another example feedback channel resource 4400 according to embodiments of the present disclosure. The embodiment of the feedback channel resource 4400 illustrated in FIG. 44 is for illustration only. FIG. 44 does not limit the scope of the present disclosure to any particular implementation.

In one example, the associated feedback channel resource is determined as below and an example is shown in FIG. 44. In this approach, PSCCH resources in the same time slot but in different frequency resource blocks may be associated with a same feedback channel resource. The reason is due to fewer bits that need to be carried by a feedback channel compared with a PSCCH channel, a feedback channel resource in a time slot can hold more than one feedback channel. In a same time slot, multiple feedback channels can be multiplexed in a TDM manner, FDM manner, or CDM manner and so on. How feedback channels are multiplexed in the same T-F feedback resource are configured by higher layers or pre-defined.

In the frequency domain, the feedback channel resource associated with PSCCH resource m for PSCCH resource is the set of contiguous resource blocks with the physical resource block number n_{PRB}=n_{subCHRBstart}+n_{offset}+└m/nₘᵤₗₜᵢₚₗₑₓ ┘*n_{FbChsize}+j for j=0 . . . n_{FbChsize} where n_{subCHRBstart} and n_{offset} are the starting RB index of the PSCCH+PSSCH resource pool and the offset in number of RBs relative to the starting RB index of the PSCCH+PSSCH resource pool that are given by higher layer parameters. The parameter n_{FbChsize} is the number of RBs for a feedback channel resource. nₘᵤₗₜᵢₚₗₑₓ is the number of feedback channels associated with PSCCH resources in the same time slot that are multiplexed in the same feedback channel resource.

In the time domain, the feedback channel resource associated with PSCCH resource m is in slot k+k_{offset} . . . k+k_{offset}+M, where k is the time slot for PSCCH resource m and k_{offset} is the minimum slot offset relative to slot k that is configured by higher layers. M is configured by higher layers and is the slot range within which there are feedback channel resources associated with a same PSCCH resource.

In each T-F feedback channel resource, there may be more than one feedback resource channel associated with the PSCCH resources from the same time slot. For each T-F feedback channel resource that is associated with PSCCH resource m, how the feedback channels are multiplexed is configured by higher layers or predefined.

As illustrated in FIG. 44, PSCCH resource m and m+1 in slot k is associated with one feedback channel in the feedback channel resource n in slot k+2 with a slot offset of 2 relative to PSCCH resource m in slot k. PSCCH resource m and m+1 in slot k is also associated with one feedback channel in the feedback channel resource n in slot k+3 with a slot offset of 3 relative to PSCCH resource m in slot k. In this example, The number of feedback channels associated with PSCCH resources in the same time slot multiplexed in the same T-F feedback channel resource nₘᵤₗₜᵢₚₗₑₓ is 2.

In one embodiment, a self-contained slot structure is used for transmitting PSCCH/PSSCH and receiving corresponding ACK/NACK feedback that are all contained in the same slot. This is helpful for latency sensitive applications that require very quick ACK/NACK feedback.

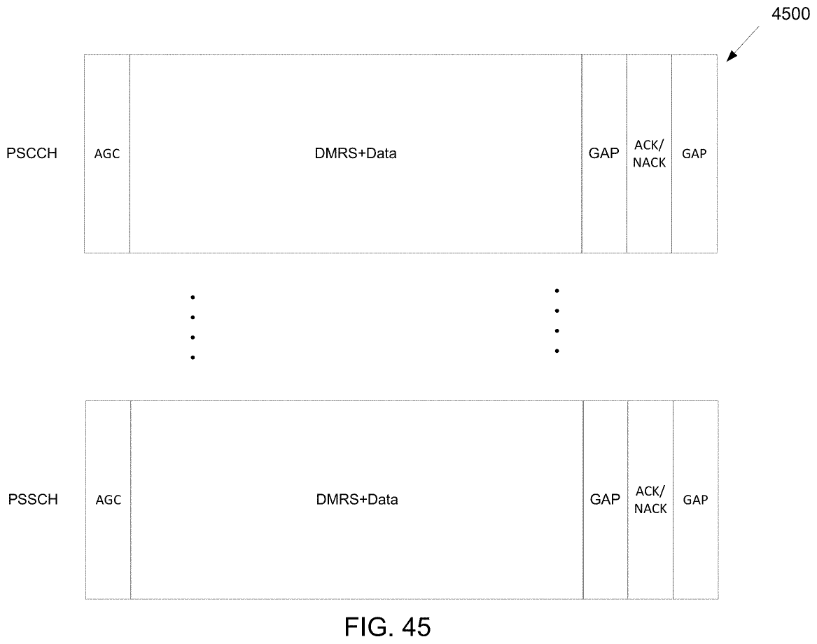

FIG. 45 illustrates yet another example feedback channel resource 4500 according to embodiments of the present disclosure. The embodiment of the feedback channel resource 4500 illustrated in FIG. 45 is for illustration only. FIG. 45 does not limit the scope of the present disclosure to any particular implementation.

As illustrated in FIG. 45, the corresponding ACK/NACK is transmitted by the receiver in the same slot as PSCCH/PSSCH transmitted by the sender UE. The ACK/NACK can be transmitted in the whole PSCCH and PSSCH bandwidth to increase the reliability of the ACK/NACK transmission. There is an extra guard period between DMRS+Data (Tx) and ACK/NACK (Rx) for Tx-Rx transition.

Similarly, ACK/NACK symbols also need to have corresponding AGC, DMRS and ACK/NACK parts.

The resource blocks that are used for self-contained slot transmission can be configured by higher layers. The UE can sense and select self-contained slots separately for transmitting data with extremely low latency requirements.

In one embodiment, there is a PSCCH/PSSCH transmission by the UE at the same time slot when it is also time for the ACK/NACK to be transmitted by the same UE. In this embodiment, the UE doesn't transmit the ACK/NACK in the ACK/NACK feedback channel. The UE embeds the ACK/NACK information in the PSCCH/PSSCH channel in order to avoid multi-cluster transmission and reduce UE power backoff.

Because the ACK/NACK is not transmitted in the associated feedback channel resource, the problem here is how the ACK/NACK receiver UE can know where the ACK/NACK is targeted.

In one example, if the PSCCH/PSSCH transmitted by the ACK/NACK sender UE is a broadcast TB and the PSCCH/PSSCH associated with the ACK/NACK is a unicast TB, extra information indicating the receiver UE ID of ACK/NACK needs to be carried by the PSCCH/PSSCH. Specially, one bit in the PSCCH needs to be available to indicate there is a receiver UE ID field and an ACK/NACK field embedded in the corresponding PSSCH. In the corresponding PSSCH, a receiver UE ID field can be in the form of the UE ID or PSCCH resource m associated with the ACK/NACK feedback. When the receiver UE ID is in the form of PSCCH resource m, PSCCH resource m is carried in the PSSCH and └ log₂(N_{subCH})┘ bits are needed to indicate the position of PSCCH resource m where N_{subcH} is the total number of subchannels in the PSCCH resource pool determined by higher layer parameter numSubchannel. When the receiver UE ID is in the form of UE ID, Layer-2 ID can be used instead.

In one example, if the PSCCH/PSSCH transmitted by the ACK/NACK sender UE is a broadcast TB, and the PSCCH/PSSCH resource associated with the ACK/NACK is also a broadcast TB, extra information indicating the PSCCH/PSSCH resource associated with ACK/NACK needs to be carried by the PSCCH/PSSCH. Specially, one bit in the PSCCH needs to be available to indicate there is an ACK/NACK field embedded in the corresponding PSSCH. In the corresponding PSSCH, where PSCCH resource m is carried, └ log₂(N_{subCH})┘ bits are needed to indicate the position of the PSCCH resource where N_{subCH} is the total number of subchannels in the PSCCH resource pool determined by higher layer parameter numSubchannel.

In one example, if the PSCCH/PSSCH transmitted by the ACK/NACK sender UE is a unicast TB, and the receiver UE for this unicast TB is not the same UE for the ACK/NACK. The ACK/NACK cannot be multiplexed in this unicast TB.

In one example, if the PSCCH/PSSCH transmitted by the ACK/NACK sender UE is a unicast TB, and the receiver UE for this unicast TB is the same UE for the ACK/NACK. The receiver UE ID that is carried in the PSCCH can be used to indicate where the ACK/NACK multiplexed in the PSSCH is targeted. Similarly one bit in the PSCCH needs to be available to indicate there is an ACK/NACK field embedded in the corresponding PSSCH.

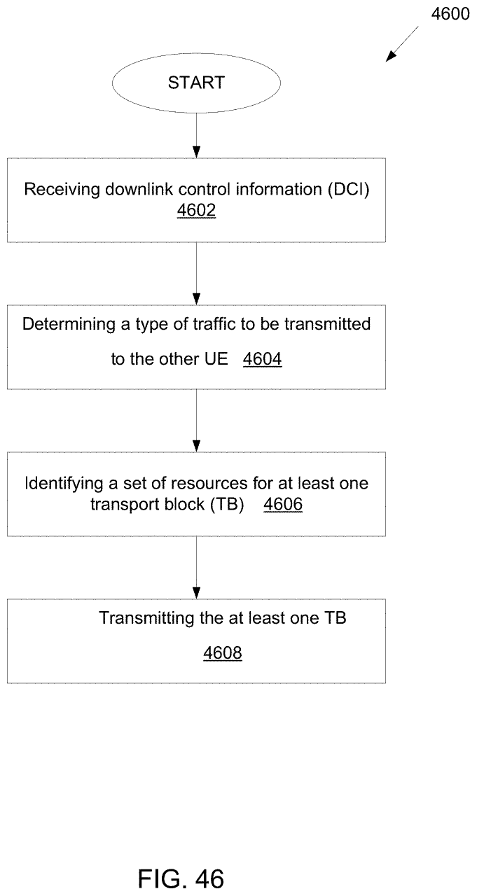

FIG. 46 illustrates a flowchart of a method 4600 for network controlled resource allocation according to embodiments of the present disclosure, as may be performed by a UE (e.g., 111-116 as illustrated in FIG. 1). The embodiment of the method 4600 illustrated in FIG. 46 is for illustration only. FIG. 46 does not limit the scope of the present disclosure to any particular implementation.

As illustrated in FIG. 46, the method 4600 begins at step 4602. In step 4602, the UE receives, from a base station (BS), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH).

In one embodiment, the DCI is indicated in a set of resource blocks (RBs) in consecutive slots and the set of RBs are allocated in a same frequency.

In step 4604, the UE determines a type of traffic to be transmitted to the other UE via at least one of the PSFCH, PSCCH, or PSSCH, wherein the type of traffic is aperiodic traffic or periodic traffic.

In step 4606, the UE identifies, based on the type of traffic, a set of resources for at least one transport block (TB) to be included in the at least one of the PSFCH, the PSCCH, or the PSSCH.

In step 4608, the UE transmits, to the other UE via the sidelink, the at least one TB using the identified set of resources.

In one embodiment, the UE further determines whether the PSFCH is enabled based on the DCI or a higher layer signal received from the BS.

In one embodiment, the UE further configures a set of UEs for a groupcast PSCCH/PSSCH.

In one embodiment, the UE further receives, from the set of UEs, scheduling requests including service requirements.

In one embodiment, the UE determines the service requirements including at least one of a periodicity of transmission or a packet size for the aperiodic traffic or the periodic traffic.

In one embodiment, the UE further transmits, to the BS, a resource request based on the determined service requirements.

In one embodiment, the UE further receives, from the BS, an indication of resources corresponding to the resource request.

In one embodiment, the UE further transmits, to the set of UEs via the groupcast PSCCH/PSSCH, the indication of the resources received from the BS, the set of resources being configured in a semi-static manner.

In one embodiment, the UE further autonomously selecting the set of resources based on a pre-configured resource pool.

In one embodiment, the UE further transmits, to the set of UEs via the groupcast PSCCH/PSSCH, an indication of the autonomously selected set of resources, the autonomously selected set of resources being configured in a semi-static manner.

In one embodiment, the UE further determines a set of retransmission resources for a hybrid automatic repeat and request (HARM) when the UE receives a negative response, from the other UE, corresponding to a data transmission via the PSSCH.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claims scope. The scope of patented subject matter is defined only by the claims. Moreover, none of the claims are intended to invoke 35 U.S.C. § 112(f) unless the exact words “means for” are followed by a participle.

What is claimed is:

1. A user equipment (UE) in a wireless communication system, the UE comprising:
a transceiver configured to:
receive, from a base station (BS), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH); and
a processor operably connected to the transceiver, the processor configured to:
determine a type of traffic to be transmitted to the other UE via at least one of the PSFCH, PSCCH, or PSSCH, wherein the type of traffic is aperiodic traffic or periodic traffic; and
identify, based on the type of traffic, a set of resources for at least one transport block (TB) to be included in the at least one of the PSFCH, the PSCCH, or the PSSCH,
wherein the transceiver is further configured to transmit, to the other UE via the sidelink, the at least one TB using the identified set of resources.

2. The UE of claim 1, wherein the DCI is indicated in a set of resource blocks (RBs) in consecutive slots and the set of RBs are allocated in a same frequency.

3. The UE of claim 1, wherein the processor is further configured to determine whether the PSFCH is enabled based on the DCI or a higher layer signal received from the BS.

4. The UE of claim 1, wherein:
the processor is further configured to configure a set of UEs for a groupcast PSCCH/PSSCH;
the transceiver is further configured to receive, from the set of UEs, scheduling requests including service requirements; and
the processor is further configured to determine the service requirements including at least one of a periodicity of transmission or a packet size for the aperiodic traffic or the periodic traffic.

5. The UE of claim 4, wherein the transceiver is further configured to:
transmit, to the BS, a resource request based on the determined service requirements;
receive, from the BS, an indication of resources corresponding to the resource request; and
transmit, to the set of UEs via the groupcast PSCCH/PSSCH, the indication of the resources received from the BS, the set of resources being configured in a semi-static manner.

6. The UE of claim 4, wherein:
the processor is further configured to autonomously select the set of resources based on a pre-configured resource pool; and
the processor is further configured to transmit, to the set of UEs via the groupcast PSCCH/PSSCH, an indication of the autonomously selected set of resources, the autonomously selected set of resources being configured in a semi-static manner.

7. The UE of claim 1, wherein the processor is further configured to determine a set of retransmission resources for a hybrid automatic repeat and request (HARQ) when the UE receives a negative response, from the other UE, corresponding to a data transmission via the PSSCH.

8. A base station (BS) in a wireless communication system, the BS comprising:
a transceiver configured to transmit, to a user equipment (UE), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH),
wherein:
a type of traffic to be transmitted to the other UE via at least one of the PSFCH, PSCCH, or PSSCH, is determined, the type of traffic being aperiodic traffic or periodic traffic;
a set of resources for at least one transport block (TB) to be included in the at least one of the PSFCH, the PSCCH, or the PSSCH, based on the type of traffic, is identified; and
the at least one TB using the identified set of resources is transmitted to the other UE via the sidelink.

9. The BS of claim 8, wherein the DCI is indicated in a set of resource blocks (RBs) in consecutive slots and the set of RBs are allocated in a same frequency.

10. The BS of claim 8, wherein whether the PSFCH is enabled is determined based on the DCI or a higher layer signal received from the BS.

11. The BS of claim 8, wherein:
a set of UEs is configured for a groupcast PSCCH/PSSCH;
scheduling requests including service requirements are received from the set of UEs; and
the service requirements including at least one of a periodicity of transmission or a packet size for the aperiodic traffic or the periodic traffic is determined.

12. The BS of claim 11, wherein the transceiver is further configured to:
receive, from the UE, a resource request based on the determined service requirements; and
transmit, to the UE, an indication of resources corresponding to the resource request.

13. The BS of claim 12, wherein the indication of the resources received from the BS is transmitted to the set of UEs via the groupcast PSCCH/PSSCH, the set of resources being configured in a semi-static manner.

14. A method of a user equipment (UE) in a wireless communication system, the method comprising:
receiving, from a base station (BS), downlink control information (DCI) including information of multi-transmission resources for a sidelink with another UE, wherein the multi-transmission resources are allocated to at least one of a physical sidelink feedback channel (PSFCH), a physical sidelink control channel (PSCCH), or a physical sidelink shared channel (PSSCH);
determining a type of traffic to be transmitted to the other UE via at least one of the PSFCH, PSCCH, or PSSCH, wherein the type of traffic is aperiodic traffic or periodic traffic;
identifying, based on the type of traffic, a set of resources for at least one transport block (TB) to be included in the at least one of the PSFCH, the PSCCH, or the PSSCH; and
transmitting, to the other UE via the sidelink, the at least one TB using the identified set of resources.

15. The method of claim 14, further comprising determining whether the PSFCH is enabled based on the DCI or a higher layer signal received from the BS.

16. The method of claim 14, wherein the DCI is indicated in a set of resource blocks (RBs) in consecutive slots and the set of RBs are allocated in a same frequency.

17. The method of claim 15, further comprising:
configuring a set of UEs for a groupcast PSCCH/PSSCH;
receiving, from the set of UEs, scheduling requests including service requirements; and
determining the service requirements including at least one of a periodicity of transmission or a packet size for the aperiodic traffic or the periodic traffic.

18. The method of claim 17, further comprising:
transmitting, to the BS, a resource request based on the determined service requirements;
receiving, from the BS, an indication of resources corresponding to the resource request; and
transmitting, to the set of UEs via the groupcast PSCCH/PSSCH, the indication of the resources received from the BS, the set of resources being configured in a semi-static manner.

19. The method of claim 17, further comprising:
autonomously selecting the set of resources based on a pre-configured resource pool; and
transmitting, to the set of UEs via the groupcast PSCCH/PSSCH, an indication of the autonomously selected set of resources, the autonomously selected set of resources being configured in a semi-static manner.

20. The UE of claim 15, further comprising determining a set of retransmission resources for a hybrid automatic repeat and request (HARQ) when the UE receives a negative response, from the other UE, corresponding to a data transmission via the PSSCH.
